(19) United States
(12) Patent Application Publication
(10) Pub. No.: US 2005/0097974 A1
(43) Pub. Date: May 12, 2005

(54) Processes for obtaining continuously variable transmissions, and continuously variable transmissions

(76) Inventor: Carlos Raul Espinosa, Quito (EC)

Correspondence Address: Carlos Espinosa, P O Box 17-07-8819, Quito, EC

(21) Appl. No.: 10/702,461

(22) Filed: Nov. 7, 2003

(51) Int. Cl. F16H 15/00

(52) U.S. Cl. 74/111; 476/50

(57) ABSTRACT

A processes for obtaining continuously variable transmissions having rotation movement of continuously variable oscillating angle, or of continuously variable eccentricity. A continuously variable transmissions having rotation movement of continuously variable oscillating angle, or of continuously variable eccentricity.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

1. Field of Invention

This invention relates to processes for obtaining continuously variable transmissions of mechanical power, and continuously variable transmissions.

2. Description of Prior Art

Machines with variable speed usually use a transmission between a source of mechanical power and a load. Examples of machines with variable speed are cars, trucks, tractors, motorcycles, bicycles, and frequency regulators.

Transmissions permit to transfer constant mechanical power or constant torque.

Transmissions have direct and/or reversible mechanical power transference between the source and the load.

Transmissions have a transmission ratio. The transmission ratio is referred to a magnitude of the mechanical power between different stages.

The source of mechanical power has optimum functioning conditions in a limited operative range, and the source of mechanical power and the load operate in a high overall transmission ratio range. Due to these features and for avoiding a change with a high variation of the transmission ratio, there is the need to add several transmission ratios to the transmission.

The largest number of transmission ratios with continuous shifting is given by a continuously variable transmission. Inventors have development several types of continuously variable transmissions. Some types of continuously variable transmissions are called infinitely variable transmissions.

Continuously variable transmissions are configured with or without mechanical power split.

Although continuously variable transmissions give more transmission ratios than transmissions with ratio steps like manuals and automatics, and have continuous shifting, and several modes for the transmission ratio control, they are used in a very low quantity in comparison with the transmissions with ratio steps in machines with variable speed.

In the prior art, the most currently utilized continuously variable transmissions, with relation to the transmissions with ratio steps, for the same power, suffer from a number of disadvantages:
(a) Expensive manufacture.
(b) Complex control system.
(c) Low ratio of transmitted power by weight.
(d) Low transmitted torque.

### OBJECTS AND ADVANTAGES

Accordingly, besides the objects and advantages of the transmissions described in my above patent, several objects and advantages of the present invention are:
(a) to provide a processes for obtaining continuously variable transmissions which can be used in a variety of machines with variable speed, applications, sources of mechanical power, and loads;
(b) to provide a continuously variable transmissions of different types and configurations with simple structure, economical manufacture, reduced control system, compact size, and high transmitted torque; and
(c) to provide a continuously variable transmissions which can be used in a high variety of machines with variable speed, applications, sources of mechanical power, and loads.

Further objects and advantages are to provide a continuously variable transmissions which can have a continuous shifting in a high overall transmission ratio range, and with a change of speed from forward to reverse including stationary, which can have a variator of transmission ratios with gearing contact or traction contact. Still further objects and advantages will become apparent from a consideration of the ensuing description and drawings.

### SUMMARY OF THE INVENTION

In accordance with the present invention a process for obtaining continuously variable transmissions having rotation movement of continuously variable oscillating angle, comprising:
(a) providing an input rotation movement,
(b) providing a rotation movement of continuously variable oscillating angle,
(c) converting the input rotation movement to the rotation movement of continuously variable oscillating angle,
(d) providing a control system and controlling the rotation movement of continuously variable oscillating angle,
(e) providing a contact area, a main variable movement, and a perpendicular movement in relation to the main variable movement, in the rotation movement of continuously variable oscillating angle,
(f) providing a contact area, and a main output variable movement,
(g) providing a free movement in the contact area,
(h) converting the main variable movement to the main output variable movement,
(i) converting the perpendicular movement in relation to the main variable movement to the free movement,
(j) providing a continuously variable output rotation movement and integrating the main output variable movement, and the free movement, in the continuously variable output rotation movement, and
(k) providing a reversible movement transmission from the continuously variable output rotation movement to the input rotation movement.

In accordance with the present invention a process for obtaining continuously variable transmissions having rotation movement of continuously variable eccentricity, comprising:
(a) providing an input rotation movement,
(b) providing a rotation movement of continuously variable eccentricity,
(c) converting the input rotation movement to the rotation movement of continuously variable eccentricity,
(d) providing a control system and controlling the rotation movement of continuously variable eccentricity,
(e) providing a contact area, a main variable movement, and a perpendicular movement in relation to the main variable movement, in the rotation movement of continuously variable eccentricity,

(f) providing a contact area, and a main output variable movement,
(g) providing a free movement in the contact area,
(h) converting the main variable movement to the main output variable movement,
(i) converting the perpendicular movement in relation to the main variable movement to the free movement,

(j) providing a continuously variable output rotation movement and integrating the main output variable movement, and the free movement, in the continuously variable output rotation movement, and
(k) providing a reversible movement transmission from the continuously variable output rotation movement to the input rotation movement.

In accordance with the present invention a continuously variable transmissions having rotation movement of continuously variable oscillating angle, comprising:
(a) an input rotation movement,
(b) a rotation movement of continuously variable oscillating angle,
(c) a converter of movements from the input rotation movement to the rotation movement of continuously variable oscillating angle,
(d) a control system for controlling the rotation movement of continuously variable oscillating angle,
(e) a contact area, a main variable movement, and a perpendicular movement in relation to the main variable movement, for using the rotation movement of continuously variable oscillating angle,
(f) a contact area, and a main output variable movement,
(g) a free movement in the contact area,
(h) a converter of movements from the main variable movement to the main output variable movement,
(i) a converter of movements from the perpendicular movement in relation to the main variable movement to the free movement, and

(j) a continuously variable output rotation movement and an integrator of movements between the main output variable movement and the free movement, in the continuously variable output rotation movement.

In accordance with the present invention a continuously variable transmissions having rotation movement of continuously variable eccentricity, comprising:
(a) an input rotation movement,
(b) a rotation movement of continuously variable eccentricity,
(c) a converter of movements from the input rotation movement to the rotation movement of continuously variable eccentricity,
(d) a control system for controlling the rotation movement of continuously variable eccentricity,
(e) a contact area, a main variable movement, and a perpendicular movement in relation to the main variable movement, for using the rotation movement of continuously variable eccentricity,
(f) a contact area, and a main output variable movement,
(g) a free movement in the contact area,
(h) a converter of movements from the main variable movement to the main output variable movement,
(i) a converter of movements from the perpendicular movement in relation to the main variable movement to the free movement, and
(j) a continuously variable output rotation movement and an integrator of movements between the main output variable movement and the free movement, in the continuously variable output rotation movement.

### BRIEF DESCRIPTION OF THE DRAWINGS

FIG. 1 is a block diagram providing a process for obtaining a continuously variable transmission having rotation movement of continuously variable oscillating angle, in accordance with a preferred embodiment of the present invention.

FIG. 2 is a block diagram showing a process for obtaining a continuously variable transmission having rotation movement of continuously variable eccentricity, in accordance with an embodiment of the present invention.

FIG. 3 is a perspective of a continuously variable transmission having rotation movement of continuously variable oscillating angle, in accordance with an embodiment of the present invention.

FIG. 4 is a plan view of the continuously variable transmission that is depicted in FIG. 3.

FIG. 5 is a longitudinal section of the continuously variable transmission that is depicted in FIG. 3, in accordance with an embodiment of the present invention.

FIG. 6 is a longitudinal section of the continuously variable transmission taken substantially along line 6-6 of FIG. 5.

FIG. 7 is a perspective of a continuously variable transmission having rotation movement of continuously variable oscillating angle, in accordance with an embodiment of the present invention.

FIG. 8 is a transverse section of the continuously variable transmission taken substantially along line 8-8 of FIG. 7.

FIG. 9 is a transverse section of the continuously variable transmission that is depicted in FIG. 7, in accordance with an embodiment of the present invention.

FIG. 10 is a longitudinal section of the continuously variable transmission taken substantially along line 10-10 of FIG. 9.

FIG. 11 is a perspective of a continuously variable transmission having rotation movement of continuously variable oscillating angle, in accordance with an embodiment of the present invention.

FIG. 12 is a transverse section of the continuously variable transmission taken substantially along line 12-12 of FIG. 11.

FIG. 13 is a perspective of a continuously variable transmission having rotation movement of continuously variable oscillating angle, in accordance with an embodiment of the present invention.

FIG. 14 is a transverse section of the continuously variable transmission taken substantially along line 14-14 of FIG. 13.

FIG. 15 is a transverse section of the continuously variable transmission that is depicted in FIG. 13, in accordance with an embodiment of the present invention.

FIG. 16 is a perspective of a continuously variable transmission having rotation movement of continuously variable oscillating angle, in accordance with an embodiment of the present invention.

FIG. 17 is a perspective of a continuously variable transmission having rotation movement of continuously variable oscillating angle, in accordance with an embodiment of the present invention.

FIG. 18 is a transverse section of the continuously variable transmission taken substantially along line 18-18 of FIG. 17.

FIG. 19 is a transverse section of the continuously variable transmission that is depicted in FIG. 17, in accordance with an embodiment of the present invention.

FIG. 20 is a perspective of a continuously variable transmission having rotation movement of continuously variable oscillating angle, in accordance with an embodiment of the present invention.

FIG. 21 is a perspective of a continuously variable transmission having rotation movement of continuously variable oscillating angle, in accordance with an embodiment of the present invention.

FIG. 22 is a perspective of a continuously variable transmission having rotation movement of continuously variable oscillating angle, in accordance with an embodiment of the present invention.

FIG. 23 is a perspective of a continuously variable transmission having rotation movement of continuously variable oscillating angle, in accordance with an embodiment of the present invention.

FIG. 24 is a longitudinal section of the continuously variable transmission that is depicted in FIG. 23, in accordance with an embodiment of the present invention.

FIG. 25 is a perspective of a component of the continuously variable transmission that is depicted in FIG. 23.

FIG. 26 is a perspective of a continuously variable transmission having rotation movement of continuously variable oscillating angle, in accordance with an embodiment of the present invention.

FIG. 27 is a longitudinal section of the continuously variable transmission taken substantially along line 27-27 of FIG. 26.

FIG. 28 is a transverse section of the continuously variable transmission taken substantially along line 28-28 of FIG. 27.

FIG. 29 is a longitudinal section of the continuously variable transmission that is depicted in FIG. 26, in accordance with an embodiment of the present invention.

FIG. 30 is a transverse section of the continuously variable transmission taken substantially along line 30-30 of FIG. 29.

FIG. 31 is a perspective of a continuously variable transmission having rotation movement of continuously variable oscillating angle, in accordance with an embodiment of the present invention.

FIG. 32 is a longitudinal section of the continuously variable transmission taken substantially along line 32-32 of FIG. 31.

FIG. 33 is a transverse section of the continuously variable transmission taken substantially along line 33-33 of FIG. 32.

FIG. 34 is a longitudinal section of the continuously variable transmission that is depicted in FIG. 31, in accordance with an embodiment of the present invention.

FIG. 35 is a transverse section of the continuously variable transmission taken substantially along line 35-35 of FIG. 34.

FIG. 36 is a perspective of a continuously variable transmission having rotation movement of continuously variable oscillating angle, in accordance with an embodiment of the present invention.

FIG. 37 is a perspective of a continuously variable transmission having rotation movement of continuously variable oscillating angle, in accordance with an embodiment of the present invention.

FIG. 38 is a perspective of a continuously variable transmission having rotation movement of continuously variable oscillating angle, in accordance with an embodiment of the present invention.

FIG. 39 is a perspective of a continuously variable transmission having rotation movement of continuously variable oscillating angle, in accordance with an embodiment of the present invention.

FIG. 40 is a longitudinal section of the continuously variable transmission taken substantially along line 40-40 of FIG. 39.

FIG. 41 is a transverse section of the continuously variable transmission taken substantially along line 41-41 of FIG. 40.

FIG. 42 is a transverse section of the continuously variable transmission that is depicted in FIG. 39, in accordance with an embodiment of the present invention.

FIG. 43 is a perspective of a continuously variable transmission having rotation movement of continuously variable oscillating angle, in accordance with an embodiment of the present invention.

FIG. 44 is a perspective of a continuously variable transmission having rotation movement of continuously variable oscillating angle, in accordance with an embodiment of the present invention.

FIG. 45 is a transverse section of the continuously variable transmission taken substantially along line 45-45 of FIG. 44.

FIG. 46 is a perspective of the continuously variable transmission that is depicted in FIG. 44, in accordance with an embodiment of the present invention.

FIG. 47 is a longitudinal section of the continuously variable transmission taken substantially along line 47-47 of FIG. 46.

FIG. 48 is a transverse section of the continuously variable transmission taken substantially along line 48-48 of FIG. 47.

FIG. 49 is a longitudinal section of the continuously variable transmission that is depicted in FIG. 46, in accordance with an embodiment of the present invention.

FIG. 50 is a transverse section of the continuously variable transmission taken substantially along line 50-50 of FIG. 49.

FIG. 51 is a longitudinal section of the continuously variable transmission that is depicted in FIG. 46, in accordance with an embodiment of the present invention.

FIG. 52 is a transverse section of the continuously variable transmission taken substantially along line 52-52 of FIG. 51.

FIG. 53 is a perspective of a continuously variable transmission having rotation movement of continuously variable oscillating angle, in accordance with an embodiment of the present invention.

FIG. 54 is a longitudinal section of the continuously variable transmission taken substantially along line 54-54 of FIG. 53.

FIG. 55 is a longitudinal section of the continuously variable transmission taken substantially along line 55-55 of FIG. 54.

FIG. 56 is a perspective of a continuously variable transmission having rotation movement of continuously variable oscillating angle, in accordance with an embodiment of the present invention.

FIG. 57 is a longitudinal section of the continuously variable transmission taken substantially along line 57-57 of FIG. 56.

FIG. 58 is a longitudinal section of the continuously variable transmission taken substantially along line 58-58 of FIG. 57.

FIG. 59 is a longitudinal section of a continuously variable transmission having rotation movement of continuously variable oscillating angle, in accordance with an embodiment of the present invention.

FIG. 60 is a longitudinal section of the continuously variable transmission taken substantially along line 60-60 of FIG. 59.

FIG. 61 is a plan view of a continuously variable transmission having rotation movement of continuously variable eccentricity, in accordance with an embodiment of the present invention.

FIG. 62 is a longitudinal section of the continuously variable transmission taken substantially along line 62-62 of FIG. 61.

FIG. 63 is a perspective of a continuously variable transmission having rotation movement of continuously variable eccentricity, in accordance with an embodiment of the present invention.

FIG. 64 is a longitudinal section of the continuously variable transmission taken substantially along line 64-64 of FIG. 63.

### DRAWINGS—REFERENCE NUMERALS

101 input rotation movement
102 arrow of direct process
103 arrow of reversible process
104 rotation movement of continuously variable oscillating angle
105 control system of the oscillating angle
106 main variable movement
107 perpendicular movement in relation to the main variable movement
108 contact area
109 main output variable movement
110 free movement
111 continuously variable output rotation movement
112 rotation movement of continuously variable eccentricity
113 control system of the eccentricity
131 circle of input rotation movement
132 circle of rotation movement of continuously variable oscillating angle
133 oscillation axis
134 reference axial axis
135 equivalent rotation axis
136 oscillation angle
137, 166-169, 173-175 direction of input rotation movement
138, 180-181, 194-195, 203 direction of main variable movement
139 opposite direction of main variable movement
140, 144 output axial axis
141, 143, 147, 150, 179, 182 direction of output rotation movement
142, 155-165, 170-172, 176-178 direction of free movement
145 compound trajectory of input rotation movement
146 compound trajectory of rotation movement of continuously variable oscillating angle
148-149 symmetry axis
151 direction of rotation movement of continuously variable oscillating angle
152 compound-half-toroidal disc axis
153 direction of rotation movement of compound-half-toroidal disc
154 ball shaft axis
183 symmetry axis of the lemon
184 symmetry axis of the shaft
191-192, 198-199, 202 reference axis
193, 200 eccentricity
196-197, 201 direction of rotation movement
221, 239, 243, 246, 249, 261 input shaft
222, 232 swash plate shaft
223, 238 half-toroidal disc shaft
224, 236, 253, 263 intermediate shaft
225, 244, 257, 264 output shaft
226, 254 worm shaft
227 control gear shaft
228 roller rod
229, 256 shaft
230, 234 pulley output shaft
231, 235 pulley shaft
233 roller disc shaft
237 sphere shaft
240 external telescopic shaft
241 internal telescopic shaft
242 ball shaft
245, 247 tire shaft
248 belt shaft
250-252, 266 cylinder shaft
255 rotor shaft
262 cone shaft
265 disc shaft
291, 293, 297 swash plate
292, 294 shoe
295 spherical head
296 shoe support
311-313, 342 roller disc
331 cylindrical roller
332 roller with annular teeth
333, 337 roller base
334 roller with annular teeth
335 roller with pneumatic-cylindrical tire
336, 338 pneumatic chamber
341 roller
343 ring
344 traction cone
345 traction disc
361 ball bearing
362, 370, 380-381, 415 bearing support
363 cover bolt
364, 374, 385 housing
365 roller retainer ring
366, 373 belt support
367 swash base
368 base support
369 retainer ring
371 bearing cover
372 plain belt support
375, 383 gear support
376, 379, 404 ball
377 concave support
378 compound belt support
382 electric motor support
384 electrical connector support
386 cone support
401 half-toroidal disc
402 compound-half-toroidal disc
403, 407 sphere
405 pneumatic-cylindrical tire
406 cylinder with distributed spheres
408, 412 belt
409 belt cylinder
410 belt cylinder cover
411 compound cylinder
413 belt bearing
414 belt bearing shaft
431, 436 helical gear
432 complementary helical gear
433 intermediate helical gear
434 helical gear of control motor
435 helical gear of worm shaft
437, 439, 441 compound gear
438, 440, 442, 626, 631 collapsible tooth
481, 485-486 spiral bevel gear
482 output spiral bevel gear
483 input pinion gear
484 ring gear
487 face gear
521 worm
522-525, 527 gear
526, 528-529 gear base
530 gear support
531 screw
532 nut support
541 control motor
542 electric motor
543 rotor
544 stator
545, 684, 691 bearing
546 external rotor
547-548, 553-554 electrical connector
549 connector base
550-551 electrical cable
552 electrical isolator
591-592 universal joint
621 toothed belt with concave teeth
622 concave tooth
623, 629, 634 toothed belt
624, 635 straight tooth
625, 633 support with collapsible teeth
627, 632 plate spring
628 plain belt
630 belt tooth
636 compound belt with concave shape
637, 640 annular belt with concave shape
638 belt ball
639 internal belt with concave shape
641, 651 holed ball
642 internal belt support with concave shape
643-644, 655-656 belt ball shaft
645 compound belt
646, 649 annular belt
647, 657 ball
648 internal belt
650 internal belt support
654 compound-toothed belt
658-661 belt ball support
662 toothed-annular belt
671-672 compound cylinder
681 bearing with barrel shape
682, 687 bearing support
683 cover support
685 shaft
686 bearing with lemon shape
688 support
689 shaft support
690 bearing shaft
701 toothed pulley with spherical shape
702, 704, 706 toothed pulley
703 cylindrical pulley
705 pulley with spherical shape

### DETAILED DESCRIPTION OF THE PREFERRED EMBODIMENTS

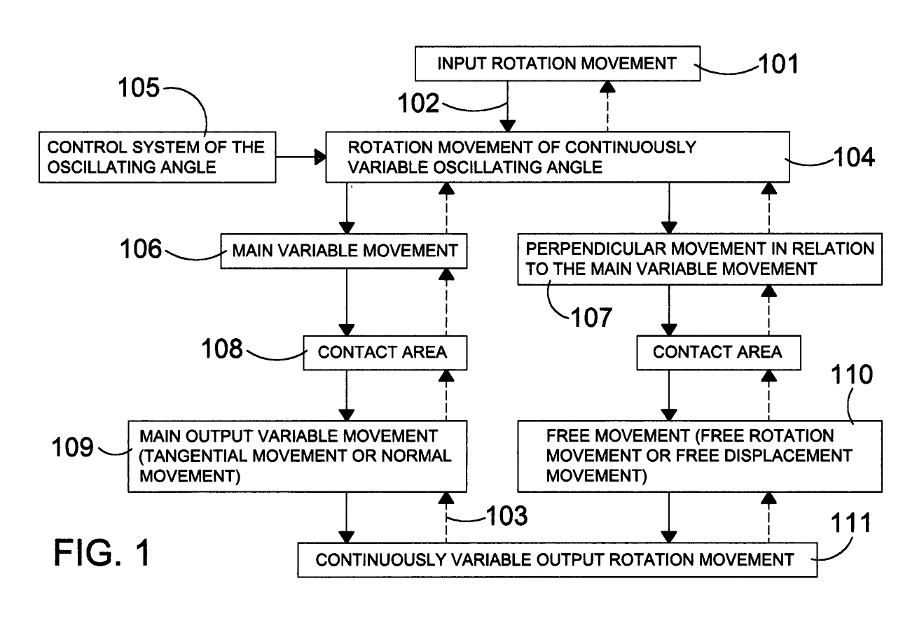

FIG. 1 shows a preferred embodiment of the invention. A process for obtaining a continuously variable transmission having rotation movement of continuously variable oscillating angle is illustrated through a block diagram, where an input rotation movement 101 is converted in a rotation movement of continuously variable oscillating angle 104. The movement 101 is formed from a source of rotational energy (not shown). An arrow of direct process 102 is connected between the movement 101 and the movement 104. A control system of the oscillating angle 105 is referred to the movement 104. A main variable movement 106 is obtained from the movement 104. A perpendicular movement in relation to the main variable movement 107 is obtained from the movement 104. The movement 106 is converted in a main output variable movement 109, through a contact area 108. The movement 109 may be a tangential movement or a normal movement in relation to the contact area. The movement 107 is converted in a free movement 1 10, through the contact area 108. The movement 1 10 may be a free rotation movement or a free displacement movement. A continuously variable output rotation movement 111 is obtained from the movements 109 and 1 10. The movement 111 is transmitted to a load (not shown). An arrow of reversible process 103 is connected between the movement 1 11 and the movement 109.

The process for obtaining a continuously variable transmission operates a sequential steps, in a direct or reversible form. Therefore, the source of mechanical power drives the load, and also can occur the opposite, when the load accelerates to the source, like a engine breaking condition.

The manner of using the process for obtaining a continuously variable transmission is alternative. One situation is when the source of rotational energy has a approximately constant movement and the load has a continuously variable movement. Another situation is when the load has a approximately constant movement and the source has a continuously variable movement.

The functions of the process for obtaining a continuously variable transmission are based in the input rotation movement 101 which determines a approximately constant movement. Next converting the movement 101 in the rotation movement of continuously variable oscillating angle 104 by using the control system 105, so that the movement 104 has the two components, one component is the main variable movement 106 and interacts in the contact area 108 producing the main output variable movement 109. Next converting the movement 109 in the continuously variable output rotation movement 111 which determines a continuously variable movement. The other component of the movement 104 is the movement 107 which also interacts with the contact area 108 producing the free movement 110 which is a component of the movement 111. The control system 105 performs a control process or a control method in the movement 104 so that the source of rotational energy drives the load with a continuously variable transmission.

The main variable movement 106 is converted in the main output variable movement 109 through an interaction of movements in the contact area 108. The movement 106 may be a tangential movement or a normal movement in relation to the contact area.

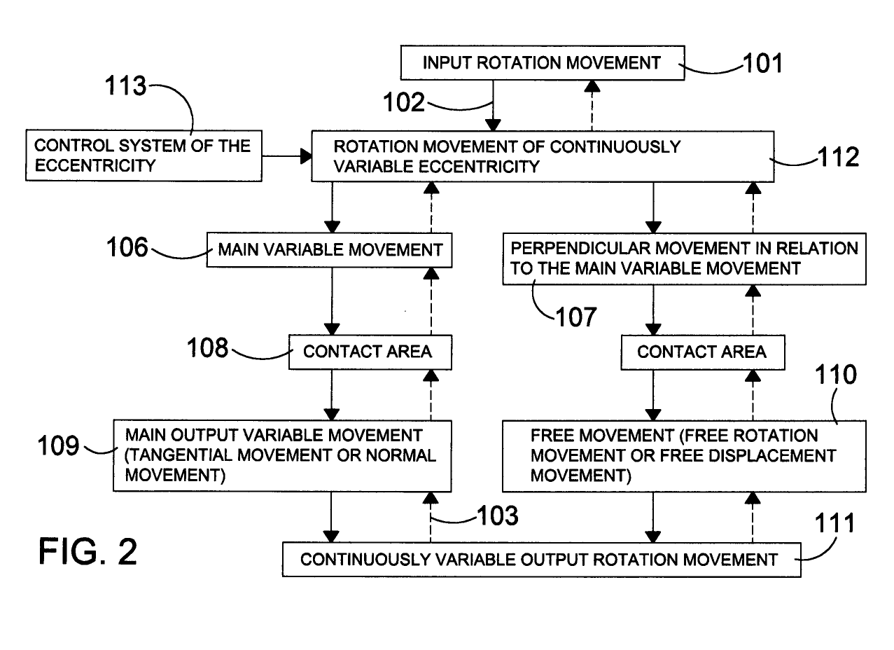

FIG. 2 shows another embodiment of the present invention. A process for obtaining a continuously variable transmission having rotation movement of continuously variable eccentricity is illustrated through a block diagram, where an input rotation movement 101 is converted in a rotation movement of continuously variable eccentricity 112. The movement 101 is formed from a source of rotational energy (not shown). An arrow of direct process 102 is connected between the movement 101 and the movement 112. A control system of the eccentricity 113 is referred to the movement 1 12. A main variable movement 106 is obtained from the movement 112. A perpendicular movement in relation to the main variable movement 107 is obtained from the movement 112. The movement 106 is converted in a main output variable movement 109, through a contact area 108. The movement 109 may be a tangential movement or a normal movement in relation to the contact area. The movement 107 is converted in a free movement 110, through the contact area 108. The movement 110 may be a free rotation movement or a free displacement movement. A continuously variable output rotation movement 111 is obtained from the movements 109 and 110. The movement 111 is transmitted to a load (not shown). An arrow of reversible process 103 is connected between the movement 111 and the movement 109.

The functions of the process for obtaining a continuously variable transmission are based in the input rotation movement 101 which determines a approximately constant movement. Next converting the movement 101 in the rotation movement of continuously variable eccentricity 112 by using the control system 113, so that the movement 112 has the two components, one component is the main variable movement 106 and interacts in the contact area 108 producing the main output variable movement 109. Next converting the movement 109 in the continuously variable output rotation movement 111 which determines a continuously variable movement. The other component of the movement 112 is the movement 107 which also interacts with the contact area 108 producing the free movement 110 which is a component of the movement 111. The control system 113 performs a control process or a control method in the movement 112 so that the source of rotational energy drives the load with a continuously variable transmission.

The main variable movement 106 is converted in the main output variable movement 109 through an interaction of movements in the contact area 108. The movement 106 may be a tangential movement or a normal movement in relation to the contact area.

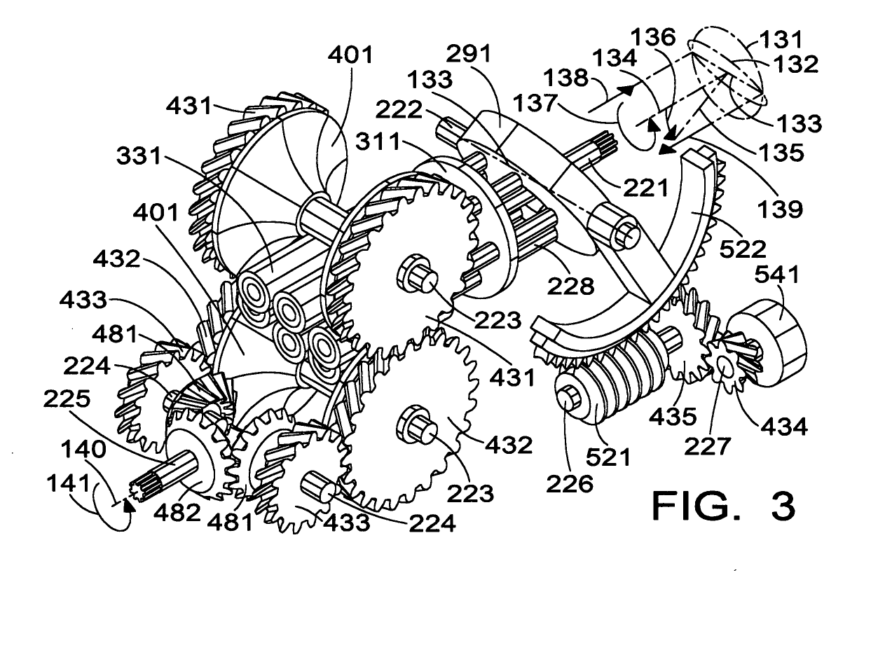

Referring to the FIG. 3, there is shown an embodiment of a continuously variable transmission in accordance with the present invention. The continuously variable transmission has an input shaft 221 which is connected at one side to a source of rotational energy (not shown) and by the other side to a roller disc 311. The disc 311 has a six roller rods 228 which are circumferentially and symmetrically distributed. At one end of the rods 228 is a swash plate 291 which is pivotable around of an oscillation axis 133 and a swash plate shaft 222. In the other end of each one of the rods 228 is located a cylindrical roller 331. The rollers 331 have a traction contact with a four half-toroidal discs 401 through a traction oil system (not shown). Two half-toroidal discs 401 are mounted face to face on a half-toroidal disc shaft 223 and these two discs 401 are attached in its external part to a two helical gears 431 which rotate in opposite directions. Also another two half-toroidal discs 401 are supported face to face on another shaft 223 and these two discs 401 are fixed in its external part to a two helical gears 432 which rotate in opposite directions. The two shafts 223 are parallel shafts.

The four discs 401 are circumferentially located around of the six cylindrical rollers 331. The helical gears 431 are engaged with the helical gears 432. The two helical gears 432 are engaged with a two helical gears 433. One helical gear 433 is supported on a rotatable shaft 224 which transmits the movement to a spiral bevel gear 481. The another helical gear 433 is mounted on another rotatable shaft 224 which transmits the movement to another spiral bevel gear 481. Both spiral bevel gears 481 are engaged with a spiral bevel gear 482. The gear 482 is mounted on a rotatable output shaft 225 which is connected to a load (not shown). The swash plate 291 is oscillated through a gear 522 which is engaged with a worm 521. The worm 521 is rotated with a worm shaft 226. A helical gear 435 is mounted on the shaft 226 and this gear 435 is engaged with a helical gear 434. The gear 434 is supported on a rotatable shaft 227. The shaft 227 is driven by a control motor 541. The control motor 541 is a component of a control system (not shown) of the continuously variable transmission.

The input shaft 221 is determined by a reference axial axis 134 with a direction of input rotation movement 137. The swash plate 291 is pivoted in an oscillation angle 136. The oscillation angle 136 is formed between the reference axial axis 134 and an equivalent rotation axis 135. In another oscillation axis 133 are located a circle of input rotation movement 131 and a circle of rotation movement of continuously variable oscillating angle 132; at one end of this oscillation axis 133 is projected a direction of main variable movement 138 and, at the other end is projected a opposite direction of main variable movement 139. The output shaft 225 is determined by an output axial axis 140 with a direction of output rotation movement 141.

The continuously variable transmission of FIG. 3 is operated through the input shaft 221 which is driven by an engine or a motor, this shaft 221 has an input rotation movement and rotates with the same angular velocity to the six cylindrical rollers 331. Additionally, each one of these rollers 331 has an oscillating movement or a reciprocating movement. Consequently, the rollers 331 have a movement which can be determined through a rotation movement with an oscillating movement. This oscillating movement is transmitted from the rollers 331 to the four half-toroidal discs 401 by an interaction in a contact area using a traction oil. The oscillating movement of the roller 331 produces a rotation movement in the half-toroidal discs 401. Each one of the four half-toroidal discs 401 has a rotation movement; therefore, each one of these four rotation movements is added for obtaining an output rotation movement in the output shaft 225. The rotation movement of each one of the rollers 331 is converted in a free rotation movement of the rollers 331 in relation to its roller rods 228. The oscillating movement of the rollers 331 is produced by the swash plate 291 which has a continuously variable oscillating angle.

The control system of the continuously variable transmission operates the control motor 541 which regulates the oscillation angle 136 of the swash plate 291. The torque of the control motor 541 is amplificated through the gear train formed by the helical gears 434 and 435, the worm 521, and the gear 522. The control system can have several methods of control for selecting the transmission ratio. The control system can be configured to determine the transmission ratio in an automatic, or semi-automatic, or manual selection by a user. When the input shaft 221 rotates with the direction of input rotation movement 137, the cylindrical rollers 331 located at the right side have the direction of main variable movement 139, and the cylindrical rollers 331 located at the left side have the direction of main variable movement 138. This direction of main variable movement determines the direction of output rotation movement 141. Consequently, when the swash plate 291 is regulated and the oscillation angle 136 is changed, the direction of output rotation movement 141 is modificated; thus, the transmission ratio can be varied from forward to reverse including neutral in a continuous form.

The transmission has the roller disc 311 mounted on a stationary base, and the disc 311 conduces the direction of input rotation movement 137; the six cylindrical rollers 331 are supported on a structure with control of the oscillating angle 136, and the rollers 331 have a rotation movement of continuously variable oscillating angle; the rollers 331 drive the main variable movements 138 and 139, and the rollers 331 have a free rotation movement; the four half-toroidal discs 401 have a continuously variable output rotation movement.

The transmission is depicted in a transmission ratio. The transmission has a traction contact for transmitting the movements between the cylindrical rollers 331 and the half-toroidal discs 401. The rollers 331 drive the main variable movement, and a perpendicular movement in relation to the main variable movement.

The main variable movement of the six cylindrical rollers 331 is a tangential movement to a contact area, this contact area is formed between the external surfaces of the rollers 331 and the four half-toroidal discs 401. The contact area is an interaction zone between movements, the main variable movement of the rollers 331 is converted in a main output variable movement of the discs 401. The main output variable movement of the discs 401 is a tangential movement to the contact area. The main output variable movement of the discs 401 is a component of the continuously variable output rotation movement of the discs 401.

The perpendicular movement in relation to the main variable movement of the six cylindrical rollers 331 is converted in the free rotation movement of the rollers 331. This conversion is made in the contact area by the traction contact. The free rotation movement of the rollers 331 is when the rollers 331 rotate around of the roller rods 228.

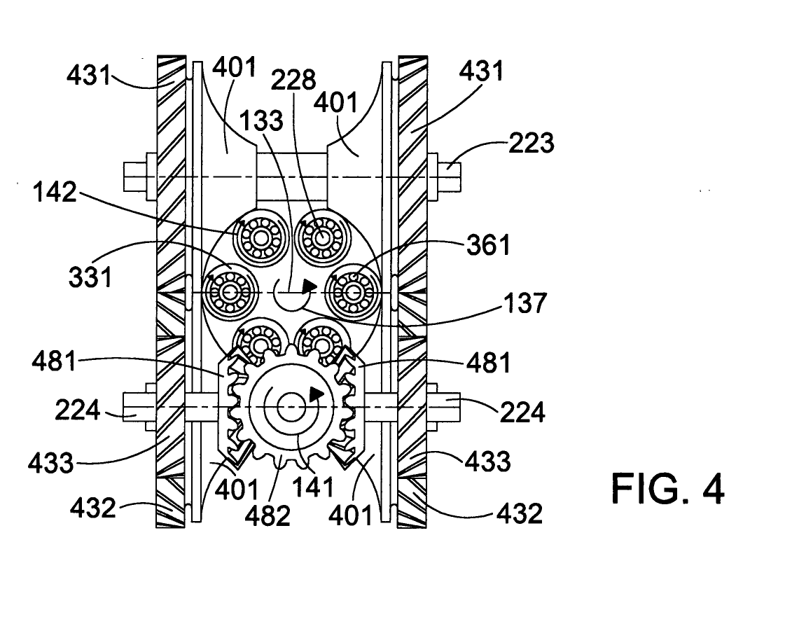

FIG. 4 shows a plan view of the transmission of FIG. 3. Each one of the cylindrical rollers 331 is located on a ball bearing 361. The bearings 361 are supported on the roller rods 228. A direction of free movement 142 is formed one each one of the rollers 331.

The four half-toroidal discs 401 determine a circular trajectory for the six cylindrical rollers 331. The rollers 331 have the traction contact with the discs 401 through the traction oil; when all the roller rods 228 rotate around of the middle point of the axis 133 in the direction of input rotation movement 137, the rollers 331 rotate around of the central point of the rods 228 in the direction of free movement 142. The direction of rotation of the free movement 142 is opposite to the direction of rotation of the input rotation movement 137. The six roller rods 228 are circumferentially spaced at approximately 60 degrees each one, for obtaining a symmetrical angular configuration with a determined radius from the rotation center in the middle point of the axis 133.

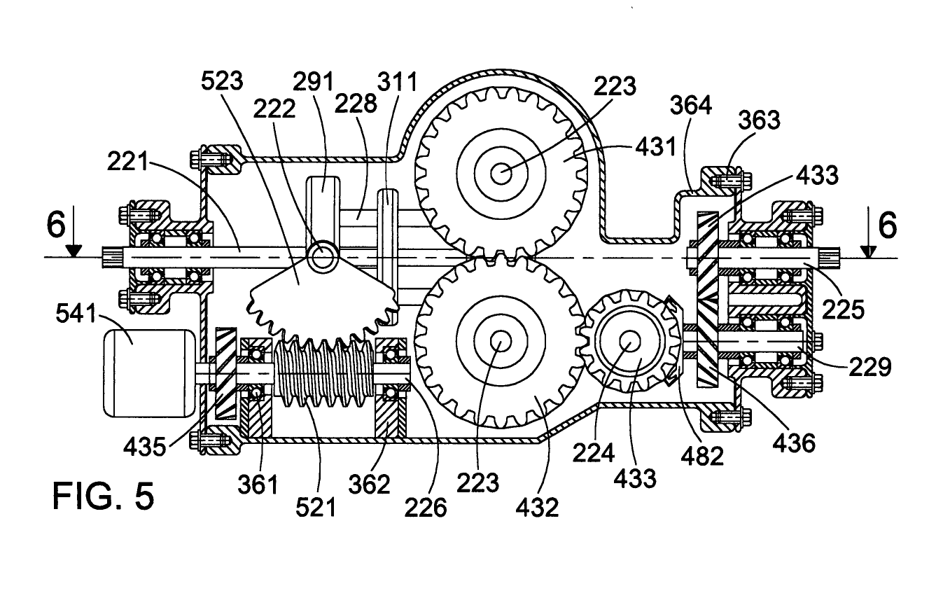

Referring to the FIG. 5, this embodiment is showing a continuously variable transmission in accordance with the present invention, which illustrates a longitudinal section of the continuously variable transmission that is depicted in FIG. 3 with more functional details. The continuously variable transmission has the input shaft 221 which is connected to the roller disc 311. The roller disc 311 and the swash plate 291 drive the roller rods 228 with a rotation movement and an oscillating movement. The swash plate 291 has a regulated oscillation around of the swash plate shaft 222 through a gear 523. The helical gears 431, 432, and 433 have a gearing contact. The spiral bevel gear 482 transmits the motion to a rotatable shaft 229 which turns a helical gear 436. The gear 436 is engaged with the helical gear 433 which is supported on the rotatable output shaft 225. The gear 523 is engaged with a worm 521 which is rotated with a worm shaft 226 by the control motor 541. The worm shaft 226 is mounted on the ball bearings 361 with a bearing supports 362. A housing 364 uses a bolts 363 to joint its parts.

The transmission is depicted in a transmission ratio corresponding to stationary. The transmission has the traction contact for transmitting the movements between the input rotation movement and the continuously variable output rotation movement.

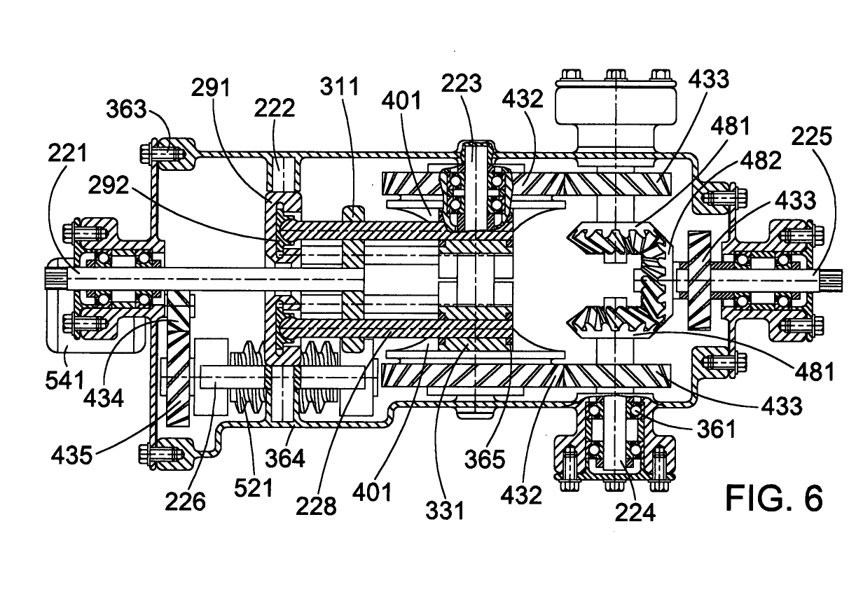

FIG. 6 shows a longitudinal section of the continuously variable transmission of FIG. 5. The swash plate 291 uses a shoes 292 to move the roller rods 228. The cylindrical rollers 331 have a roller retainer rings 365.

When the transmission has the transmission ratio corresponding to stationary, the rollers 331 have a main variable movement equivalent to zero, and a perpendicular movement in relation to the main variable movement. The perpendicular movement in relation to the main variable movement of the rollers 331 is converted in a free rotation movement of the rollers 331. The free rotation movement of the rollers 331 is when the rollers 331 rotate around of the roller rods 228. This conversion is made in the contact area by the traction contact. Consequently, the half-toroidal discs 401 are in a stationary condition.

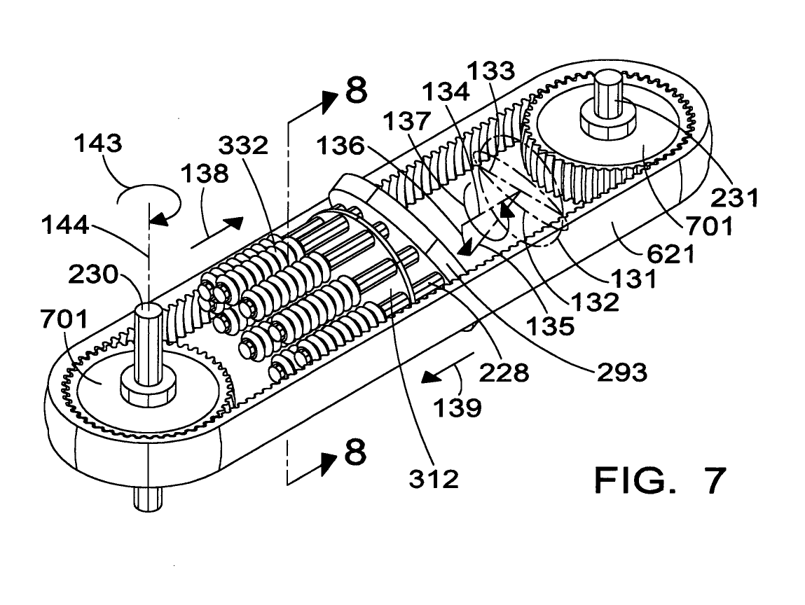

FIG. 7 shows an embodiment of a continuously variable transmission in accordance with the present invention. The continuously variable transmission has an input shaft connected to a roller disc 312. The disc 312 has the twelve roller rods 228 which are circumferentially and symmetrically distributed. At one end of the rods 228 is a swash plate 293 which is pivotable around of an oscillation axis. This oscillation axis of the swash plate 293 is a parallel axis to the oscillation axis 133. In the other end of each one of the roller rods 228 is located a roller with annular teeth 332. The rollers 332 have a gearing contact with a toothed belt with concave teeth 621. The toothed belt 621 is connected to a two toothed pulleys with spherical shape 701. One toothed pulley 701 is supported on a pulley shaft 231, and the another toothed pulley 701 is supported on a rotatable pulley output shaft 230 which transmits the movement of the continuously variable transmission. The output shaft 230 is determined by an output axial axis 144 with a direction of output rotation movement 143.

When the input shaft rotates with the direction of input rotation movement 137, the rollers 332 located at the right side have the direction of main variable movement 139, and the rollers 332 located at the left side have the direction of main variable movement 138. This direction of main variable movement determines the direction of movement of the toothed belt 621 which drives the output shaft 230 and its direction of output rotation movement 143.

The transmission has the roller disc 312 mounted on a stationary base, and the disc 312 conduces the input rotation movement 137; the twelve rollers with annular teeth 332 are supported on a structure with control of the oscillating angle 136, and the rollers 332 have a rotation movement of continuously variable oscillating angle; the rollers 332 drive the main variable movements 138 and 139, and the rollers 332 have a free rotation movement; the toothed belt with concave teeth 621 and the two toothed pulleys with spherical shape 701 have a continuously variable output rotation movement.

The transmission is depicted in a transmission ratio. The transmission has the gearing contact for transmitting the movements between the rollers with annular teeth 332 and the toothed belt 621. The rollers 332 drive the main variable movement, and a perpendicular movement in relation to the main variable movement.

The main variable movement of the rollers with annular teeth 332 is a normal movement to a contact area, this contact area is formed between the external surfaces of the geared teeth of the rollers 332 and the toothed belt 621. The contact area is an interaction zone between movements, the main variable movement of the rollers 332 is converted in a main output variable movement of the belt 621. The main output variable movement of the belt 621 is a normal movement to the contact area. The main output variable movement of the belt 621 is a component of the continuously variable output rotation movement of the belt 621.

The perpendicular movement in relation to the main variable movement of the rollers 332 is converted in the free rotation movement of the rollers 332.

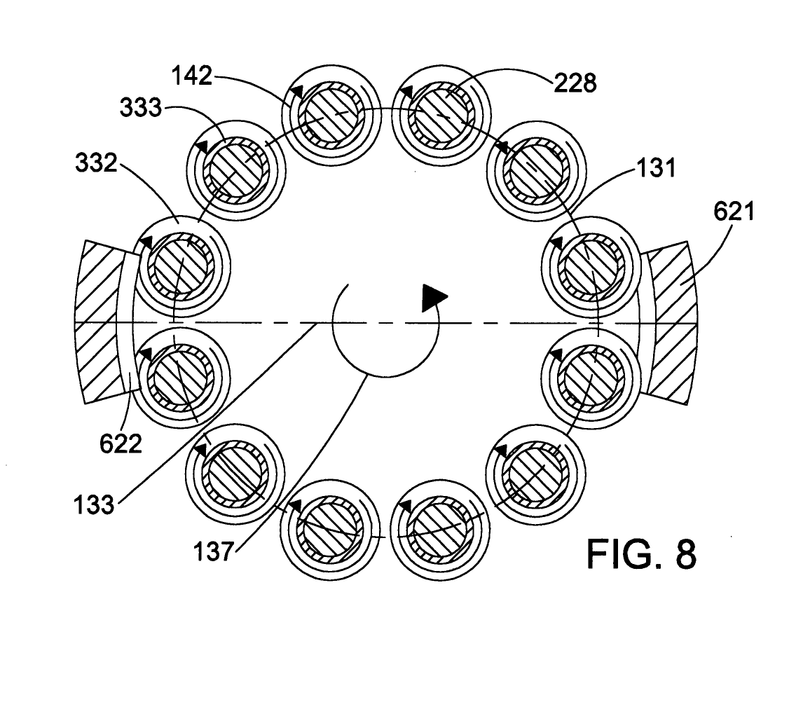

FIG. 8 shows a transverse section of the transmission of FIG. 7. Each one of the twelve rollers with annular teeth 332 is located on a roller base 333. The bases 333 are supported on the roller rods 228. A direction of free movement 142 is formed on the rollers 332. The rollers 332 have the gearing contact or positive engagement with a concave tooth 622 of the toothed belt 621.

When all the roller rods 228 rotate around of the middle point of the axis 133 in the direction of input rotation movement 137, the rollers 332 rotate around of the central point of the rods 228 in the direction of free movement 142. The direction of rotation of the free movement 142 is opposite to the direction of rotation of the input rotation movement 137. The twelve roller rods 228 are circumferentially spaced at approximately 30 degrees each one, for obtaining a symmetrical angular configuration with a determined radius from the rotation center in the middle point of the axis 133.

Occasionally, a collision between teeth of the belt 621 and the rollers 332 can be presented in the transmission; this problem may be reduced with a flexible-toothed belt.

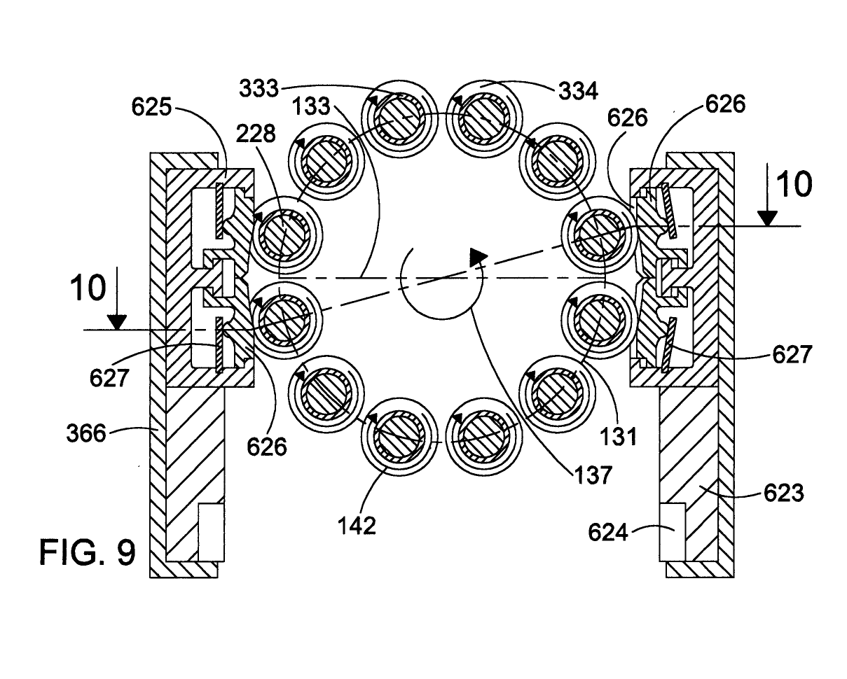

Referring to the FIG. 9, this embodiment is showing a continuously variable transmission in accordance with the present invention, which illustrates a transverse section of the continuously variable transmission that is depicted in FIG. 7 with more functional details. The continuously variable transmission has the twelve roller rods 228 which are circumferentially and symmetrically distributed. Each one of the roller rods 228 has a roller with annular teeth 334. The rollers 334 have a gearing contact with a toothed belt 623. The belt 623 has a collapsible teeth 626 which are located on a support 625. The collapsible teeth 626 are in contact with a plate spring 627 which is fixed at one end to the support 625. The belt 623 has a straight teeth 624 located at the lower position. The belt 623 is moved on a belt support 366.

When a collision between teeth of the belt 623 and the rollers 334 is presented in the transmission, the collapsible teeth 626 are displaced in the support 625. The plate springs 627 return the teeth 626 to its initial position for the gearing contact between teeth.

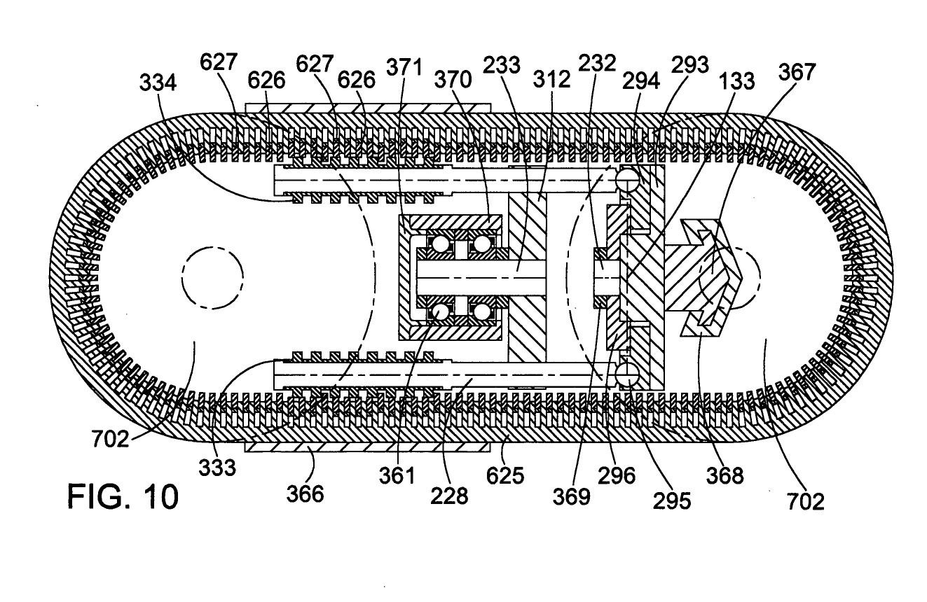

FIG. 10 shows a longitudinal section of the transmission of FIG. 9. The continuously variable transmission has the roller disc 312 which is connected to an input rotation movement. The disc 312 is supported on a roller disc shaft 233 which has a bearing support 370 and a bearing cover 371. At one end of the roller rods 228 is the swash plate 293 which is pivotable around of the oscillation axis 133. The swash plate 293 has a swash plate shaft 232 with a retainer ring 369 and a shoe support 296. Each one of the roller rods 228 are connected to the swash plate 293 through a spherical heads 295 and a shoes 294. The swash plate 293 is mounted on a base 367 with a support 368. The toothed belt 623 is engaged with a two toothed pulleys 702 using the straight teeth 624.

The transmission has the roller disc 312 mounted on a stationary base, and the disc 312 conduces the direction of input rotation movement 137; the twelve rollers with annular teeth 334 are supported on a structure with control of the oscillating angle 136, and the rollers 334 have a rotation movement of continuously variable oscillating angle; the rollers 334 drive the main variable movements 138 and 139, and the rollers 334 have a free rotation movement; the toothed belt 623 and the two toothed pulleys 702 have a continuously variable output rotation movement.

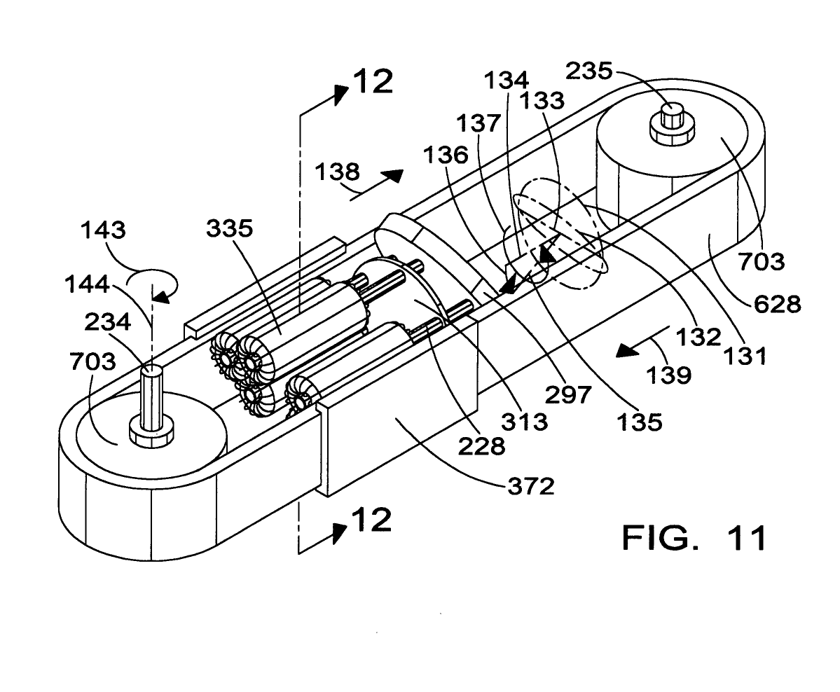

FIG. 11 shows an embodiment of a continuously variable transmission in accordance with the present invention. The continuously variable transmission has an input shaft connected to a roller disc 313. The disc 313 has the six roller rods 228 which are circumferentially and symmetrically distributed. At one end of the rods 228 is a swash plate 297 which is pivotable around of an oscillation axis. This oscillation axis of the swash plate 297 is a parallel axis to the oscillation axis 133. In the other end of each one of the rods 228 is located a roller with pneumatic-cylindrical tire 335. The rollers 335 have a traction contact with a plain belt 628. The belt 628 is connected to a two cylindrical pulleys 703. One pulley 703 is supported on a pulley shaft 235, and the another pulley 703 is supported on a rotatable pulley output shaft 234 which transmits the movement of the continuously variable transmission. The shaft 234 is determined by an output axial axis 144 with a direction of output rotation movement 143. The belt 628 is moved on a plain belt support 372.

The transmission has the roller disc 313 mounted on a stationary base, and the disc 313 conduces the direction of input rotation movement 137; the six rollers with pneumatic-cylindrical tire 335 are supported on a structure with control of the oscillating angle 136, and the rollers 335 have a rotation movement of continuously variable oscillating angle; the rollers 335 drive the main variable movements 138 and 139, and the rollers 335 have a free rotation movement; the plain belt 628 and the two cylindrical pulleys 703 have a continuously variable output rotation movement.

The transmission is depicted in a transmission ratio. The transmission has the traction contact for transmitting the movements between the rollers with pneumatic-cylindrical tire 335 and the plain belt 628. The rollers 335 drive the main variable movement, and a perpendicular movement in relation to the main variable movement.

The main variable movement of the rollers with pneumatic-cylindrical tire 335 is a tangential movement to a contact area, this contact area is formed between the external surfaces of the rollers 335 and the plain belt 628. The contact area is an interaction zone between movements, the main variable movement of the rollers 335 is converted in a main output variable movement of the belt 628. The main output variable movement of the belt 628 is a tangential movement to the contact area. The main output variable movement of the belt 628 is a component of the continuously variable output rotation movement of the belt 628.

The perpendicular movement in relation to the main variable movement of the rollers 335 is converted in the free rotation movement of the rollers 335. This conversion is made in the contact area by the traction contact.

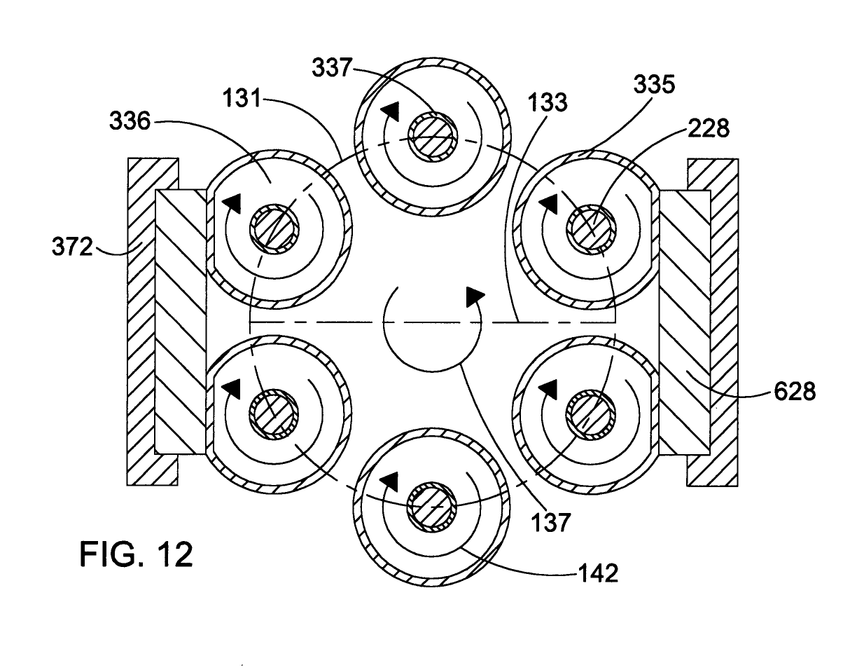

FIG. 12 shows a transverse section of the transmission of FIG. 11. Each one of the six rollers with pneumatic-cylindrical tire 335 is located on a roller base 337 and has a pneumatic chamber 336. The bases 337 are supported on the roller rods 228. A direction of free movement 142 is formed on the rollers 335. The rollers 335 have the traction contact with the plain belt 628.

When all the roller rods 228 rotate around of the middle point of the axis 133 in the direction of input rotation movement 137, the rollers with pneumatic-cylindrical tire 335 rotate around of the central point of the rods 228 in the direction of free movement 142. The direction of rotation of the free movement 142 is opposite to the direction of rotation of the input rotation movement 137. The six roller rods 228 are circumferentially spaced at approximately 60 degrees each one, for obtaining a symmetrical angular configuration with a determined radius from the rotation center in the middle point of the axis 133. The plain belt support 372 permits the movement of the belt 628 in the direction of main variable movement 138 and in the another direction of main variable movement 139, also the support 372 maintains the belt 628 in a appropriated position for the traction contact with the rollers 335.

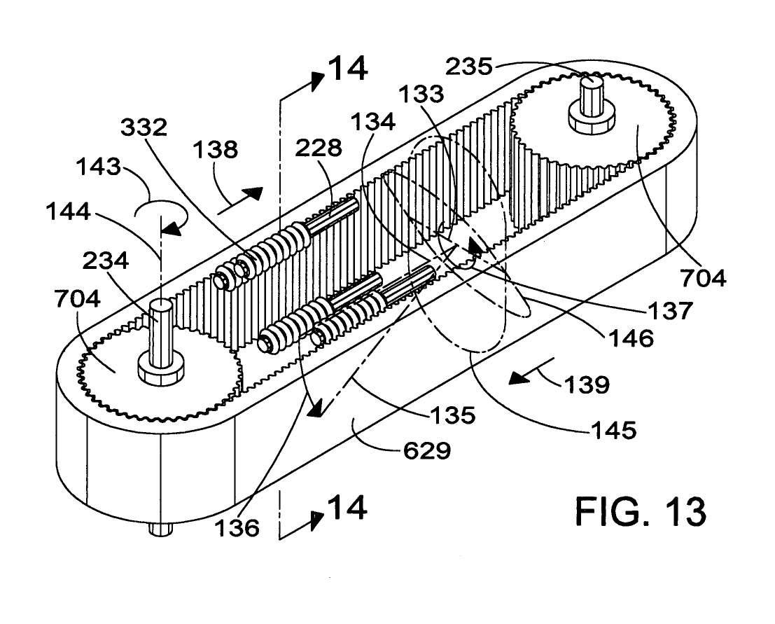

FIG. 13 shows an embodiment of a continuously variable transmission in accordance with the present invention. The continuously variable transmission has the six roller rods 228 which are symmetrically distributed. At one end of the rods 228 are located a rollers with annular teeth 332. The rollers 332 have a gearing contact with a toothed belt 629. The belt 629 is connected to a two toothed pulleys 704. One pulley 704 is supported on the pulley shaft 235, and the another pulley 704 is supported on the rotatable pulley output shaft 234 which transmits the movement of the continuously variable transmission. In the oscillation axis 133 are located a compound trajectory of input rotation movement 145 and a compound trajectory of rotation movement of continuously variable oscillating angle 146.

The transmission has the direction of input rotation movement 137 which is transmitted to the six rollers with annular teeth 332; the rollers 332 are supported on a structure with control of the oscillating angle 136, and the rollers 332 have a rotation movement of continuously variable oscillating angle; the rollers 332 drive the main variable movements 138 and 139, and the rollers 332 have a free rotation movement; the toothed belt 629 and the two toothed pulleys 704 have a continuously variable output rotation movement.

The transmission is depicted in a transmission ratio. The transmission has the gearing contact for transmitting the movements between the rollers with annular teeth 332 and the toothed belt 629. The rollers 332 drive the main variable movement, and a perpendicular movement in relation to the main variable movement.

The main variable movement of the rollers with annular teeth 332 is a normal movement to a contact area, this contact area is formed between the external surfaces of the geared teeth of the rollers 332 and the toothed belt 629. The contact area is an interaction zone between movements, the main variable movement of the rollers 332 is converted in a main output variable movement of the belt 629. The main output variable movement of the belt 629 is a normal movement to the contact area. The main output variable movement of the belt 629 is a component of the continuously variable output rotation movement of the belt 629.

The perpendicular movement in relation to the main variable movement of the rollers 332 is converted in the free rotation movement of the rollers 332.

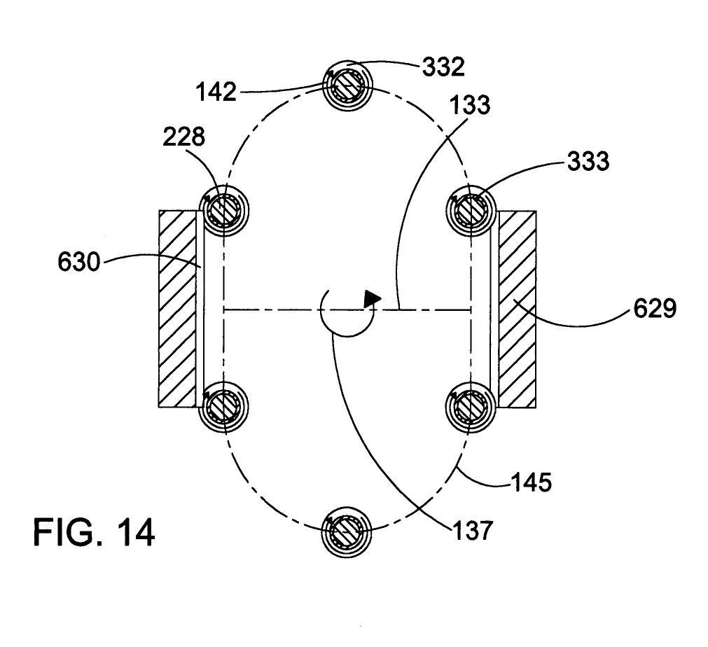

FIG. 14 shows a transverse section of the transmission of FIG. 13. Each one of the six cylindrical rollers 332 is located on a roller base 333. The rollers 332 have the gearing contact with a belt teeth 630 of the belt 629.

The six roller rods 228 are in the compound trajectory of input rotation movement 145 which is formed by a two half circles united by two straight lines. The six rods 228 are symmetrically spaced on the compound trajectory 145.

Occasionally, a collision between teeth of the belt 629 and the rollers 332 can be presented in the transmission; this problem may be reduced with a flexible-toothed belt.

In the straight lines of the compound trajectory 145 and with a determined transmission ratio, the main variable movement, which direction is 138 or 139, has a constant speed along of the straight line; this constant speed of the main variable movement is transmitted to the belt 629.

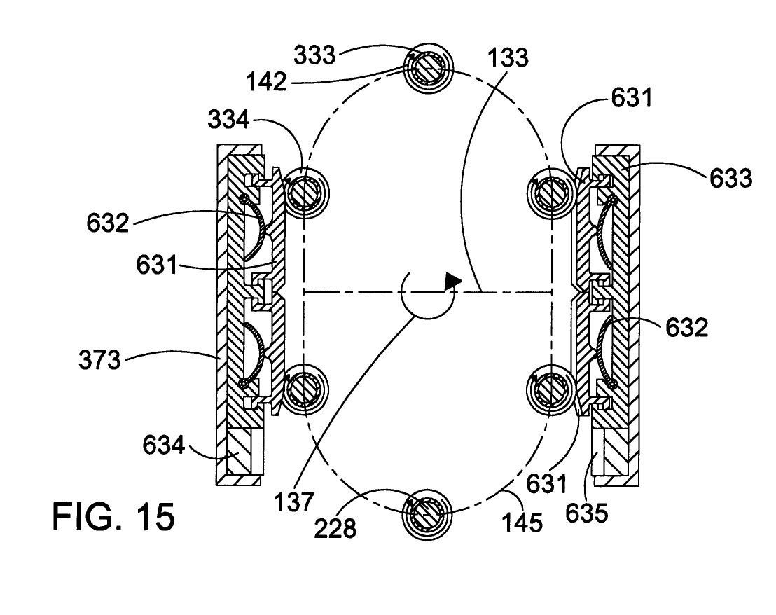

Referring to the FIG. 15, this embodiment is showing a continuously variable transmission in accordance with the present invention, which illustrates a transverse section of the continuously variable transmission that is depicted in FIG. 13 with more functional details. The continuously variable transmission has the six roller rods 228 which are symmetrically distributed. Each one of the rods 228 has a roller with annular teeth 334. The rollers 334 have the gearing contact with a toothed belt 634. The belt 634 has a collapsible teeth 631 which are located on a support 633. The collapsible teeth 631 are in contact with a plate spring 632 which is fixed at one end to the support 633. The belt 634 has a straight teeth 635 located at the lower position. The belt 634 is moved on a belt support 373.

When a collision between teeth of the belt 634 and the rollers 334 is presented in the transmission, the collapsible teeth 631 are displaced in the support 633. The plate springs 632 return the collapsible teeth 631 to its initial position for the gearing contact between teeth.

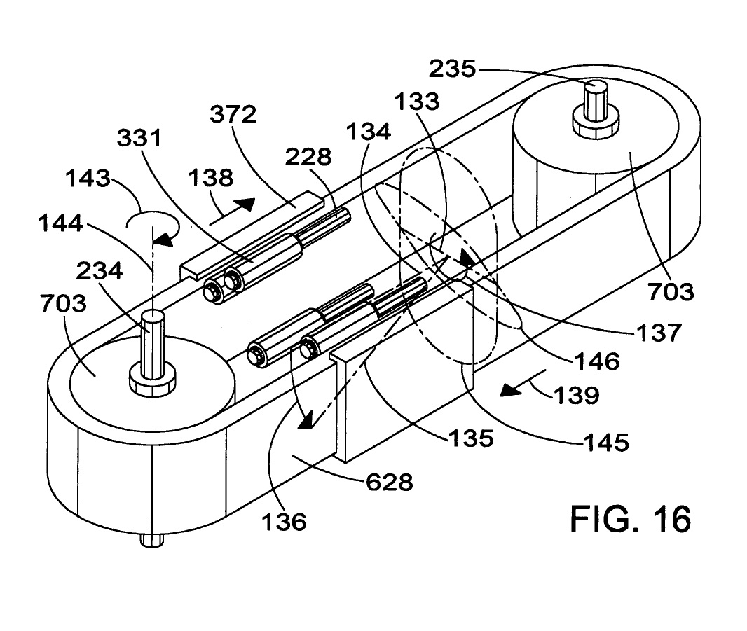

FIG. 16 shows an embodiment of a continuously variable transmission in accordance with the present invention. The continuously variable transmission has the six roller rods 228 which are symmetrically distributed. At one end of the rods 228 are located the cylindrical rollers 331 which are in a traction contact with the plain belt 628.

The transmission has the direction of input rotation movement 137 which is transmitted to the six cylindrical rollers 331; the rollers 331 are supported on a structure with control of the oscillating angle 136, and the rollers 331 have a rotation movement of continuously variable oscillating angle; the rollers 331 drive the main variable movements 138 and 139, and the rollers 331 have a free rotation movement; the plain belt 628 and the two cylindrical pulleys 703 have a continuously variable output rotation movement.

The transmission is depicted in a transmission ratio. The transmission has the traction contact for transmitting the movements between the cylindrical rollers 331 and the plain belt 628. The rollers 331 drive the main variable movement, and a perpendicular movement in relation to the main variable movement.

The main variable movement of the cylindrical rollers 331 is a tangential movement to a contact area, this contact area is formed between the external surfaces of the rollers 331 and the plain belt 628. The contact area is an interaction zone between movements, the main variable movement of the rollers 331 is converted in a main output variable movement of the belt 628. The main output variable movement of the belt 628 is a tangential movement to the contact area. The main output variable movement of the belt 628 is a component of the continuously variable output rotation movement of the belt 628.

The perpendicular movement in relation to the main variable movement of the cylindrical rollers 331 is converted in the free rotation movement of the rollers 331. This conversion is made in the contact area by the traction contact.

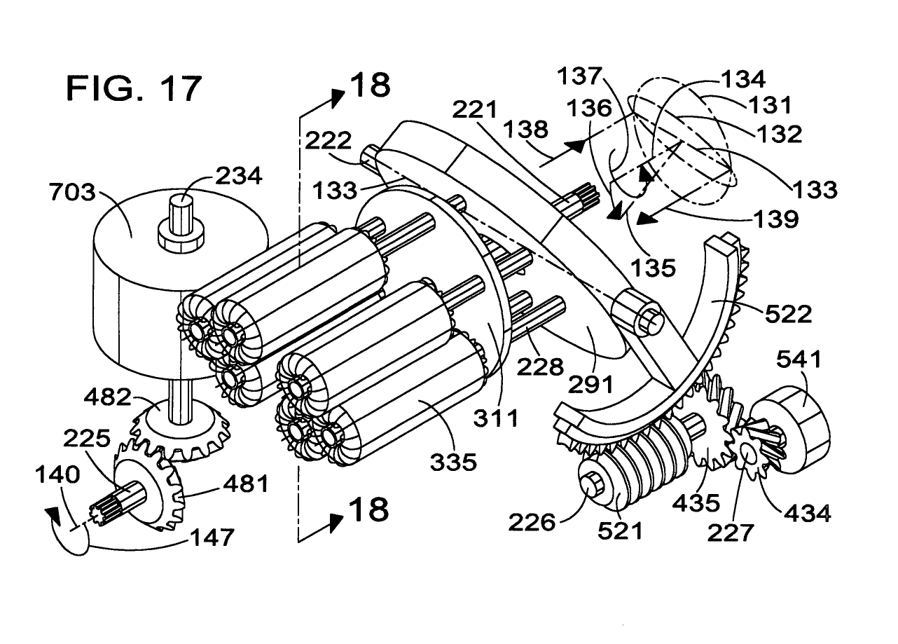

Referring to the FIG. 17, there is shown an embodiment of a continuously variable transmission in accordance with the present invention. The continuously variable transmission has the six roller rods 228 which are circumferentially and symmetrically distributed. At one end of the rods 228 are located the rollers with pneumatic-cylindrical tire 335. At least one of the six rods 228 has a traction contact with the cylindrical pulley 703. The pulley 703 rotates with the shaft 234 and the spiral bevel gear 481 which is engaged with the spiral bevel gear 482. The gear 482 is mounted on the rotatable output shaft 225. The shaft 225 is determined by the output axial axis 140 with a direction of output rotation movement 147.

The transmission has the roller disc 311 mounted on a stationary base, and the disc 311 conduces the direction of input rotation movement 137; the six rollers with pneumatic-cylindrical tire 335 are supported on a structure with control of the oscillating angle 136, and the rollers 335 have a rotation movement of continuously variable oscillating angle; the rollers 335 drive the main variable movements 138 and 139, and the rollers 335 have a free rotation movement; the cylindrical pulley 703 has a continuously variable output rotation movement.

The transmission is depicted in a transmission ratio. The transmission has the traction contact for transmitting the movements between the rollers with pneumatic-cylindrical tire 335 and the cylindrical pulley 703. The rollers 335 drive the main variable movement, and a perpendicular movement in relation to the main variable movement.

The main variable movement of the rollers with pneumatic-cylindrical tire 335 is a tangential movement to a contact area, this contact area is formed between the external surfaces of the rollers 335 and the cylindrical pulley 703. The contact area is an interaction zone between movements, the main variable movement of the rollers 335 is converted in a main output variable movement of the pulley 703. The main output variable movement of the pulley 703 is a tangential movement to the contact area. The main output variable movement of the pulley 703 is a component of the continuously variable output rotation movement of the pulley 703.

The perpendicular movement in relation to the main variable movement of the cylindrical rollers 335 is converted in the free rotation movement of the rollers 335. This conversion is made in the contact area by the traction contact.

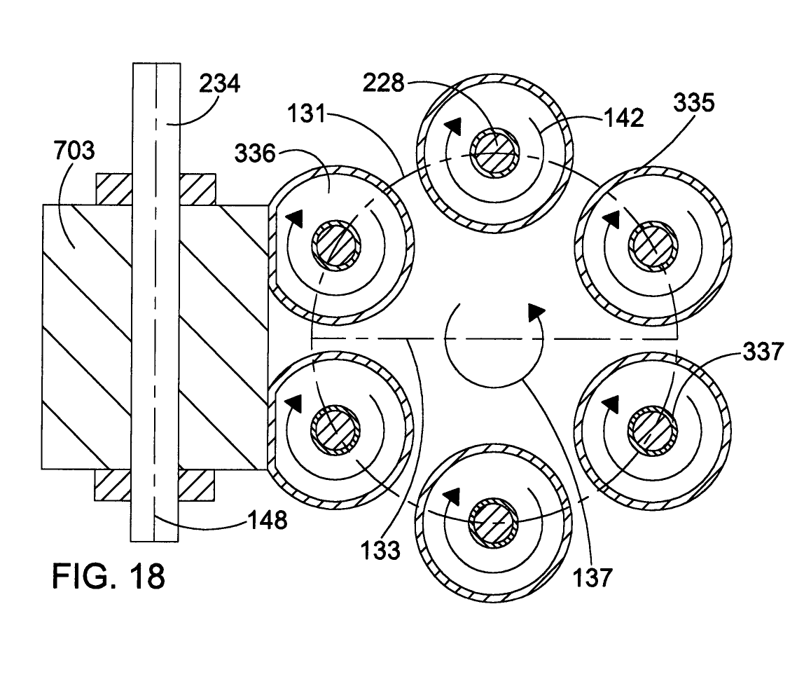

FIG. 18 shows a transverse section of the transmission of FIG. 17. Each one of the six rollers with pneumatic-cylindrical tire 335 is located on the roller base 337 and has the pneumatic chamber 336. The bases 337 are supported on the roller rods 228. The direction of free movement 142 is formed on the rollers 335. The rollers 335 have the traction contact with the cylindrical pulley 703 which is rotated around of its symmetry axis 148.

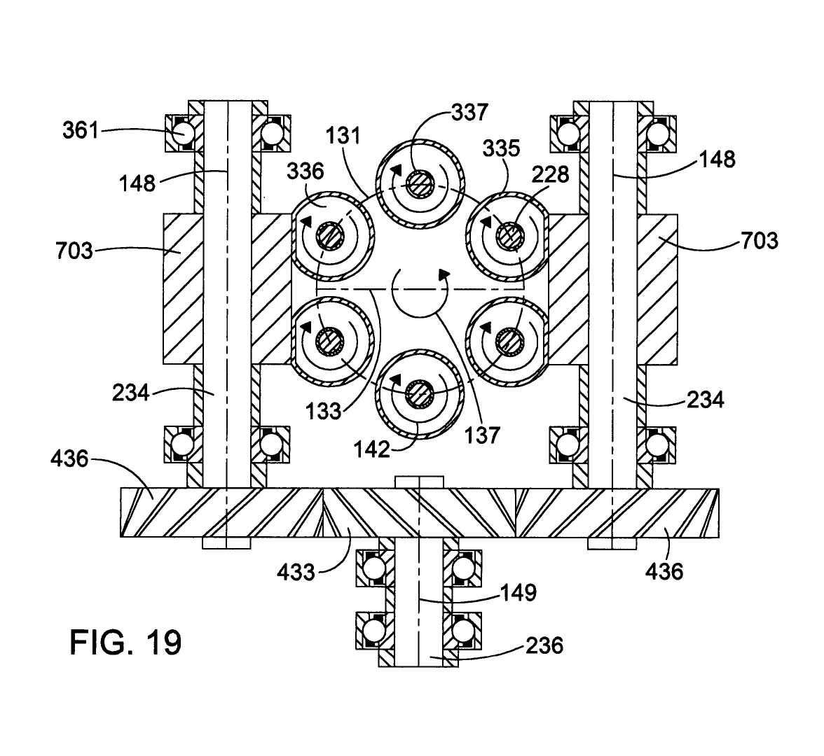

Referring to the FIG. 19, this embodiment is showing a continuously variable transmission in accordance with the present invention, which illustrates a transverse section of the continuously variable transmission that is depicted in FIG. 17 with more functional details. The continuously variable transmission has the two cylindrical pulleys 703 which are in traction contact with rollers with pneumatic-cylindrical tire 335. The shaft 234 in the left side of the six roller rods 228 has a parallel direction to the shaft 234 in the right side. The shafts 234 are connected to the two helical gears 436 which are engaged with the helical gears 433. The helical gear 433 is supported on a shaft 236 which is rotated around of its symmetry axis 149.

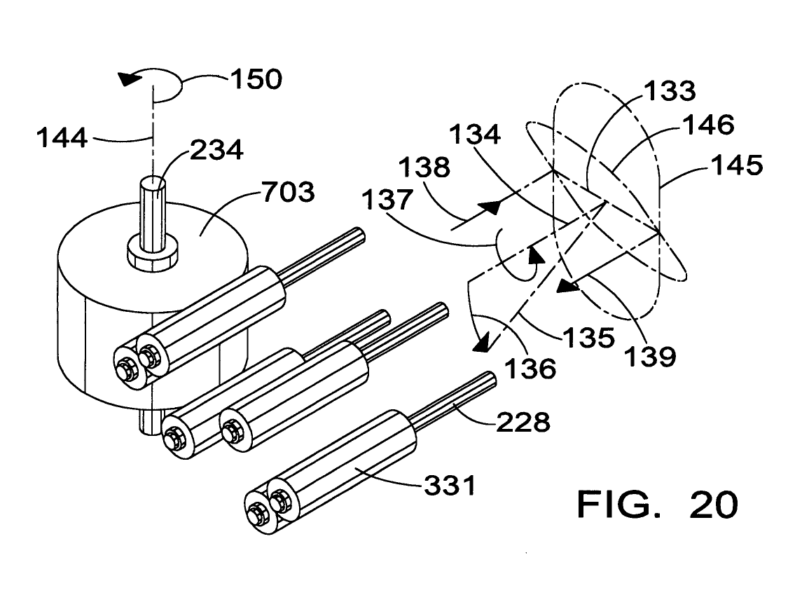

FIG. 20 shows an embodiment of a continuously variable transmission in accordance with the present invention. The continuously variable transmission has the six roller rods 228 which are symmetrically distributed in relation to the compound trajectory of input rotation movement 145 which is formed by a two half circles united by two straight lines. At one end of the rods 228 are located the cylindrical rollers 331. At least one of the six rollers 331 has a traction contact with the cylindrical pulley 703. The pulley 703 is supported on the output shaft 234, which transmits the movement of the continuously variable transmission. The shaft 234 is determined by the output axial axis 144 with a direction of output rotation movement 150.

The transmission has the direction of input rotation movement 137 which is transmitted to the six cylindrical rollers 331; the rollers 331 are supported on a structure with control of the oscillating angle 136, and the rollers 331 have a rotation movement of continuously variable oscillating angle; the rollers 331 drive the main variable movements 138 and 139, and the rollers 331 have a free rotation movement; the cylindrical pulley 703 has a continuously variable output rotation movement.

The transmission is depicted in a transmission ratio. The transmission has the traction contact for transmitting the movements between the cylindrical rollers 331 and the cylindrical pulley 703. The rollers 331 drive the main variable movement, and a perpendicular movement in relation to the main variable movement.

The main variable movement of the cylindrical rollers 331 is a tangential movement to a contact area, this contact area is formed between the external surfaces of the rollers 331 and the cylindrical pulley 703. The contact area is an interaction zone between movements, the main variable movement of the rollers 331 is converted in a main output variable movement of the pulley 703. The main output variable movement of the pulley 703 is a tangential movement to the contact area. The main output variable movement of the pulley 703 is a component of the continuously variable output rotation movement of the pulley 703.

The perpendicular movement in relation to the main variable movement of the cylindrical rollers 331 is converted in the free rotation movement of the rollers 331. This conversion is made in the contact area by the traction contact.

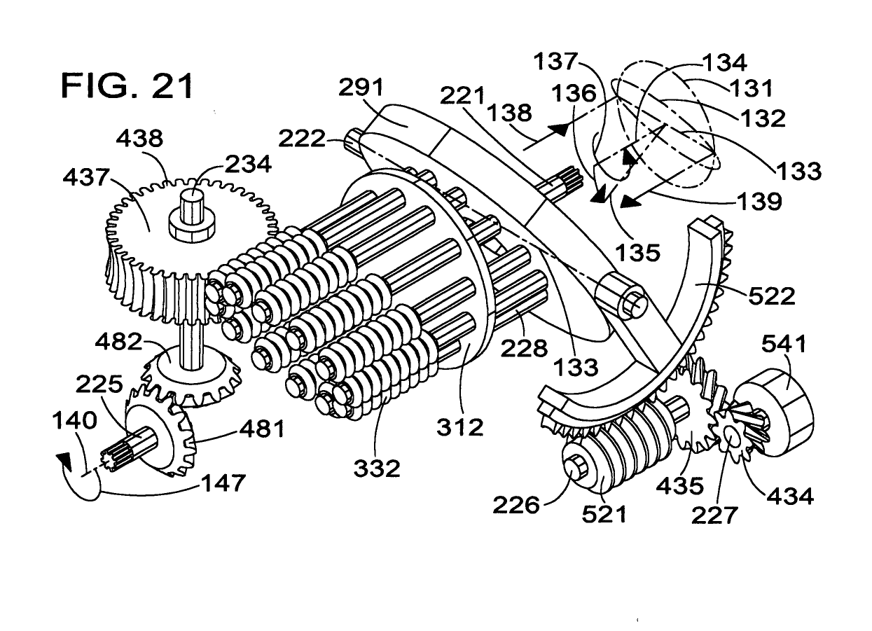

Referring to the FIG. 21, there is shown an embodiment of a continuously variable transmission in accordance with the present invention. The continuously variable transmission has the twelve roller rods 228 which are circumferentially and symmetrically distributed. At one end of the rods 228 are located the rollers with annular teeth 332. At least one of the twelve rollers 332 has a gearing contact with a compound gear 437. The compound gear 437 has a collapsible teeth 438. The gear 437 rotates with the shaft 234 and the spiral bevel gear 481 which is engaged with the spiral bevel gear 482. The gear 482 is mounted on the rotatable output shaft 225. The shaft 225 is determined by the output axial axis 140 with a direction of output rotation movement 147.

When a collision between teeth of the rollers 332 and the compound gear 437 is presented in the transmission, the collapsible teeth 438 are internally displaced to permit the rotation movement of the rollers 332.

The transmission has the roller disc 312 mounted on a stationary base, and the disc 312 conduces the direction of input rotation movement 137; the twelve rollers with annular teeth 332 are supported on a structure with control of the oscillating angle 136, and the rollers 332 have a rotation movement of continuously variable oscillating angle; the rollers 332 drive the main variable movements 138 and 139, and the rollers 332 have a free rotation movement; the compound gear 437 has a continuously variable output rotation movement.

The transmission is depicted in a transmission ratio. The transmission has the gearing contact for transmitting the movements between the rollers with annular teeth 332 and the compound gear 437. The rollers 332 drive the main variable movement, and a perpendicular movement in relation to the main variable movement.

The main variable movement of the rollers with annular teeth 332 is a normal movement to a contact area, this contact area is formed between the external surfaces of the geared teeth of the rollers 332 and the compound gear 437. The contact area is an interaction zone between movements, the main variable movement of the rollers 332 is converted in a main output variable movement of the gear 437. The main output variable movement of the gear 437 is a normal movement to the contact area. The main output variable movement of the gear 437 is a component of the continuously variable output rotation movement of the gear 437.

The perpendicular movement in relation to the main variable movement of the rollers 332 is converted in the free rotation movement of the rollers 332.

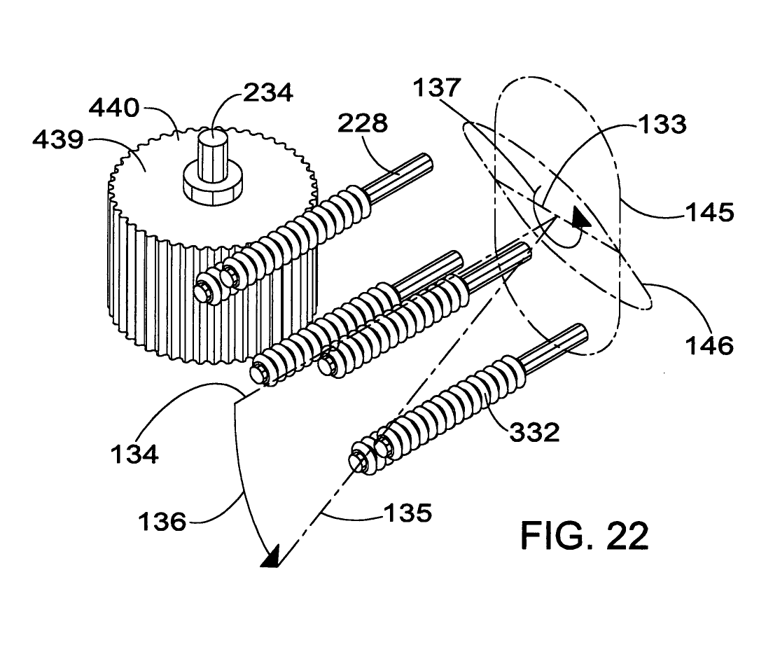

Referring to the FIG. 22, there is shown an embodiment of a continuously variable transmission in accordance with the present invention. The continuously variable transmission has the six roller rods 228 which are symmetrically distributed. At one end of the rods 228 are located the rollers with annular teeth 332. At least one of the six rollers 332 has a gearing contact with a compound gear 439. The compound gear 439 has a collapsible teeth 440. The gear 439 rotates with the output shaft 234.

When a collision between teeth of the rollers 332 and the compound gear 439 is presented in the transmission, the collapsible teeth 440 are internally displaced to permit the rotation movement of the rollers 332.

The transmission has the direction of input rotation movement 137 which is transmitted to the six rollers with annular teeth 332; the rollers 332 are supported on a structure with control of the oscillating angle 136, and the rollers 332 have a rotation movement of continuously variable oscillating angle; the rollers 332 drive a main variable movement, and the rollers 332 have a free rotation movement; the compound gear 439 has a continuously variable output rotation movement.

The transmission is depicted in a transmission ratio. The transmission has the gearing contact for transmitting the movements between the rollers with annular teeth 332 and the compound gear 439. The rollers 332 drive the main variable movement, and a perpendicular movement in relation to the main variable movement.

The main variable movement of the rollers with annular teeth 332 is a normal movement to a contact area, this contact area is formed between the external surfaces of the geared teeth of the rollers 332 and the compound gear 439. The contact area is an interaction zone between movements, the main variable movement of the rollers 332 is converted in a main output variable movement of the gear 439. The main output variable movement of the gear 439 is a normal movement to the contact area. The main output variable movement of the gear 439 is a component of the continuously variable output rotation movement of the gear 439.

The perpendicular movement in relation to the main variable movement of the rollers 332 is converted in the free rotation movement of the rollers 332.

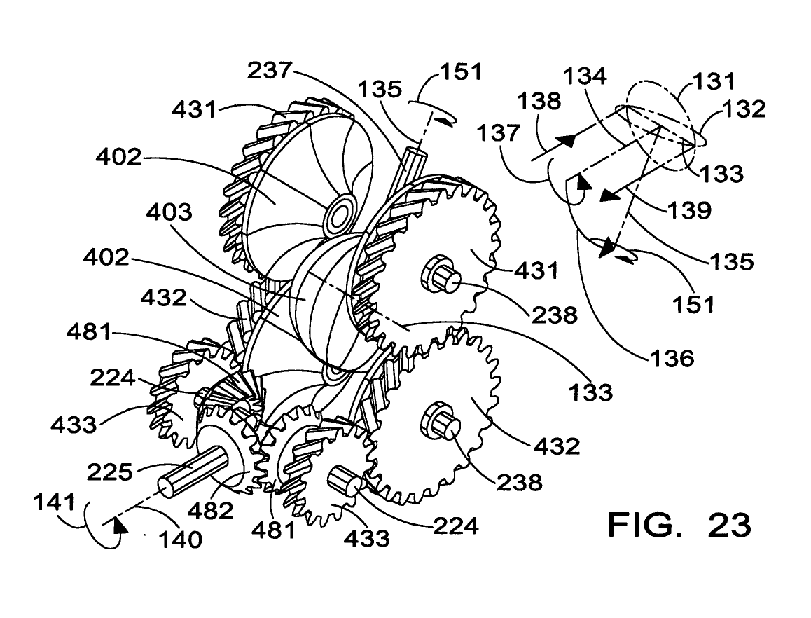

Referring to the FIG. 23, there is shown an embodiment of a continuously variable transmission in accordance with the present invention. The continuously variable transmission has a sphere shaft 237 which is connected at one side to a sphere 403. The sphere 403 is pivotable around of the oscillation axis 133. The sphere 403 has a traction contact with a four compound-half-toroidal discs 402 through a traction oil system (not shown). The discs 402 are mounted on a half-toroidal disc shafts 238. The four discs 402 are circumferentially located around the sphere 403. The four discs 402 transmit the rotation movement to the output shaft 225 through a gear set. The sphere shaft 237 has a direction of rotation movement of continuously variable oscillating angle 151.

The transmission has the direction of input rotation movement 137 which is transmitted to the sphere 403; the sphere 403 is supported on a structure with control of the oscillating angle 136, and the sphere 403 has a rotation movement of continuously variable oscillating angle; the sphere 403 drives the main variable movements 138 and 139; the four compound-half-toroidal discs 402 have a plurality of elements with a free rotation movement, and the discs 402 have a continuously variable output rotation movement.

The transmission is depicted in a transmission ratio. The transmission has the traction contact for transmitting the movements between the sphere 403 and the four compound-half-toroidal discs 402. The sphere 403 drives the main variable movement, and a perpendicular movement in relation to the main variable movement.

The main variable movement of the sphere 403 is a tangential movement to a contact area, this contact area is formed between the external surfaces of the sphere 403 and the four compound-half-toroidal discs 402. The contact area is an interaction zone between movements, the main variable movement of the sphere 403 is converted in a main output variable movement of the discs 402. The main output variable movement of the discs 402 is a tangential movement to the contact area. The main output variable movement of the discs 402 is a component of the continuously variable output rotation movement of the discs 402.

The perpendicular movement in relation to the main variable movement of the sphere 403 is converted in the free rotation movement of a components of the four compound-half-toroidal discs 402. This conversion is made in the contact area by the traction contact.

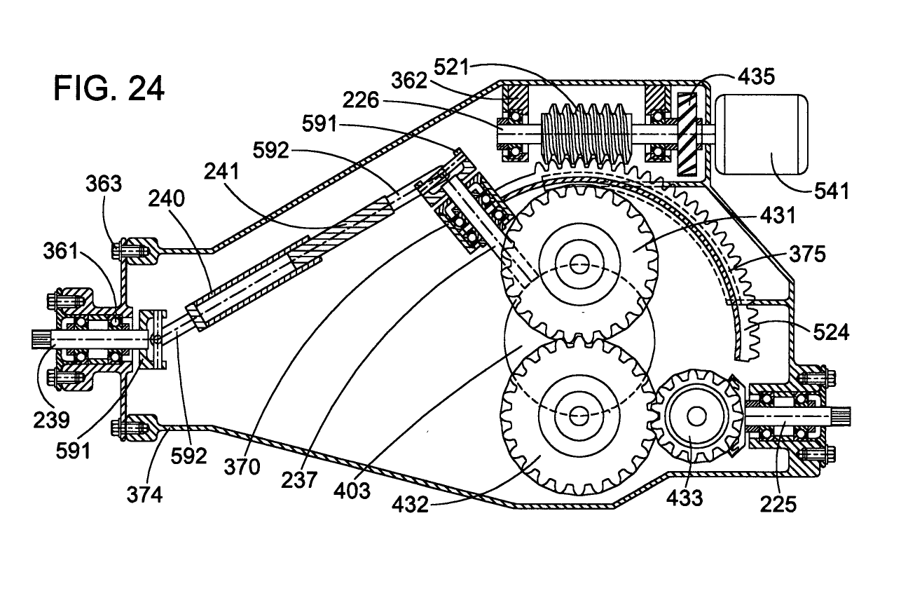

Referring to the FIG. 24, this embodiment is showing a continuously variable transmission in accordance with the present invention, which illustrates a longitudinal section of the continuously variable transmission that is depicted in FIG. 23 with more functional details. The continuously variable transmission has an input shaft 239 which is connected to a universal joints 591 and 592. The joint 592 is connected to an internal telescopic shaft 240 with an internal telescopic shaft 241. The shaft 241 is connected to the joints 592 and 591. The joint 591 is connected to the sphere shaft 237 which drives the sphere 403. The sphere 403 has a regulated oscillation around of the oscillation axis 133 which intersects the center of the sphere 403. The sphere shaft 237 is oscillated through a gear 524 which is engaged with the worm 521. The worm 521 is rotated with the worm shaft 226 by the control motor 541. The gear 524 is mounted on a gear support 375. A housing 374 uses the bolts 363 to joint its parts.

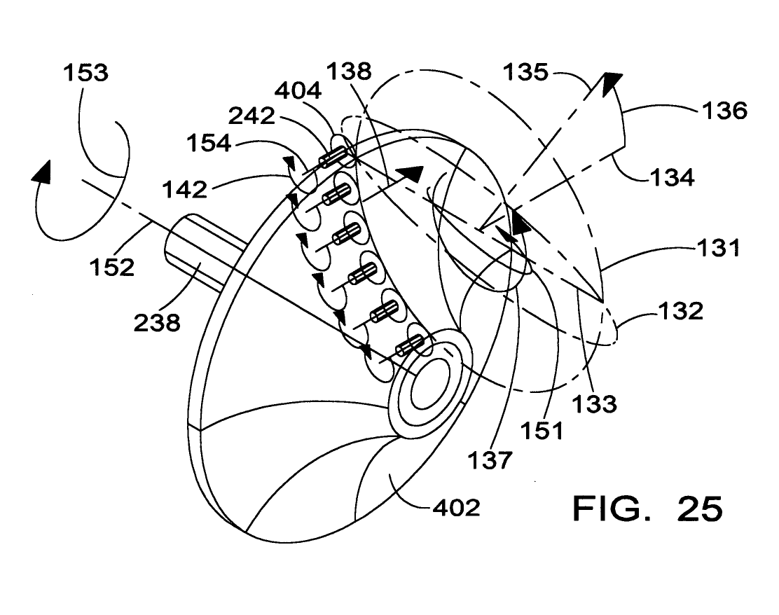

FIG. 25 shows a perspective of a component of the continuously variable transmission of FIG. 24. The component is a part of the compound-half-toroidal disc 402. The component is formed with a ball 404 which is mounted on a ball shaft 242. The shaft 242 has a ball shaft axis 154. The disc 402 is mounted on the half-toroidal disc shaft 238. The shaft 238 has a compound-half-toroidal disc axis 152 and a direction of rotation movement of compound-half-toroidal disc 153.

When the sphere 403 has the direction of rotation movement of continuously variable oscillating angle 151, and the sphere 403 has the traction contact with the ball 404 through a traction oil film, the direction of main variable movement 138 of the sphere 403 is transmitted to the ball 404, and this ball 404 is moved with the compound-half-toroidal disc 402 in the direction of rotation movement of compound-half-toroidal disc 153; additionally, the other directions of movement of the sphere 403 are transmitted to the balls 404, and these balls 404 are rotated around of its ball shaft axis 154 with the direction of free movement 142. The direction of rotation of the free movement 142 is opposite to the direction of rotation of the input rotation movement 137.

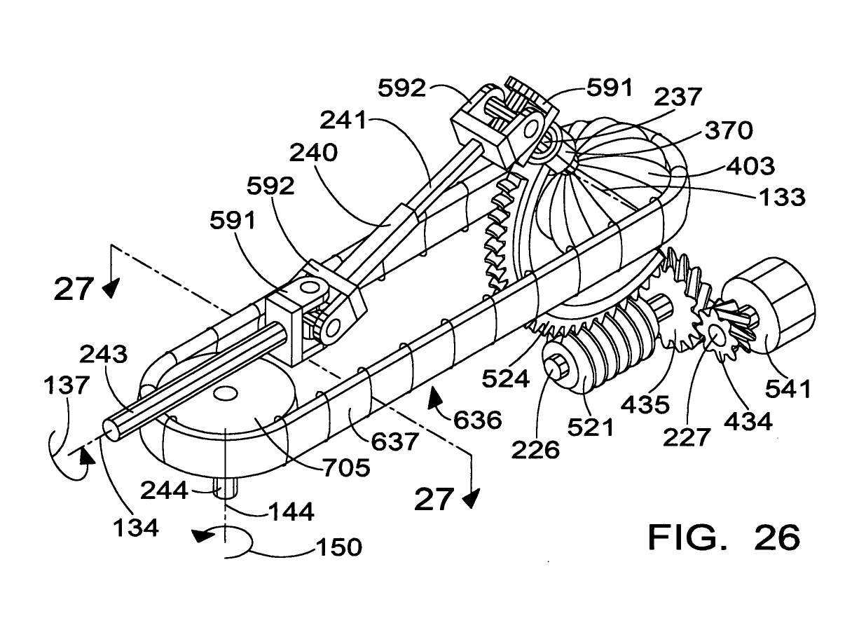

Referring to the FIG. 26, there is shown an embodiment of a continuously variable transmission in accordance with the present invention. The continuously variable transmission has an input shaft 243 which is connected to the universal joints 591 and 592. The joint 592 is connected to the external telescopic shaft 240 with the internal telescopic shaft 241. The shaft 241 is connected to the joints 592 and 591. The joint 591 is connected to the sphere shaft 237 which drives the sphere 403. The sphere 403 has a regulated oscillation around of the oscillation axis 133. The sphere shaft 237 is oscillated through the gear 524 which is engaged with the worm 521. The worm 521 is rotated with the worm shaft 226 by the control motor 541. The sphere 403 has a traction contact with a compound belt with concave shape 636. The compound belt 636 is formed of a annular belts with concave shape 637. The compound belt 636 drives a pulley with spherical shape 705 which is mounted on an output shaft 244. The shaft 244 has the output axial axis 144 with the direction of output rotation movement 150.

The transmission has the input shaft 243 mounted on a stationary base, and the shaft 243 conduces the direction of input rotation movement 137; the sphere 403 is supported on a structure with control of the oscillating angle, and the sphere 403 has a rotation movement of continuously variable oscillating angle; the sphere 403 drives a main variable movement; the annular belts 637 have a free rotation movement, and the compound belt 636 and the pulley with spherical shape 705 have a continuously variable output rotation movement.

The transmission is depicted in a transmission ratio. The transmission has the traction contact for transmitting the movements between the sphere 403 and the compound belt 636. The sphere 403 drives the main variable movement, and a perpendicular movement in relation to the main variable movement.

The main variable movement of the sphere 403 is a tangential movement to a contact area, this contact area is formed between the external surfaces of the sphere 403 and the compound belt 636. The contact area is an interaction zone between movements, the main variable movement of the sphere 403 is converted in a main output variable movement of the belt 636. The main output variable movement of the belt 636 is a tangential movement to the contact area. The main output variable movement of the belt 636 is a component of the continuously variable output rotation movement of the belt 636.

The perpendicular movement in relation to the main variable movement of the sphere 403 is converted in the free rotation movement of the annular belts 637. This conversion is made in the contact area by the traction contact.

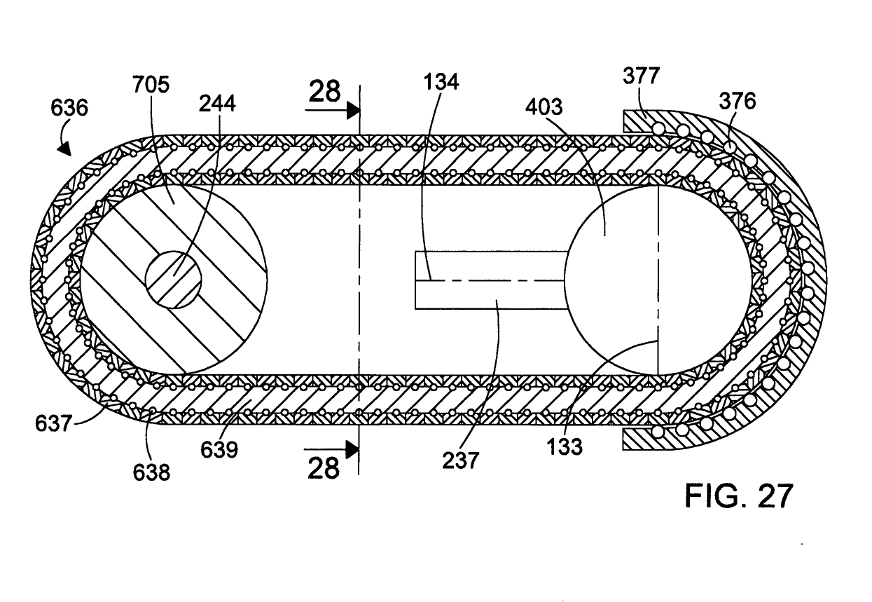

FIG. 27 shows a longitudinal section of the transmission of FIG. 26. The compound belt with concave shape 636 is formed of the annular belts with concave shape 637 with a belt balls 638 and an internal belt with concave shape 639. The compound belt 636 is moved on a concave support 377. The support 377 has a balls 376. The annular belts 637 have a slipping lateral areas; these slipping lateral areas permit the free rotation movement between the annular belts 637.

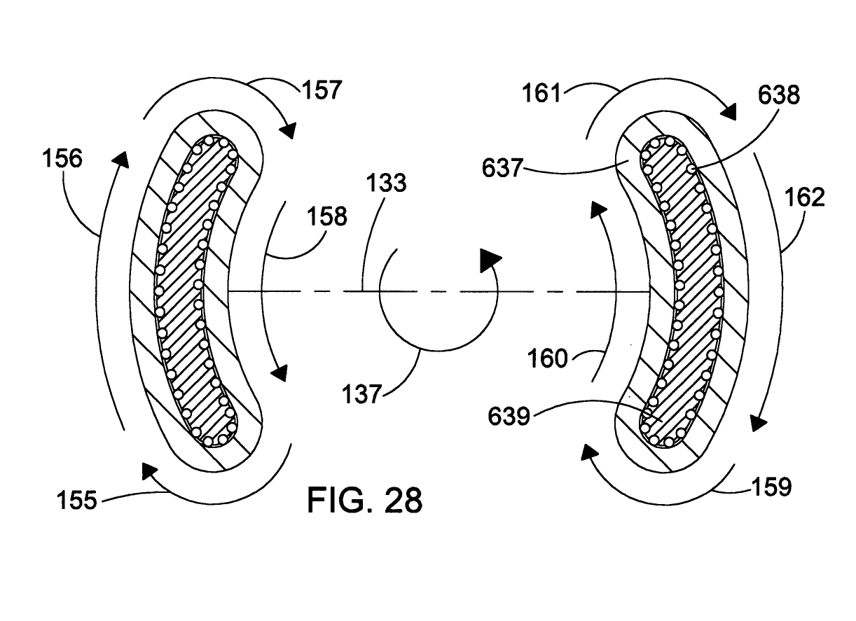

FIG. 28 shows a transverse section of the transmission of FIG. 27. The compound belt with concave shape 636 has the annular belts with concave shape 637 with the balls 638 and the internal belt with concave shape 639. A directions of free movement 155-162 are formed on the annular belts 637.

When the sphere 403 is in traction contact with the annular belts with concave shape 637, the direction of main variable movement of the sphere 403 is transmitted to the compound belt 636; additionally, the other directions of movement of the sphere 403 is transmitted to the annular belts 637 which are rotated around of its internal belt with concave shape 639 using the balls 638, thus the annular belts 637 have the directions of free movement 155-162. The directions of rotation of the free movement 155-162 are opposite to the direction of rotation of the input rotation movement 137.

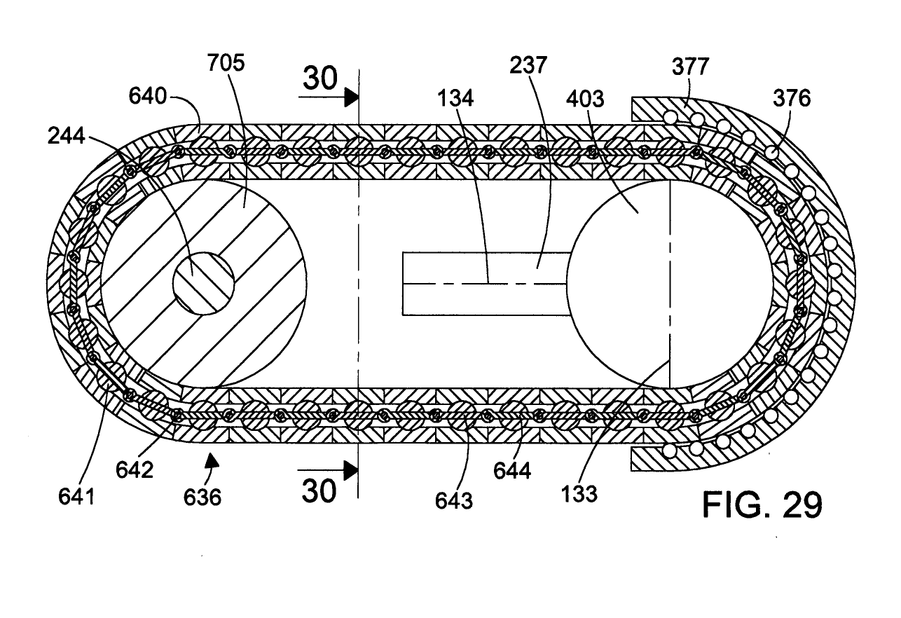

Referring to the FIG. 29, this embodiment is showing a continuously variable transmission in accordance with the present invention, which illustrates a longitudinal section of the transmission of FIG. 26 with more functional details. The compound belt with concave shape 636 is formed of an annular belts with concave shape 640 with a holed balls 641 and an internal belt supports with concave shape 642. The balls 641 are mounted on a belt ball shafts 643 and 644. The compound belt 636 is moved on the concave support 377. The support 377 has the balls 376.

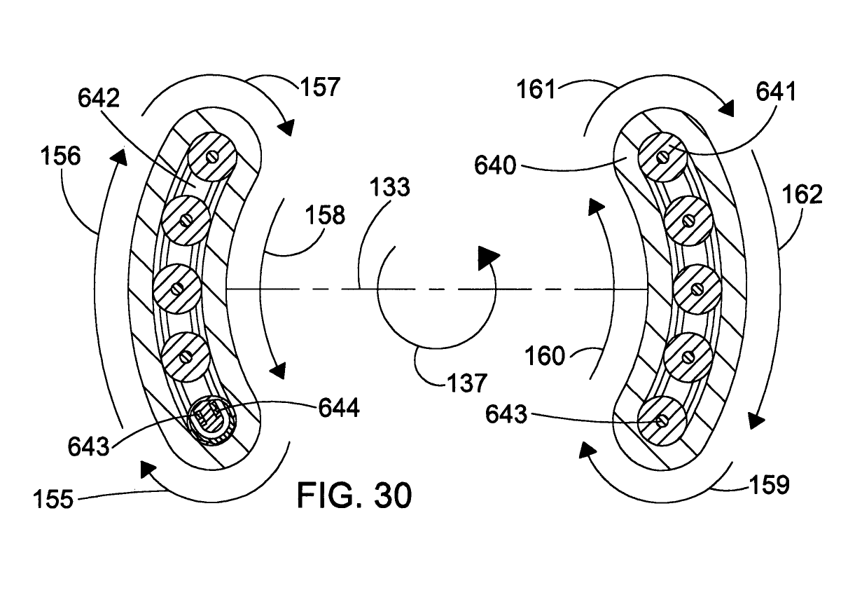

FIG. 30 shows a transverse section of the transmission of FIG. 29. The compound belt with concave shape 636 has the annular belts with concave shape 640 with the holed balls 641 and the internal belt supports with concave shape 642. The directions of free movement 155-162 are formed on the annular belts 640.

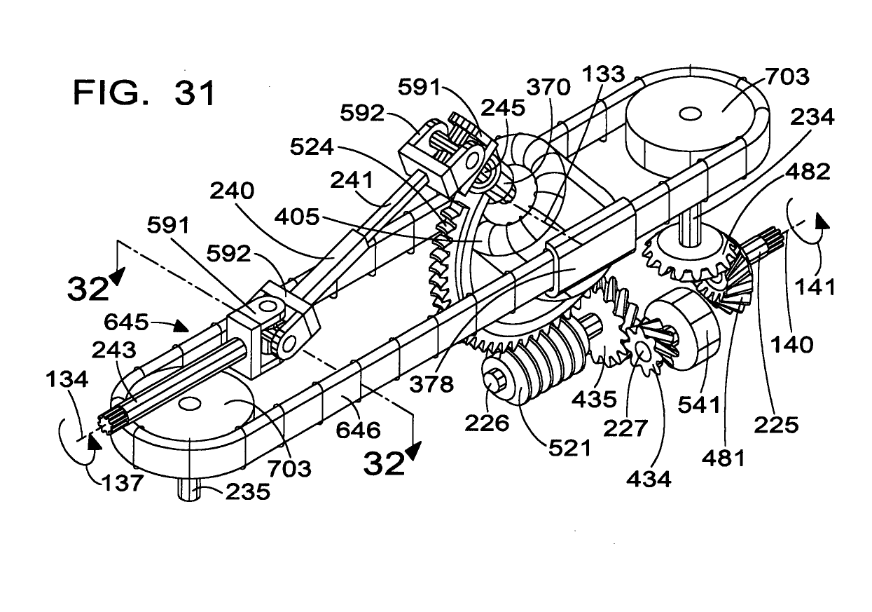

Referring to the FIG. 31, there is shown an embodiment of a continuously variable transmission in accordance with the present invention. The continuously variable transmission has the input shaft 243 which is connected to the universal joints 591 and 592. The joint 592 is connected to the external telescopic shaft 240 with the internal telescopic shaft 241. The shaft 241 is connected to the joints 592 and 591. The joint 591 is connected to a tire shaft 245 which drives a pneumatic-cylindrical tire 405. The tire 405 has a regulated oscillation around of the oscillation axis 133. The tire 405 is oscillated through the gear 524 which is engaged with the worm 521. The worm 521 is rotated with the worm shaft 226 by the control motor 541. The tire 405 has a traction contact with a compound belt 645. The compound belt 645 is formed of an annular belts 646. The belt 645 drives the two cylindrical pulleys 703. One of the pulleys 703 is supported on the output shaft 234 which transmits the movement to the spiral bevel gear 481. The gear 481 is engaged with the spiral bevel gear 482. The gear 482 is mounted on the rotatable output shaft 225. The shaft 225 is determined by the output axial axis 140 with a direction of output rotation movement 141. The belt 645 is moved on a belt support 378.

The transmission has the input shaft 243 mounted on a stationary base, and the shaft 243 conduces the direction of input rotation movement 137; the pneumatic-cylindrical tire 405 is supported on a structure with control of the oscillating angle, and the tire 405 has a rotation movement of continuously variable oscillating angle; the tire 405 drives a main variable movement; the annular belts 646 have a free rotation movement, and the compound belt 645 and the two cylindrical pulleys 703 have a continuously variable output rotation movement.

The transmission is depicted in a transmission ratio. The transmission has the traction contact for transmitting the movements between the pneumatic-cylindrical tire 405 and the compound belt 645 The tire 405 drives the main variable movement, and a perpendicular movement in relation to the main variable movement.

The main variable movement of the pneumatic-cylindrical tire 405 is a tangential movement to a contact area, this contact area is formed between the external surfaces of the tire 405 and the compound belt 645. The contact area is an interaction zone between movements, the main variable movement of the tire 405 is converted in a main output variable movement of the belt 645. The main output variable movement of the belt 645 is a tangential movement to the contact area. The main output variable movement of the belt 645 is a component of the continuously variable output rotation movement of the belt 645.

The perpendicular movement in relation to the main variable movement of the tire 405 is converted in the free rotation movement of the annular belts 646. This conversion is made in the contact area by the traction contact.

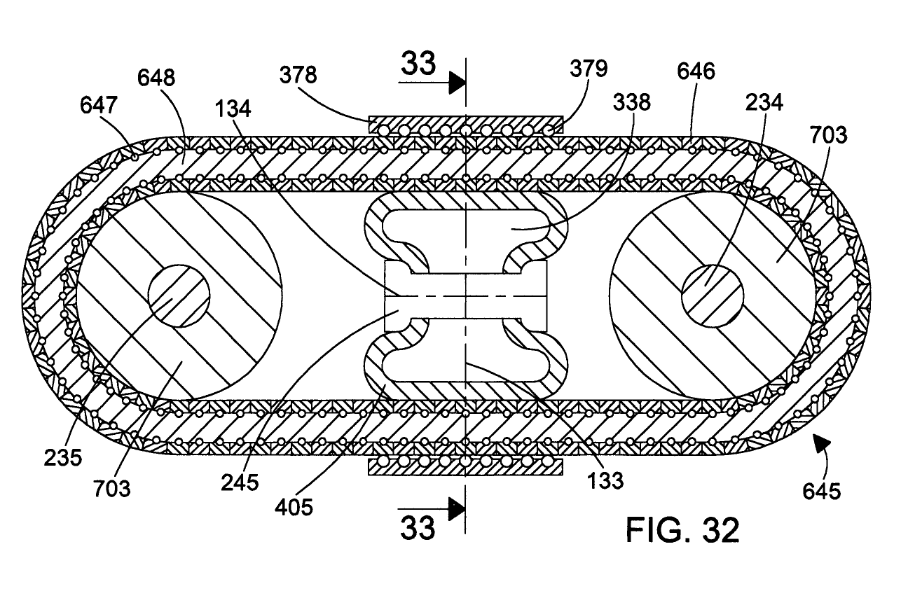

FIG. 32 shows a longitudinal section of the transmission of FIG. 31. The compound belt 645 is formed of the annular belts 646 with a balls 647 and an internal belt 648. The compound belt 645 is moved on the belt support 378 which has a balls 379. The pneumatic-cylindrical tire 405 has a pneumatic chamber 338. The annular belts 646 have a slipping lateral areas; these slipping lateral areas permit the free rotation movement between the annular belts 646.

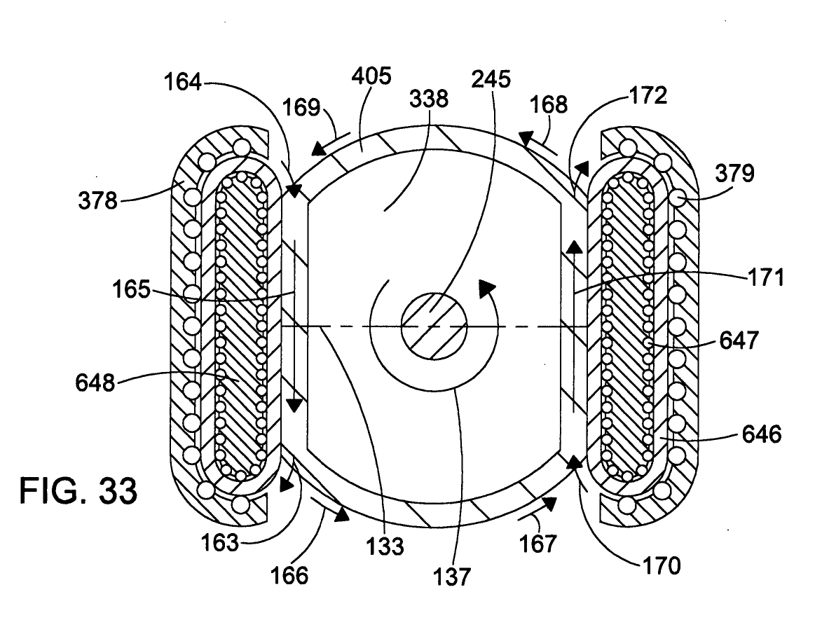

FIG. 33 shows a transverse section of the transmission of FIG. 32. The compound belt 645 has the annular belts 646 with the balls 647 and the internal belt 648. A directions of free movement 163-165 and 170-172 are formed on the annular belts 646. A directions of input rotation movement 166-169 are formed on the pneumatic-cylindrical tire 405.

When the pneumatic-cylindrical tire 405 has the traction contact with the annular belts 646, the direction of main variable movement of the pneumatic-cylindrical tire 405 is transmitted to the compound belt 645; additionally, the other directions of movement of the tire 405 is transmitted to the belts 646 which are rotated around of its internal belt 648 using the balls 647, thus the belts 646 have the directions of free movement 163-165 and 170-172. The directions of rotation of the free movement 163-165 and 170-172 are opposite to the direction of rotation of the input rotation movement 137.

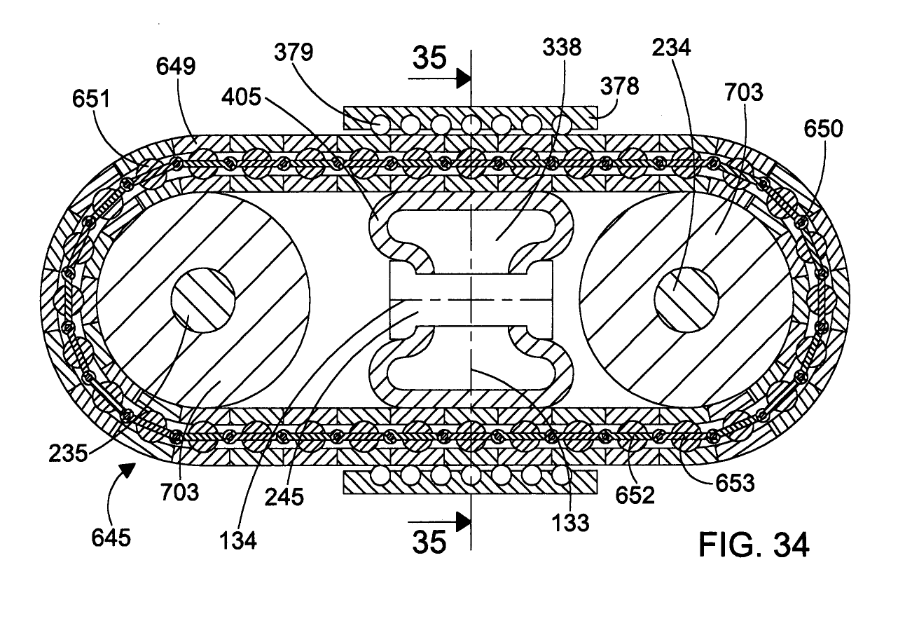

Referring to the FIG. 34, this embodiment is showing a continuously variable transmission in accordance with the present invention, which illustrates a longitudinal section of the transmission of FIG. 31 with more functional details. The compound belt 645 is formed of an annular belts 649 with a holed balls 651 and an internal belt supports 650. The balls 651 are mounted on a belt ball shafts 652 and 653. The belt 645 is moved on the belt supports 378 which have a balls 379. The pneumatic-cylindrical tire 405 has a pneumatic chamber 338. The belts 649 have a slipping lateral areas; these slipping lateral areas permit the free rotation movement between the belts 649.

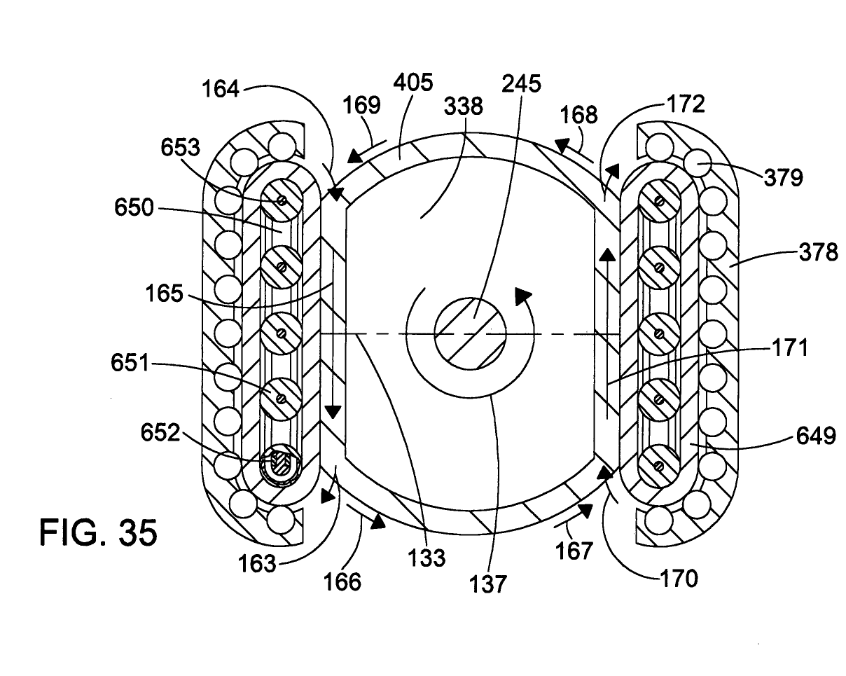

FIG. 35 shows a transverse section of the transmission of FIG. 34. The compound belt 645 has the annular belts 649 with the holed balls 651 and the internal belt supports 650. A directions of free movement 163-165 and 170-172 are formed on the belts 649. A directions of input rotation movement 166-169 are formed on the pneumatic-cylindrical tire 405.

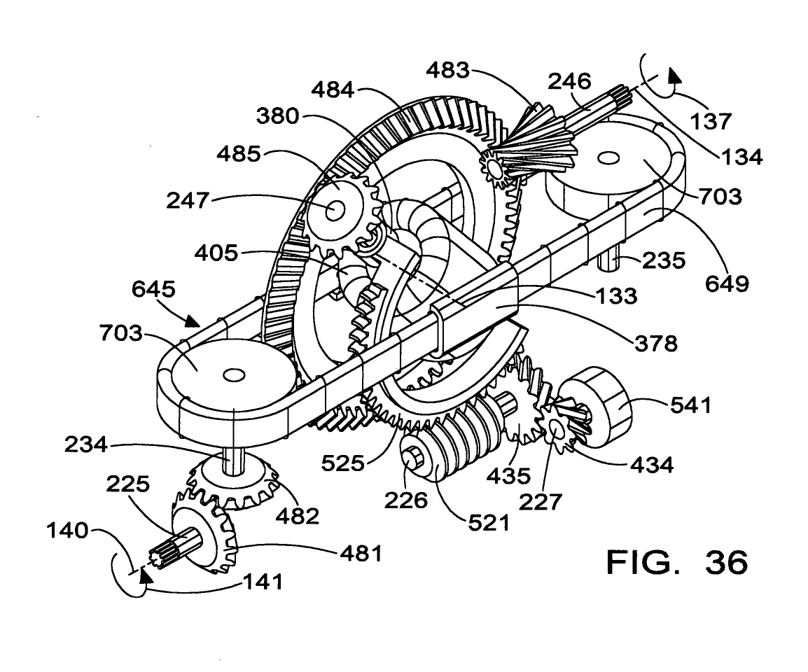

Referring to the FIG. 36, there is shown an embodiment of a continuously variable transmission in accordance with the present invention. The continuously variable transmission has the input shaft 246 which is connected to an input pinion gear 483. The gear 483 is engaged with a ring gear 484 which is engaged with a spiral bevel gear 485. The gear 485 rotates a tire shaft 247 which drives the pneumatic-cylindrical tire 405. The shaft 247 is mounted on a bearing support 380. The tire 405 has a regulated oscillation around of the oscillation axis 133. The tire 405 is oscillated through a gear 525 which is engaged with the worm 521. The worm 521 is rotated with the worm shaft 226 by the control motor 541. The tire 405 is in traction contact with the compound belt 645. The compound belt 645 is formed of the annular belts 649. The belt 645 drives the two cylindrical pulleys 703. One of the pulleys 703 is supported on the output shaft 234 which transmits the movement to the spiral bevel gear 481. The gear 481 is engaged with the spiral bevel gear 482. The gear 482 is mounted on the rotatable output shaft 225. The shaft 225 is determined by the output axial axis 140 with a direction of output rotation movement 141. The belt 645 is moved on a belt support 378.

The continuously variable transmission of FIG. 36 is operated through the input shaft 246 which is driven by an engine or a motor, this shaft 246 has an input rotation movement and rotates with the same angular velocity to the input pinion gear 483. The gear 483 transmits the rotation movement to the ring gear 484 which has a lower angular velocity than the gear 483. The gear 484 rotates to the spiral bevel gear 485. The gear 485 rotates at a higher angular velocity than the gear 484. The pneumatic-cylindrical tire 405 has the same angular velocity of the gear 485. When the tire 405 is in traction contact with the compound belt 645, the direction of main variable movement of the tire 405 is transmitted to the belt 645; additionally, the other directions of movement of the tire 405 are transmitted to the annular belts 649, causing a free rotation movement of these belts 649. The oscillating movement of the tire 405 is produced by the operation of the control motor 541. The torque of the motor 541 is amplificated through the gear train formed by the helical gears 434 and 435, the worm 521, and the gear 525. The gear 485 with the gear 484 permit to regulate the oscillating movement of the tire 405 from the control motor 541, and to transmit the input rotation movement to the tire 405 from the input shaft 246.

The transmission has the input shaft 246 mounted on a stationary base, and the shaft 246 conduces the direction of input rotation movement 137; the pneumatic-cylindrical tire 405 is supported on a structure with control of the oscillating angle, and the tire 405 has a rotation movement of continuously variable oscillating angle; the tire 405 drives a main variable movement; the annular belts 649 have the free rotation movement, and the compound belt 645 and the two cylindrical pulleys 703 have a continuously variable output rotation movement.

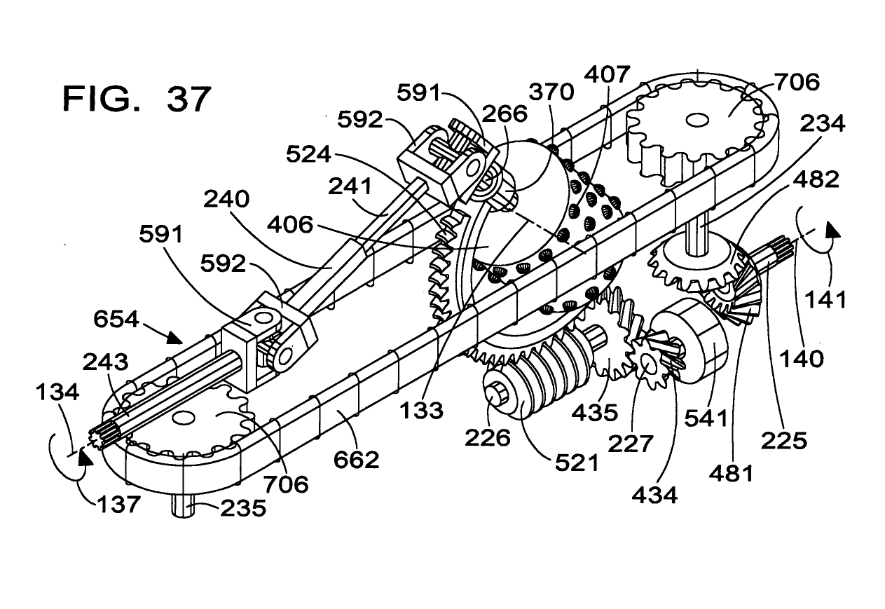

Referring to the FIG. 37, there is shown an embodiment of a continuously variable transmission in accordance with the present invention. The continuously variable transmission has the input shaft 243 which is connected to the universal joints 591 and 592. The joint 592 is connected to the external telescopic shaft 240 with the internal telescopic shaft 241. The shaft 241 is connected to the joints 592 and 591. The joint 591 is connected to a cylinder shaft 266 which drives a cylinder with distributed spheres 406. The cylinder 406 has a regulated oscillation around of the oscillation axis 133. The cylinder 406 is oscillated through the gear 524 which is engaged with the worm 521. The worm 521 is rotated with the worm shaft 226 by the control motor 541. The cylinder 406 has a spheres 407 which are located along of its cylindrical surface. The spheres 407 are uniformly distributed in the cylinder 406. The cylinder 406 has a gearing contact with a compound-toothed belt 654. The belt 654 is formed of a toothed-annular belts 662. The belt 654 drives the two toothed pulleys 706. One of the two pulleys 706 is supported on the output shaft 234 which transmits the movement to the spiral bevel gear 481. The gear 481 is engaged with the spiral bevel gear 482. The gear 482 is mounted on the rotatable output shaft 225. The shaft 225 is determined by the output axial axis 140 with a direction of output rotation movement 141.

The transmission has the input shaft 243 mounted on a stationary base, and the shaft 243 conduces the direction of input rotation movement 137; the cylinder with distributed spheres 406 is supported on a structure with control of the oscillating angle, and the cylinder 406 has a rotation movement of continuously variable oscillating angle; the cylinder 406 drives a main variable movement; the toothed-annular belts 662 have a free rotation movement; the compound-toothed belt 654 and the two toothed pulleys 706 have a continuously variable output rotation movement.

The transmission is depicted in a transmission ratio. The transmission has the gearing contact for transmitting the movements between the cylinder with distributed spheres 406 and the compound-toothed belt 654. The cylinder 406 drives the main variable movement, and a perpendicular movement in relation to the main variable movement.

The main variable movement of the cylinder with distributed spheres 406 is a normal movement to a contact area, this contact area is formed between the external surfaces of the geared teeth of the cylinder 406 and the compound-toothed belt 654. The contact area is an interaction zone between movements, the main variable movement of the cylinder 406 is converted in a main output variable movement of the belt 654. The main output variable movement of the belt 654 is a normal movement to the contact area. The main output variable movement of the belt 654 is a component of the continuously variable output rotation movement of the belt 654.

The perpendicular movement in relation to the main variable movement of the cylinder 406 is converted in the free rotation movement of the toothed-annular belts 662.

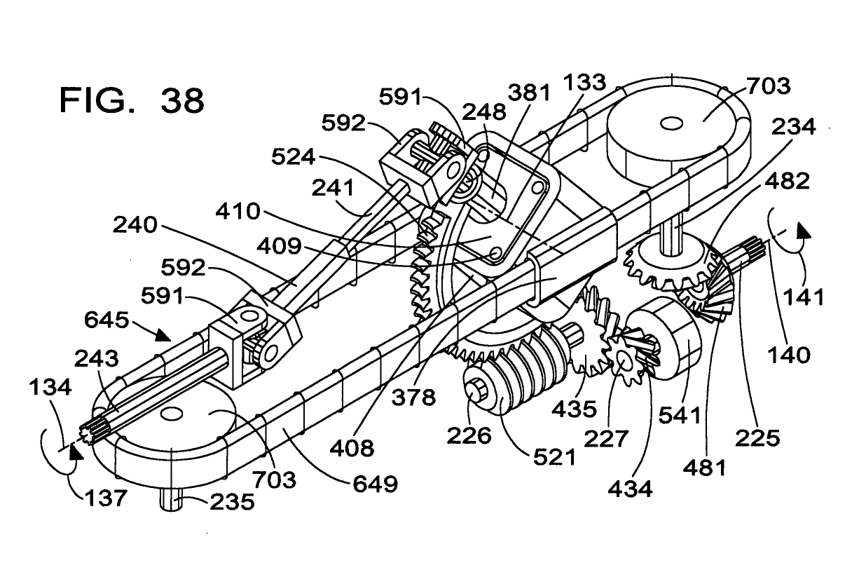

Referring to the FIG. 38, there is shown an embodiment of a continuously variable transmission in accordance with the present invention. The continuously variable transmission has the input shaft 243 which is connected to the universal joints 591 and 592. The joint 592 is connected to the external telescopic shaft 240 with the internal telescopic shaft 241. The shaft 241 is connected to the joints 592 and 591. The joint 591 is connected to a belt shaft 248 which is mounted on a bearing support 381. The shaft 248 drives a belt 408 with a belt cylinders 409 and a belt cylinder cover 410. The belt 408 has a regulated oscillation around of the oscillation axis 133. The belt 408 is oscillated through the gear 524 which is engaged with the worm 521. The worm 521 is rotated with the worm shaft 226 by the control motor 541. The belt 408 has a traction contact with a compound belt 645. The belt 408 has a plain sides for the traction contact with the belt 645. The belt 645 is formed of the annular belts 649. The belt 645 drives the two cylindrical pulleys 703. One of the pulleys 703 is supported on the output shaft 234 which transmits the movement to the spiral bevel gear 481. The gear 481 is engaged with the spiral bevel gear 482. The gear 482 is mounted on the rotatable output shaft 225. The shaft 225 is determined by the output axial axis 140 with a direction of output rotation movement 141. The belt 645 is moved on a belt support 378.

The transmission has the input shaft 243 mounted on a stationary base, and the shaft 243 conduces the direction of input rotation movement 137; the belt 408 is supported on a structure with control of the oscillating angle, and the belt 408 has a rotation movement of continuously variable oscillating angle; the belt 408 drives a main variable movement; the annular belts 649 have a free rotation movement; the compound belt 645 and the two cylindrical pulleys 703 have a continuously variable output rotation movement.

The transmission is depicted in a transmission ratio. The transmission has the traction contact for transmitting the movements between the belt 408 and the compound belt 645. The belt 408 drives the main variable movement, and a perpendicular movement in relation to the main variable movement.

The main variable movement of the belt 408 is a tangential movement to a contact area, this contact area is formed between the external surfaces of the belt 408 and the compound belt 645. The contact area is an interaction zone between movements, the main variable movement of the belt 408 is converted in a main output variable movement of the belt 645. The main output variable movement of the belt 645 is a tangential movement to the contact area. The main output variable movement of the belt 645 is a component of the continuously variable output rotation movement of the belt 645.

The perpendicular movement in relation to the main variable movement of the belt 408 is converted in the free rotation movement of the annular belts 649. This conversion is made in the contact area by the traction contact.

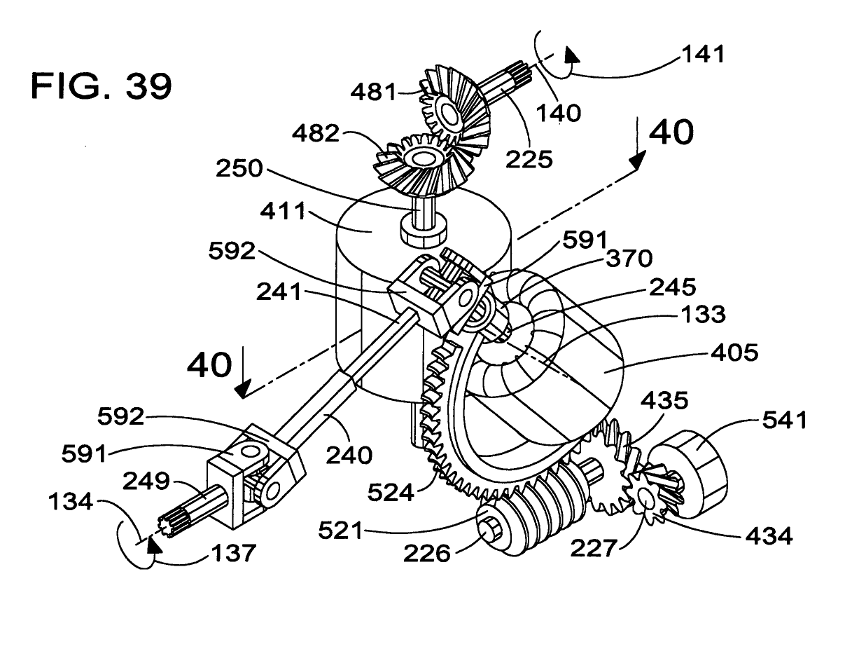

Referring to the FIG. 39, there is shown an embodiment of a continuously variable transmission in accordance with the present invention. The continuously variable transmission has the input shaft 249 which is connected to the universal joints 591 and 592. The joint 592 is connected to the external telescopic shaft 240 with the internal telescopic shaft 241. The shaft 241 is connected to the joints 592 and 591. The joint 591 is connected to a tire shaft 245 which drives a pneumatic-cylindrical tire 405. The tire 405 has a regulated oscillation around of the oscillation axis 133. The tire 405 is oscillated through the gear 524 which is engaged with the worm 521. The worm 521 is rotated with the worm shaft 226 by the control motor 541. The tire 405 has a traction contact with a compound cylinder 411. The cylinder 411 drives a cylinder shaft 250 which transmits the movement to the spiral bevel gear 482. The gear 482 is engaged with the spiral bevel gear 481. The gear 481 is mounted on the rotatable output shaft 225. The shaft 225 is determined by the output axial axis 140 with a direction of output rotation movement 141.

The transmission has the input shaft 249 mounted on a stationary base, and the shaft 249 conduces the direction of input rotation movement 137; the pneumatic-cylindrical tire 405 is supported on a structure with control of the oscillating angle, and the tire 405 has a rotation movement of continuously variable oscillating angle; the tire 405 drives a main variable movement; the compound cylinder 411 has a plurality of elements with free rotation movement; the cylinder 411 has a continuously variable output rotation movement.

The transmission is depicted in a transmission ratio. The transmission has the traction contact for transmitting the movements between the pneumatic-cylindrical tire 405 and the compound cylinder 411. The tire 405 drives the main variable movement, and a perpendicular movement in relation to the main variable movement.

The main variable movement of the pneumatic-cylindrical tire 405 is a tangential movement to a contact area, this contact area is formed between the external surfaces of the tire 405 and the compound cylinder 411. The contact area is an interaction zone between movements, the main variable movement of the tire 405 is converted in a main output variable movement of the cylinder 411. The main output variable movement of the cylinder 411 is a tangential movement to the contact area. The main output variable movement of the cylinder 411 is a component of the continuously variable output rotation movement of the cylinder 411.

The perpendicular movement in relation to the main variable movement of the tire 405 is converted in the free rotation movement of a components of the compound cylinder 411. This conversion is made in the contact area by the traction contact.

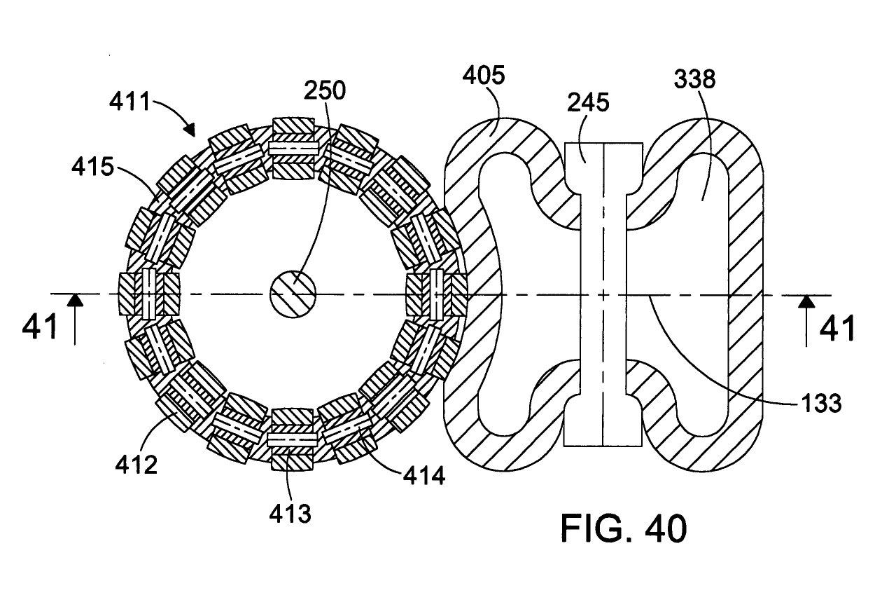

FIG. 40 shows a longitudinal section of the transmission of FIG. 39. The pneumatic-cylindrical tire 405 has a regulated oscillation around of the oscillation axis 133. The tire 405 has the traction contact with a belts 412 which are a component of the compound cylinder 411. The belts 412 have an internal surface like a barrel shape. The belts 412 are supported on a belt bearings 413. The bearings 413 are mounted on a belt bearing shafts 414. A bearing supports 415 are located between the belts 412. The supports 415 have a slipping lateral areas; these slipping lateral areas permit the slipping movement of the belts 412.

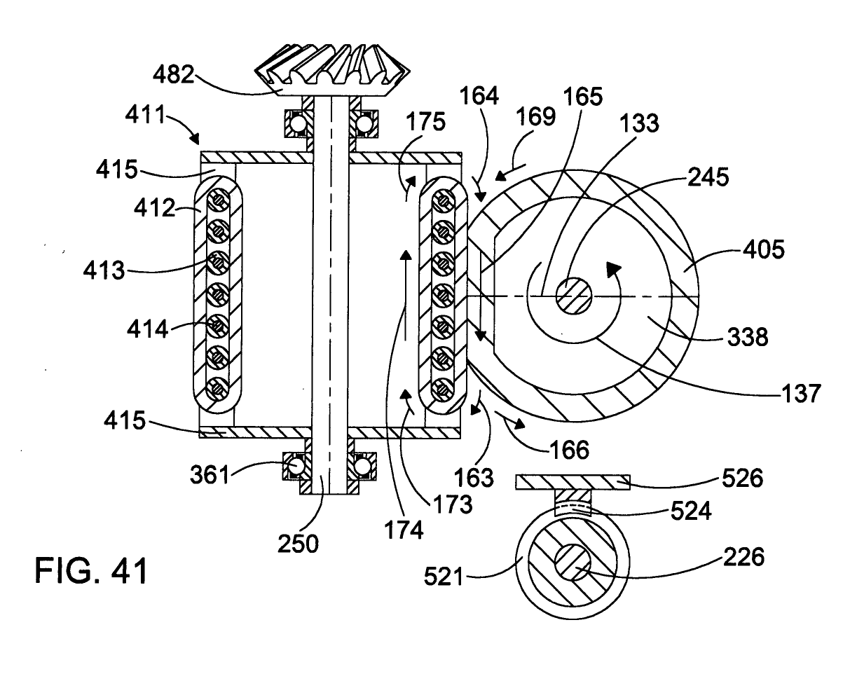

FIG. 41 shows a transverse section of the transmission of FIG. 40. The input rotation movement 137 is transmitted to the tire shaft 245. The pneumatic-cylindrical tire 405 has a regulated oscillation around of the oscillation axis 133. The tire 405 has the traction contact with the belts 412 which are a component of the compound cylinder 411. The belts 412 are supported on the belt bearings 413 which are uniformly distributed. The bearings 413 are mounted on the belt bearing shafts 414. The tire 405 is oscillated through the gear 524 which is engaged with the worm 521. The gear 524 has a gear base 526. The cylinder 411 drives the cylinder shaft 250 which transmits the movement to the spiral bevel gear 482. A directions of free movement 163-165 and 173-175 are formed on the belt 412. The directions of input rotation movement 166 and 169 are formed on the tire 405.

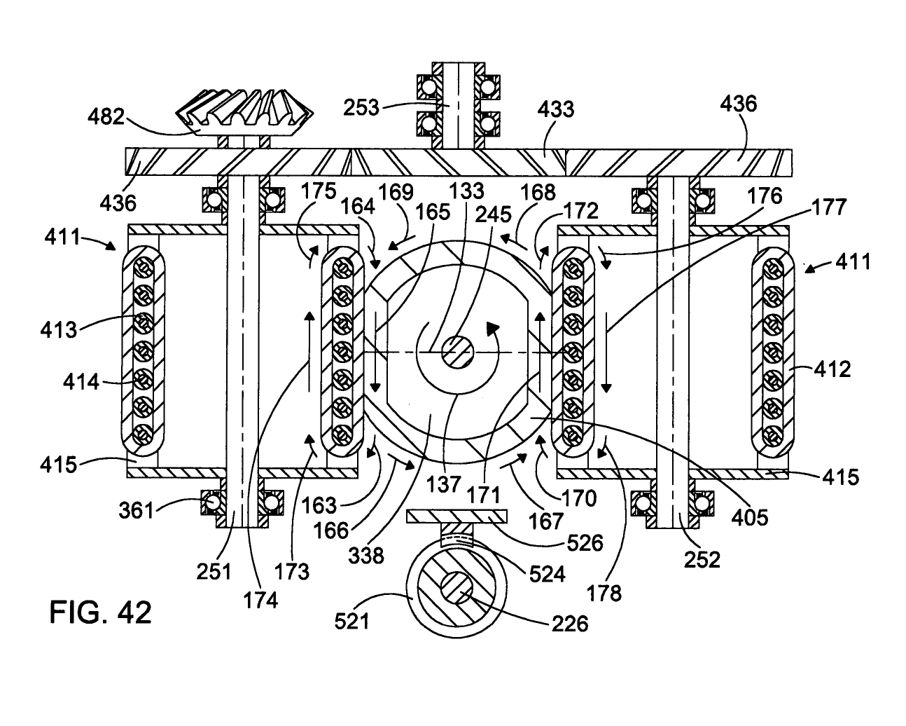

Referring to the FIG. 42, this embodiment is showing a continuously variable transmission in accordance with the present invention, which illustrates a transverse section of the transmission of FIG. 39 with more functional details. The continuously variable transmission has the two compound cylinders 411 which are located around of the pneumatic-cylindrical tire 405. The input rotation movement 137 is transmitted to the tire shaft 245. The tire 405 has a regulated oscillation around of the oscillation axis 133. The tire 405 has the traction contact with the belts 412 of the two cylinders 411. The belts 412 are supported on the belt bearings 413 which are uniformly distributed. The bearings 413 are mounted on the belt bearing shafts 414. The tire 405 is oscillated through the gear 524 which is engaged with the worm 521. The cylinders 411 drive a cylinder shafts 251 and 252. The shaft 251 in the left side of the tire 405 has a parallel direction to the shaft 252 in the right side. The shafts 251 and 252 are connected to the two helical gears 436 which are engaged with the helical gear 433. The gear 433 is supported on a intermediate shaft 253. The output rotation movement is transmitted to the spiral bevel gear 482. The directions of free movement 163-165, 173-175, 170-172 and 176-178 are formed on the belts 412. The directions of input rotation movement 166-169 are formed on the tire 405.

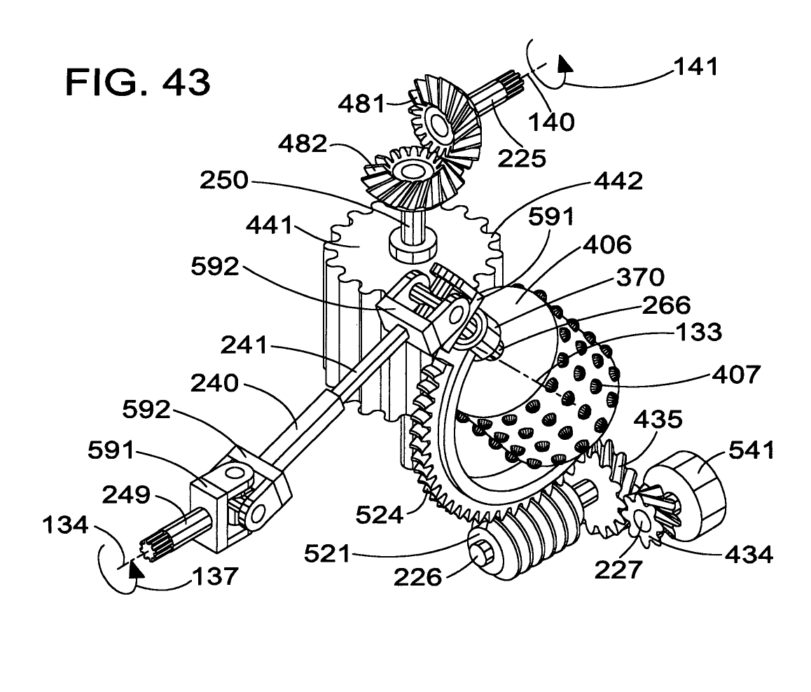

Referring to the FIG. 43, there is shown an embodiment of a continuously variable transmission in accordance with the present invention. The continuously variable transmission has the input shaft 249 which is connected to the universal joints 591 and 592. The joint 592 is connected to the external telescopic shaft 240 with the internal telescopic shaft 241. The shaft 241 is connected to the joints 592 and 591. The joint 591 is connected to the cylinder shaft 266 which drives the cylinder with distributed spheres 406. The cylinder 406 has a regulated oscillation around of the oscillation axis 133. The cylinder 406 is oscillated through the gear 524 which is engaged with the worm 521. The worm 521 is rotated with the worm shaft 226 by the control motor 541. The cylinder 406 has the spheres 407 which are located along of its cylindrical surface. The spheres 407 are uniformly distributed in the cylinder 406. The cylinder 406 has a gearing contact with a compound gear 441 which has a collapsible teeth 442. The spheres 407 are interposed between the collapsible teeth 442. The gear 441 drives the cylinder shaft 250 which transmits the movement to the spiral bevel gear 482. The gear 482 is engaged with the spiral bevel gear 481. The gear 481 is mounted on the rotatable output shaft 225. The shaft 225 is determined by the output axial axis 140 with a direction of output rotation movement 141.

When a collision between collapsible teeth 442 and the spheres 407 is presented in the transmission, the collapsible teeth 442 are internally displaced to permit the rotation movement of the spheres 407.

The transmission has the input shaft 249 mounted on a stationary base, and the shaft 249 conduces the direction of input rotation movement 137; the cylinder with distributed spheres 406 is supported on a structure with control of the oscillating angle, and the cylinder 406 has a rotation movement of continuously variable oscillating angle; the cylinder 406 drives a main variable movement; the compound gear 441 has a plurality of elements with a free rotation movement; the gear 441 has a continuously variable output rotation movement.

The transmission is depicted in a transmission ratio. The transmission has the gearing contact for transmitting the movements between the cylinder with distributed spheres 406 and the compound gear 441. The cylinder 406 drives the main variable movement, and a perpendicular movement in relation to the main variable movement.

The main variable movement of the cylinder with distributed spheres 406 is a normal movement to a contact area, this contact area is formed between the external surfaces of the geared teeth of the cylinder 406 and the compound gear 441. The contact area is an interaction zone between movements, the main variable movement of the cylinder 406 is converted in a main output variable movement of the gear 441. The main output variable movement of the gear 441 is a normal movement to the contact area. The main output variable movement of the gear 441 is a component of the continuously variable output rotation movement of the gear 441.

The perpendicular movement in relation to the main variable movement of the cylinder 406 is converted in the free rotation movement of a components of the gear 441.

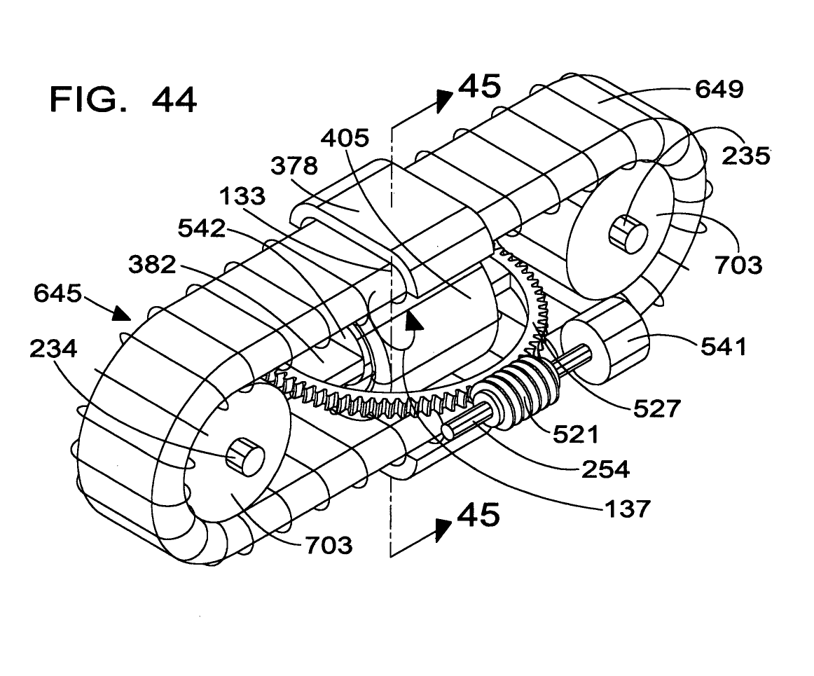

Referring to the FIG. 44, there is shown an embodiment of a continuously variable transmission in accordance with the present invention. The continuously variable transmission has an electric motor 542 which drives the pneumatic-cylindrical tire 405. The electric motor 542 is mounted on an electric motor support 382. The tire 405 has a regulated oscillation around of the oscillation axis 133. The tire 405 is oscillated through a gear 527 which is engaged with the worm 521. The worm 521 is rotated with a worm shaft 254 by the control motor 541. The tire 405 has a traction contact with a compound belt 645. The compound belt 645 is formed of the annular belts 649. The belt 645 drives the two cylindrical pulleys 703 which are mounted on the shaft 234 and 235. The belt 645 is moved on the belt support 378.

The continuously variable transmission of FIG. 44 is operated through of the electric motor 542, this motor 542 has the input rotation movement 137 and rotates with the same angular velocity to the pneumatic-cylindrical tire 405. When the tire 405 is in traction contact with the compound belt 645, the direction of main variable movement of the tire 405 is transmitted to the belt 645; additionally, the other directions of movement of the tire 405 are transmitted to the annular belts 649, causing a free rotation movement of these belts 649. The oscillating movement of the tire 405 is produced by the operation of the control motor 541. The torque of the motor 541 is amplificated through the worm 521 and the gear 527. The gear 527 regulates the oscillating movement of the electric motor support 382 with the electric motor 542 and the tire 405.

The transmission has the electric motor 542 which drives the direction of input rotation movement 137; the pneumatic-cylindrical tire 405 is mounted on the electric motor 542, and the tire 405 is driven by the motor 542; the tire 405 and the motor 542 are supported on a structure with control of the oscillating angle, and the tire 405 has a rotation movement of continuously variable oscillating angle; the tire 405 drives a main variable movement; the annular belts 649 have the free rotation movement; the compound belt 645 and the two cylindrical pulleys 703 have a continuously variable output rotation movement.

The transmission is depicted in a transmission ratio corresponding to stationary. The transmission has the traction contact for transmitting the movements between the pneumatic-cylindrical tire 405 and the compound belt 645.

When the transmission has the transmission ratio corresponding to stationary, the tire 405 has the main variable movement equivalent to zero, and a perpendicular movement in relation to the main variable movement. The perpendicular movement in relation to the main variable movement of the tire 405 is converted in the free rotation movement of the annular belts 649. This conversion is made in the contact area by the traction contact. Consequently, the compound belt 645 has a stationary condition.

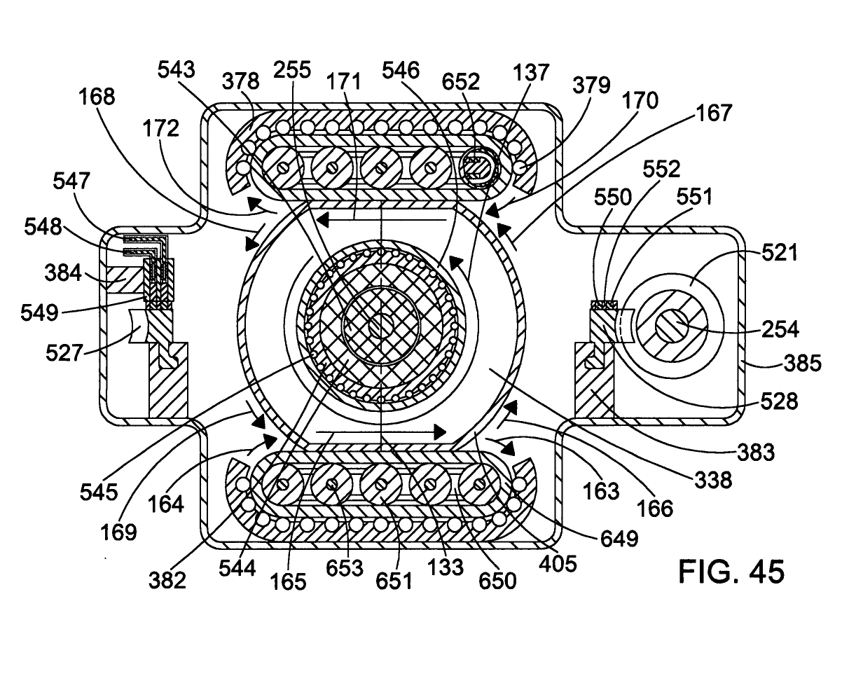

FIG. 45 shows a transverse section of the continuously variable transmission of FIG. 44. The transmission has an input of electrical energy with an electrical connectors 547 and 548. The connectors 547 and 548 are mounted in a connector base 549 with an electrical connector support 384. The electrical energy is transmitted to an electrical cables 550 and 551 which are located with an electrical isolator 552 on a gear base 528. The base 528 is mounted on a gear support 383. The electric motor 542 has a stator 544 and a rotor 543 which is mounted in a rotor shaft 255; the stator 544 is mounted on the electric motor support 382. The support 382 has a bearing 545 which is mounted with an internal rotor 546. The rotor 546 drives the pneumatic-cylindrical tire 405. The tire 405 has a regulated oscillation around of the oscillation axis 133. The tire 405 is oscillated through a gear 527 which is engaged with the worm 521. The tire 405 has the traction contact with the annular belts 649. The belts 649 are moved on the belt supports 378. The compound belt 645 has the belts 649 with the holed balls 651 and the internal belt supports 650. A directions of free movement 163-165 and 170-172 are formed on the belts 649. A directions of input rotation movement 166-169 are formed on the tire 405. The supports 378 are mounted on a housing 385.

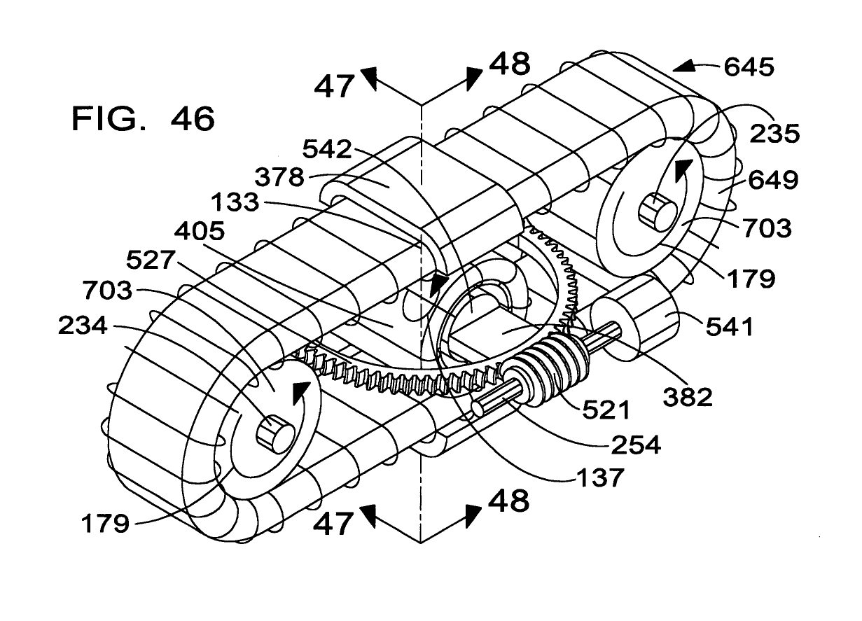

Referring to the FIG. 46, shows a perspective of the continuously variable transmission of FIG. 44. The continuously variable transmission has the electric motor 542 with the pneumatic-cylindrical tire 405 in a maximum transmission ratio. The tire 405 has the traction contact with the compound belt 645. The belt 645 drives the two cylindrical pulleys 703 which are mounted on the shafts 234 and 235. The belt 645 is moved on the belt supports 378. The two pulleys 703 have a directions of output rotation movement 179. The directions of output rotation movement 179 have the same direction of the input rotation movement 137. The tire 405 has a regulated oscillation around of the oscillation axis 133. The tire 405 is oscillated through the gear 527 which is engaged with the worm 521. The worm 521 is rotated with the worm shaft 254 by the control motor 541.

The transmission is depicted in the maximum transmission ratio. The transmission has the traction contact for transmitting the movements between the pneumatic-cylindrical tire 405 and the compound belt 645.

When the transmission has the maximum transmission ratio, the tire 405 has the main variable movement, and the perpendicular movement in relation to the main variable movement equivalent to zero.

The main variable movement of the pneumatic-cylindrical tire 405 is a tangential movement to the contact area, this contact area is formed between the external surfaces of the tire 405 and the compound belt 645. The contact area is an interaction zone between movements, the main variable movement of the tire 405 is converted in a main output variable movement of the belt 645. The main output variable movement of the belt 645 is a tangential movement to the contact area. The main output variable movement of the belt 645 is a component of the continuously variable output rotation movement of the belt 645.

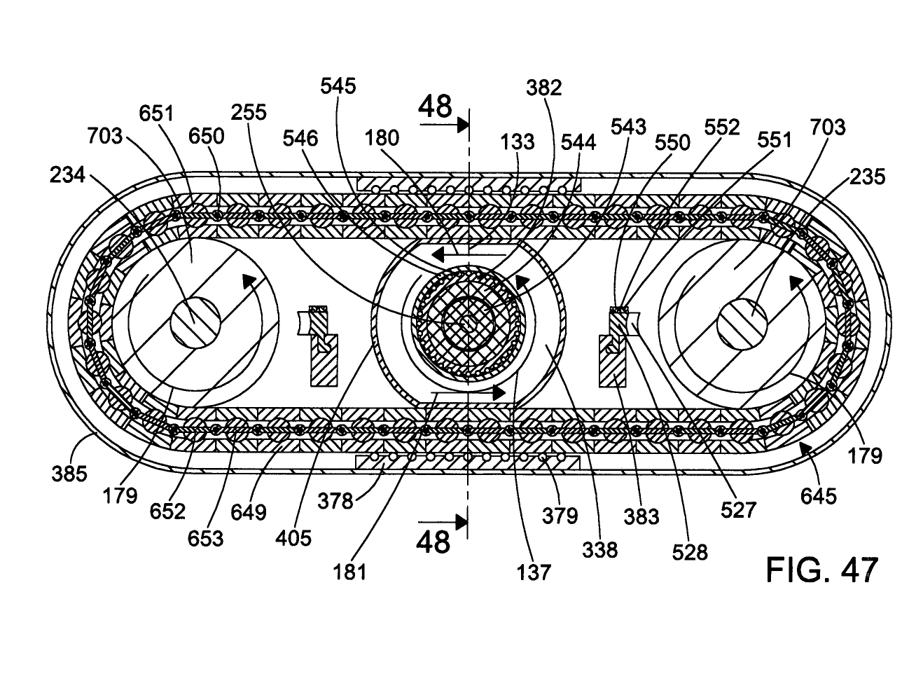

Referring to the FIG. 47, shows a longitudinal section of the continuously variable transmission of FIG. 46. The continuously variable transmission has the electric motor 542 with the pneumatic-cylindrical tire 405 in the maximum transmission ratio. The tire 405 is in traction contact with the annular belts 649. The belts 649 have a directions of main variable movement 180 and 181. The tire 405 has a regulated oscillation around of the oscillation axis 133. The tire 405 is oscillated through the gear 527.

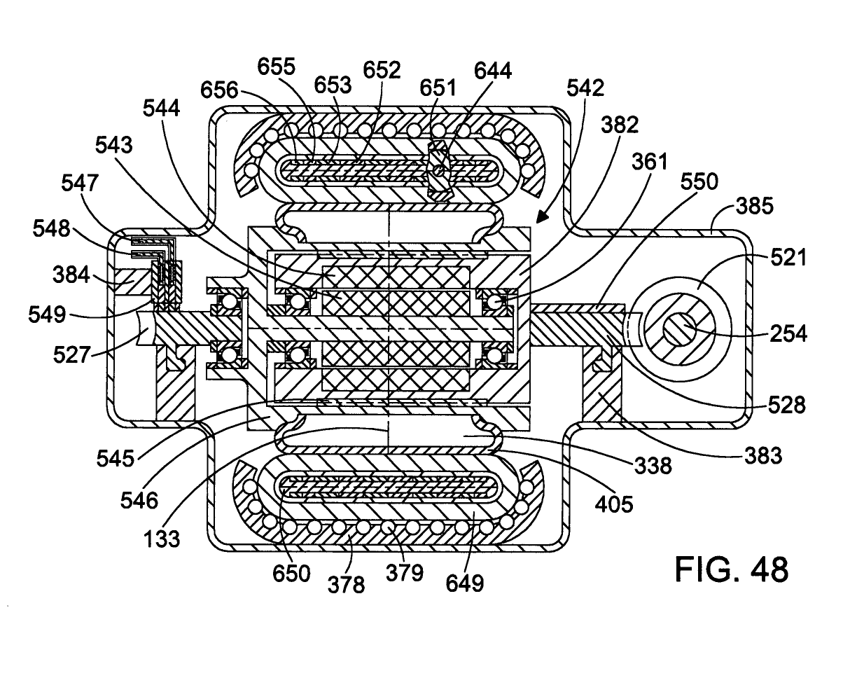

Referring to the FIG. 48, shows a transverse section of the continuously variable transmission of FIG. 47. The transmission has the pneumatic-cylindrical tire 405 in the maximum transmission ratio. The tire 405 is in traction contact with the annular belts 649. The belts 649 have a belt ball shafts 655 and 656.

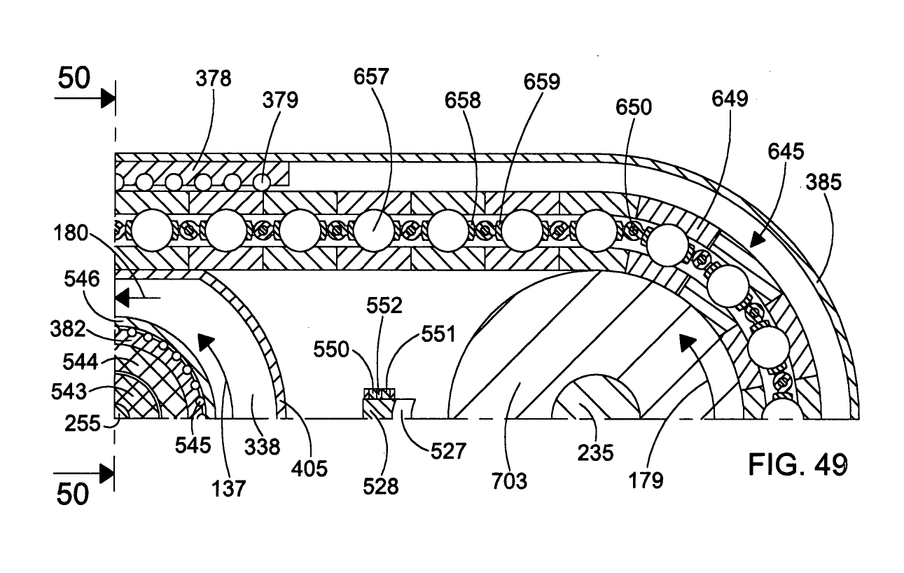

Referring to the FIG. 49, this embodiment is showing a continuously variable transmission in accordance with the present invention, which illustrates a longitudinal section of the transmission of FIG. 46 with more functional details. The compound belt 645 is formed of an annular belts 649 with a balls 657 and a ball supports 658 and 659. The belts 649 have a slipping lateral areas; these slipping lateral areas permit the free rotation movement between the belts 649.

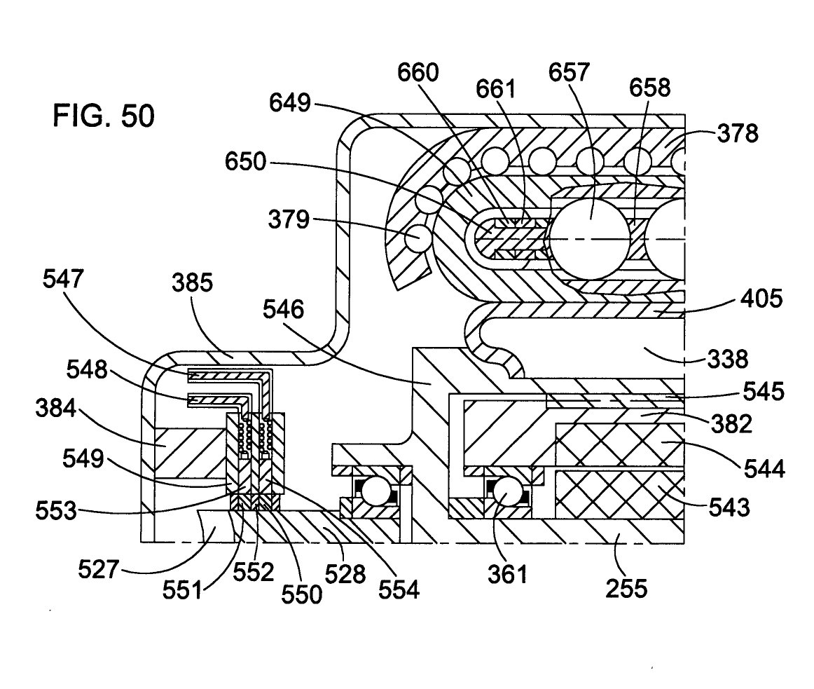

Referring to the FIG. 50, shows a transverse section of the continuously variable transmission of FIG. 49. The transmission has an input of electrical energy with the electrical connectors 547 and 548. The connectors 547 and 548 are mounted in the connector base 549 with the electrical connector support 384. The electrical energy is transmitted through an electrical connectors 553 and 554 to the electrical cables 550 and 551 which are located with the electrical isolator 552 on the gear base 528. A ball supports 660 and 661 are mounted on the internal belt supports 650.

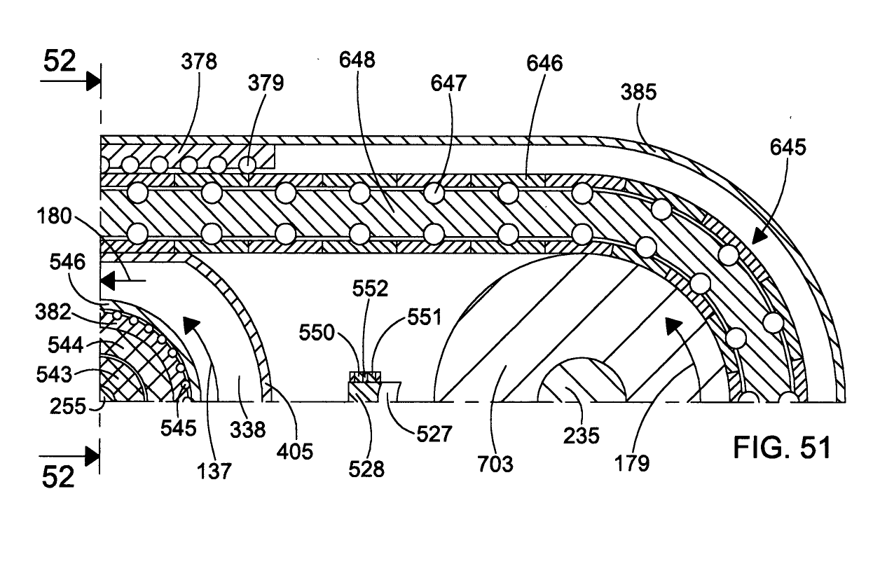

Referring to the FIG. 51, this embodiment is showing a continuously variable transmission in accordance with the present invention, which illustrates a longitudinal section of the transmission of FIG. 46 with more functional details. The compound belt 645 is formed of an annular belts 646 with a balls 647 and an internal belt 648. The belts 646 have a slipping lateral areas; these slipping lateral areas permit the free rotation movement between the belts 646.

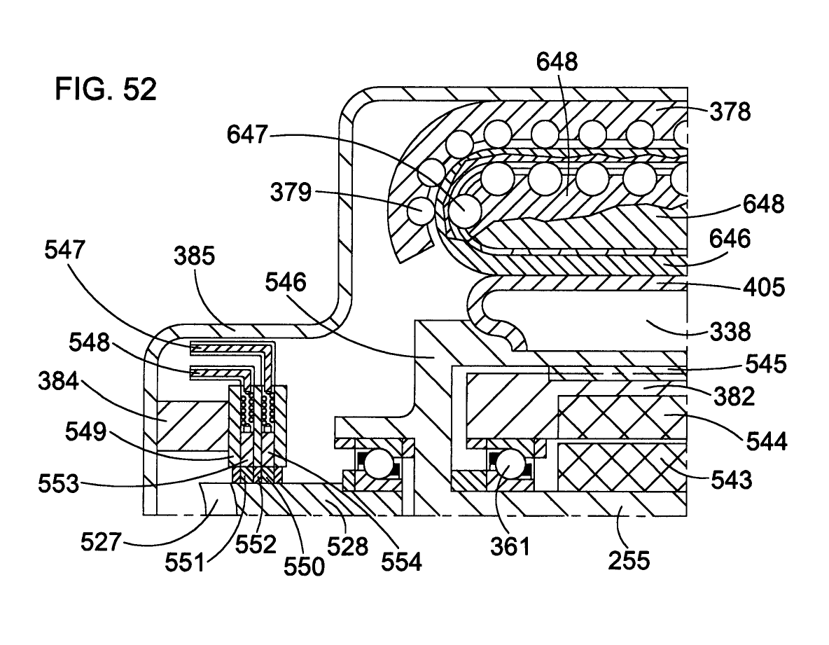

Referring to the FIG. 52, shows a transverse section of the continuously variable transmission of FIG. 51. The transmission has an input of electrical energy with the electrical connectors 547 and 548. The connectors 547 and 548 are mounted in the connector base 549 with the electrical connector support 384. The electrical energy is transmitted through an electrical connectors 553 and 554 to the electrical cables 550 and 551 which are located with the electrical isolator 552 on the gear base 528.

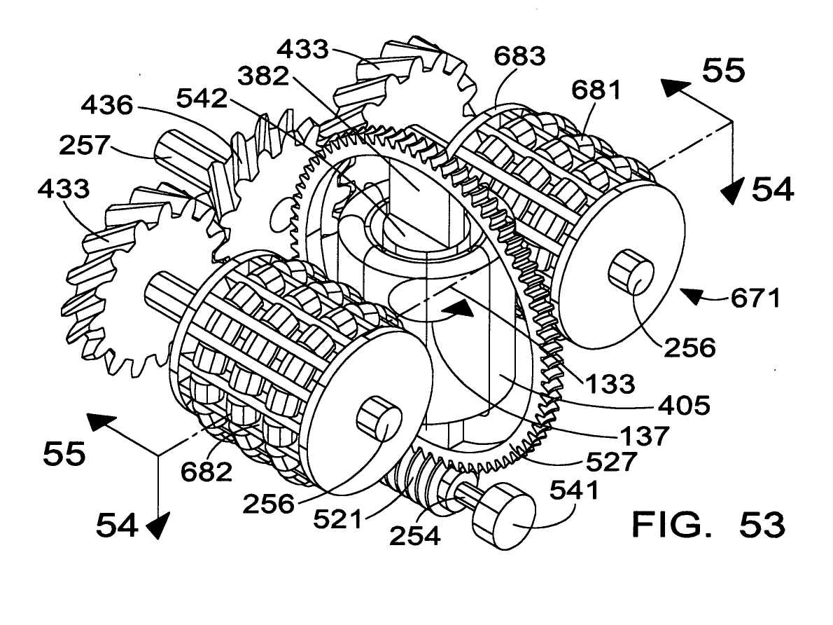

Referring to the FIG. 53, there is shown an embodiment of a continuously variable transmission in accordance with the present invention. The continuously variable transmission has the electric motor 542 which drives the pneumatic-cylindrical tire 405 with the input rotation movement 137. The motor 542 is mounted on the electric motor support 382. The tire 405 has a regulated oscillation around of the oscillation axis 133. The tire 405 is oscillated through the gear 527 which is engaged with the worm 521. The worm 521 is rotated with the worm shaft 254 by the control motor 541. The tire 405 has a traction contact with a two compound cylinders 671. The cylinders 671 are mounted on a shafts 256. The cylinders 671 have a bearings with barrel shape 681. The barrels 681 are located on the cylindrical configuration of the cylinders 671. The barrels 681 are mounted on a bearing support 682 which are located between a cover supports 683. The two shafts 256 are parallel shafts with an output shaft 257. The shafts 256 are connected to the two helical gears 433 which are engaged with the helical gear 436. The gear 433 is supported on the intermediate shaft 257.

The transmission has the electric motor 542 which drives the direction of input rotation movement 137; the pneumatic-cylindrical tire 405 is mounted on the motor 542, and the tire 405 is driven by the motor 542; the tire 405 and the motor 542 are supported on a structure with control of the oscillating angle, and the tire 405 has a rotation movement of continuously variable oscillating angle; the tire 405 drives a main variable movement; the barrels 681 have a free rotation movement; the two compound cylinders 671 have a continuously variable output rotation movement.

The transmission is depicted in a transmission ratio corresponding to stationary. The transmission has the traction contact for transmitting the movements between the pneumatic-cylindrical tire 405 and the compound cylinders 671.

When the transmission has the transmission ratio corresponding to stationary, the tire 405 has the main variable movement equivalent to zero, and a perpendicular movement in relation to the main variable movement. The perpendicular movement in relation to the main variable movement of the tire 405 is converted in the free rotation movement of the barrels 681. This conversion is made in the contact area by the traction contact. Consequently, the two compound cylinders 671 have a stationary condition.

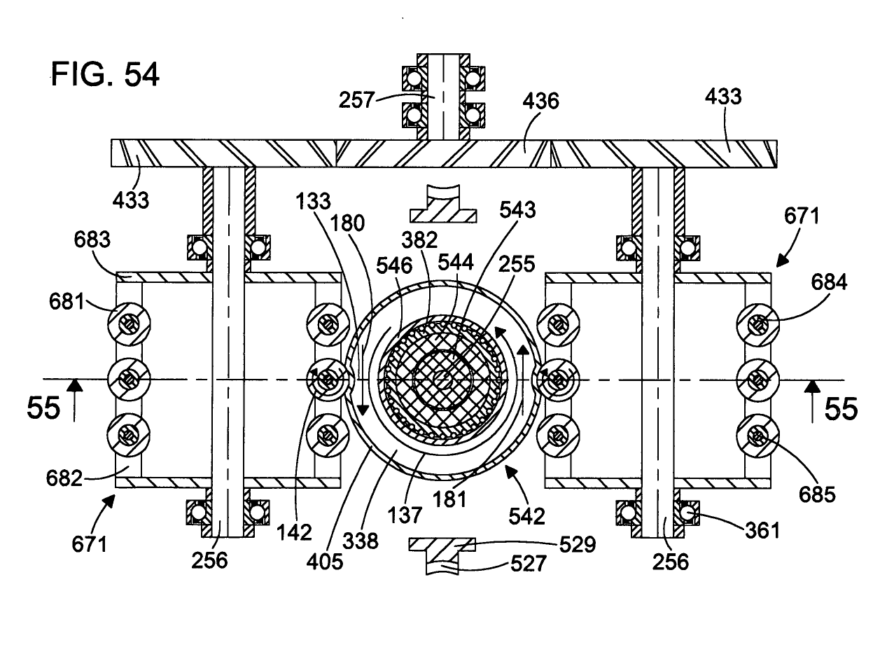

FIG. 54 shows a longitudinal section of the continuously variable transmission of FIG. 53. The transmission has an input of electrical energy to the electric motor 542 which has the stator 544 and the rotor 543 which is mounted in the rotor shaft 255; the stator 544 is supported on the electric motor support 382. The external rotor 546 drives the pneumatic-cylindrical tire 405. The tire 405 has a regulated oscillation around of the oscillation axis 133. The tire 405 is oscillated through a gear 527 which has a gear base 529. The tire 405 is in traction contact with the bearings with barrel shape 681. The barrels 681 are moved on a bearings 684 which are mounted on a shafts 685. The barrels 681 are uniformly distributed along the bearing supports 682. The directions of free movement 142 are formed on the barrels 681.

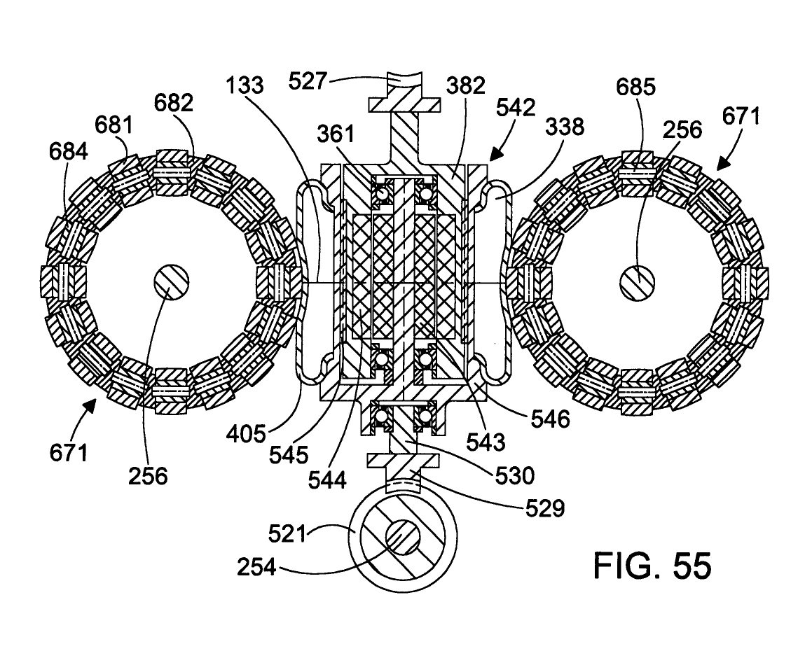

FIG. 55 shows a longitudinal section of the continuously variable transmission of FIG. 54. The transmission has the electric motor 542 which drives the external rotor 546 with the pneumatic-cylindrical tire 405. The motor 542 has a regulated oscillation around of the oscillation axis 133. The motor 542 with the tire 405 are oscillated through a gear 527 which is supported on the gear base 529. The motor 542 is mounted on a gear support 530 and the electric motor support 382. The supports 530 and 382 are connected to the gear base 529. The gear 527 is engaged with the worm 521. The tire 405 is in traction contact with the two compound cylinders 671 through the bearings with barrel shape 681. The barrels 681 are moved on a bearings 684 which are mounted on a shafts 685. The barrels 681 are uniformly distributed along the cylinders 671.

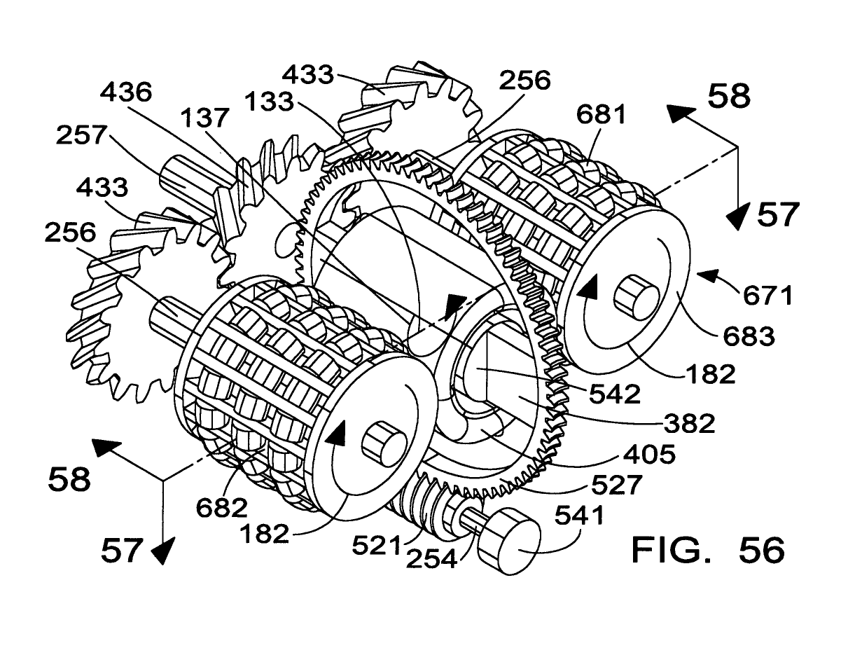

Referring to the FIG. 56, shows a perspective of the continuously variable transmission of FIG. 53. The continuously variable transmission has the electric motor 542 in a maximum transmission ratio. The two shafts 256 are parallel shafts with the output shaft 257. The two shafts 256 have a directions of output rotation movement 182.

The transmission is depicted in the maximum transmission ratio. The transmission has a traction contact for transmitting the movements between the pneumatic-cylindrical tire 405 and the two compound cylinders 671.

When the transmission has the maximum transmission ratio, the tire 405 has a main variable movement, and a perpendicular movement in relation to the main variable movement equivalent to zero.

The main variable movement of the pneumatic-cylindrical tire 405 is a tangential movement to a contact area, this contact area is formed between the external surfaces of the tire 405 and the barrels 681. The contact area is an interaction zone between movements, the main variable movement of the tire 405 is converted in a main output variable movement of the barrels 681. The main output variable movement of the barrels 681 is a tangential movement to the contact area. The main output variable movement of the barrels 681 is a component of the continuously variable output rotation movement of the two compound cylinders 671.

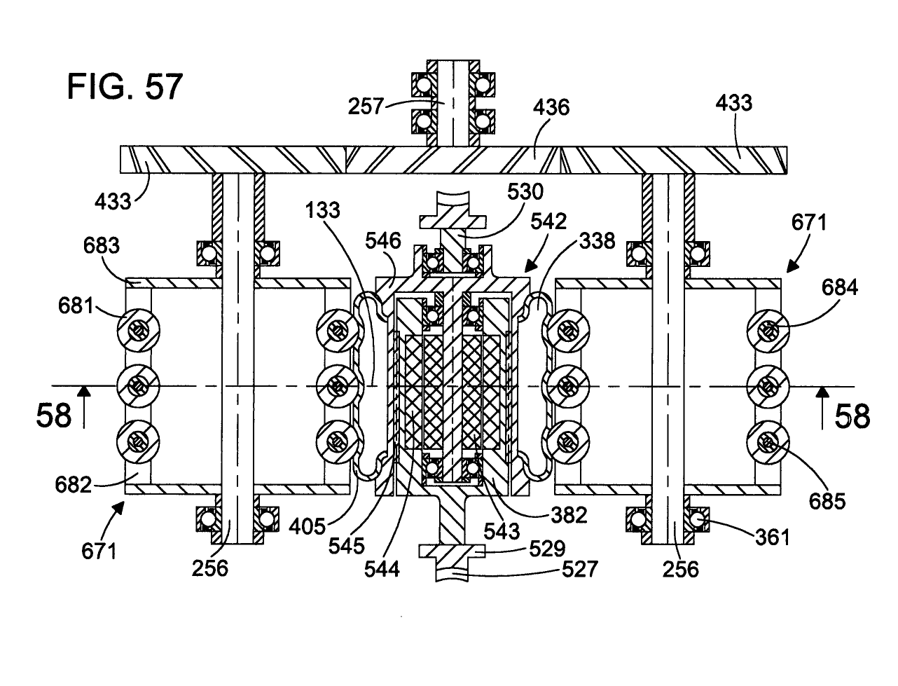

FIG. 57 shows a longitudinal section of the continuously variable transmission of FIG. 56. The transmission has the electric motor 542 which drives the external rotor 546 with the pneumatic-cylindrical tire 405. The motor 542 has a regulated oscillation around of the oscillation axis 133. The tire 405 is in traction contact with the two compound cylinders 671 through the bearings with barrel shape 681. The two cylinders 671 transmit the rotation movement to the two helical gears 433 which are engaged with the helical gear 436.

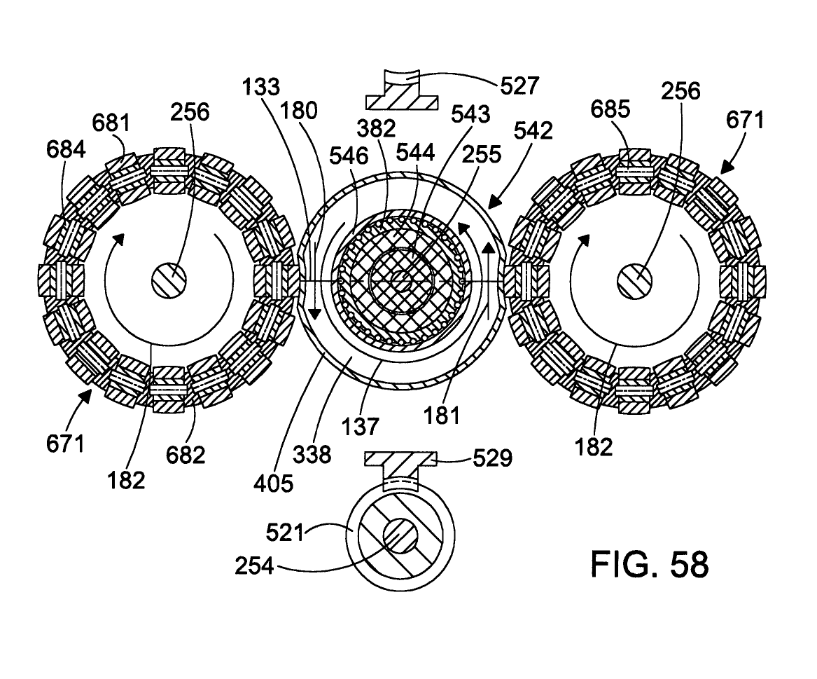

FIG. 58 shows a longitudinal section of the continuously variable transmission of FIG. 56. The transmission has the electric motor 542 which transmit the directions of main variable movement 180 and 181 of the pneumatic-cylindrical tire 405 to the directions of output rotation movement 182 of the two compound cylinders 671.

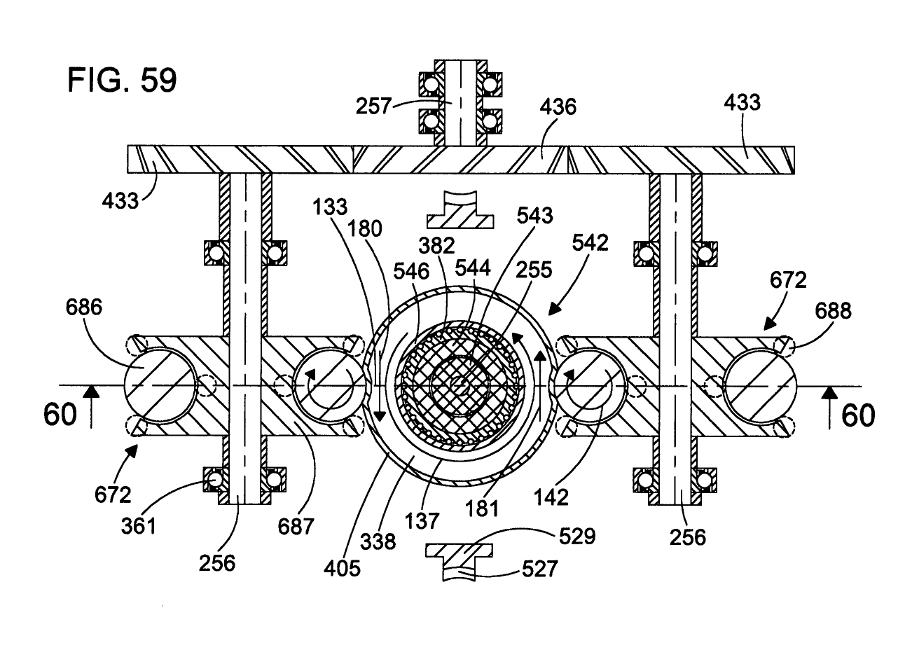

Referring to the FIG. 59, there is shown an embodiment of a continuously variable transmission in accordance with the present invention. The continuously variable transmission has an input of electrical energy to the electric motor 542 which has the stator 544 and the rotor 543 which is mounted in the rotor shaft 255; the stator 544 is supported on the electric motor support 382. The external rotor 546 drives the pneumatic-cylindrical tire 405. The motor 542 has a regulated oscillation around of the oscillation axis 133. The motor 542 is oscillated through the gear 527 which has the gear base 529. The tire 405 has a traction contact with a two compound cylinders 672 through a bearings with lemon shape 686. The lemons 686 are moved on a supports 688 which are mounted on a bearing supports 687. The supports 687 are connected to the shafts 256. The lemons 686 are uniformly distributed along the supports 687. The directions of free movement 142 are formed on the lemons 686. The supports 688 are uniformly distributed along of the circumference of the lemons 686. The transmission has the tire 405 which transmit the directions of main variable movement 180 and 181 to the directions of free movement 142 of the lemons 686.

The position of the electric motor 542 is varied through the gear 527. The input rotation movement 137 of the pneumatic-cylindrical tire 405 is transmitted to the lemons 686 by a contact area between them, and the lemons 686 rotate with the free rotation movement 142.

The transmission has the electric motor 542 which drives the direction of input rotation movement 137; the pneumatic-cylindrical tire 405 is mounted on the motor 542, and the tire 405 is driven by the motor 542; the tire 405 and the motor 542 are supported on a structure with control of the oscillating angle, and the tire 405 has a rotation movement of continuously variable oscillating angle; the tire 405 drives the main variable movement; the lemons 686 have the free rotation movement; the compound cylinders 672 have a continuously variable output rotation movement.

The transmission is depicted in a transmission ratio corresponding to stationary. The transmission has the traction contact for transmitting the movements between the pneumatic-cylindrical tire 405 and the compound cylinders 672.

When the transmission has the transmission ratio corresponding to stationary, the tire 405 has the main variable movement equivalent to zero, and a perpendicular movement in relation to the main variable movement. The perpendicular movement in relation to the main variable movement of the tire 405 is converted in the free rotation movement of the lemons 686. This conversion is made in the contact area by the traction contact. Consequently, the two compound cylinders 672 have a stationary condition.

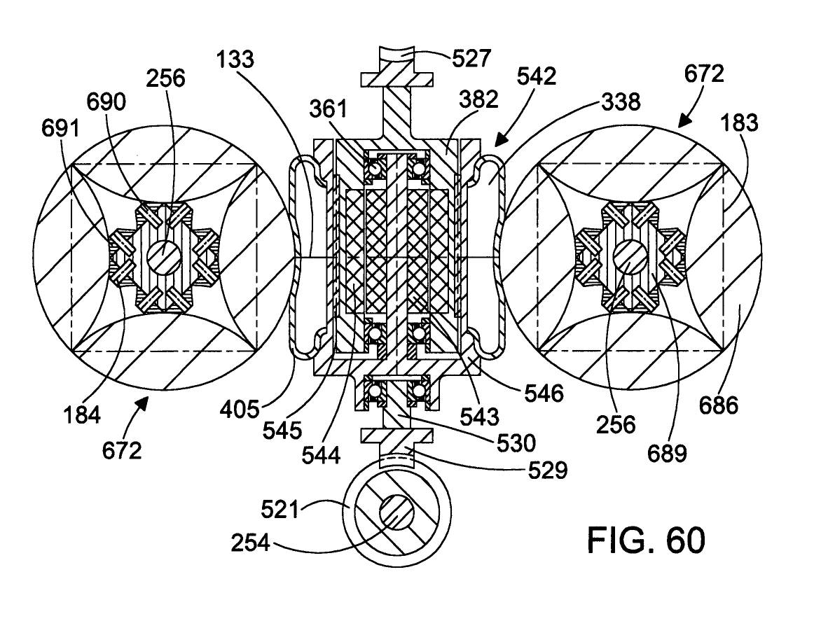

FIG. 60 shows a longitudinal section of the continuously variable transmission of FIG. 59. The transmission has the electric motor 542 in the central part between the two compound cylinders 672. Each one of the two cylinders 672 has four bearings with lemon shape 686 in a circular configuration around the shaft 256. The lemons 686 are rotated in relation to a symmetry axis of the lemon 183. The lemons 686 are mounted on a bearings 691 which have a bearing shafts 690. The shafts 690 have a symmetry axis of the shaft 184. The shafts 690 are uniformly distributed in a shaft support 689 which is connected to the shafts 256.

The rotation movement of the pneumatic-cylindrical tire 405 is transmitted to the lemons 686 by the contact area and the traction between them, thus the lemons 686 rotates around its symmetry axis 183. In this situation, the lemons 686 have the free rotation movement with the bearings 691.

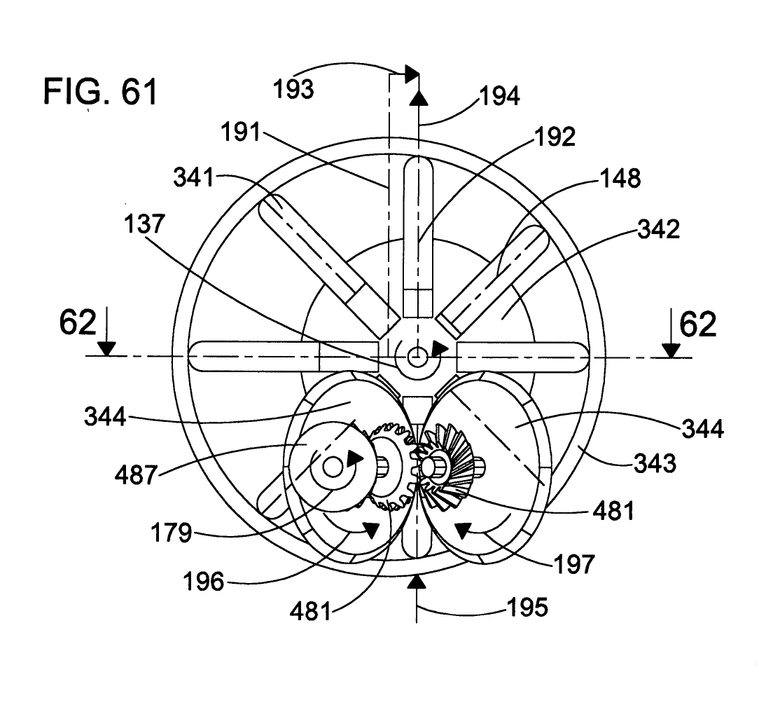

Referring to the FIG. 61, there is shown an embodiment of a continuously variable transmission in accordance with the present invention. The continuously variable transmission has the input rotation movement 137 which is connected at one side to a source of rotational energy (not shown) and by the other side to a roller disc 342. The disc 342 has an eight rollers 341 which are circumferentially and symmetrically distributed. At one end of the rollers 341 is a ring 343 which has a lineal displacement in relation to the center of the disc 342. The rollers 341 have a variable radial displacement in the disc 342. The rollers 341 have a symmetry axis 148. The rollers 341 have a traction contact with a two traction cones 344 through a traction oil system (not shown). The two cones 344 are connected with the spiral bevel gears 481 and a face gear 487. The gear 487 has the direction of output rotation movement 179. The gear 487 is connected to a load (not shown). The eccentricity of the ring 343 is regulated through a control system (not shown) of the continuously variable transmission.

In the central point of the roller disc 342 is the input rotation movement 137 which is determined by a reference axis 192. In the central point of the ring 343 is a reference axis 191. The ring 343 is regulated in a eccentricity 193. The eccentricity 193 is formed between the reference axes 192 and 191. At one end of this reference axis 192 is projected a direction of main variable movement 194 and, at the other end is projected a direction of main variable movement 195. The two traction cones 344 have a directions of rotation movement 196 and 197.

The continuously variable transmission of FIG. 61 is operated through the input rotation movement and rotates with the same angular velocity to the eight rollers 341 in the roller disc 342. Additionally, each one of these rollers 341 has an oscillating radial movement or a reciprocating radial movement caused by the eccentricity 193 between the ring 343 and the disc 342. Consequently, the rollers 341 have a movement which can be determined through a rotation movement with an oscillating radial movement. This oscillating radial movement is transmitted from the rollers 341 to the two traction cones 344 by an interaction in a contact area using a traction oil. The oscillating radial movement of the rollers 341 produces a rotation movement in the cones 344. Each one of the two cones 344 has a rotation movement; therefore, both rotation movements are adding for obtaining an output rotation movement. The rollers 341 have a free rotation movement in relation to its symmetry axis 148. The control system of the continuously variable transmission regulates the eccentricity 193 between the ring 343 and the disc 342. The control system can have several methods of control for selecting the transmission ratio. The control system can be configured to determine the transmission ratio in an automatic, or semi-automatic, or manual selection by a user. When the disc 342 rotates with the direction of input rotation movement 137, the rollers 341 located at lower side have the direction of main variable movement 195. This direction of main variable movement determines the direction of rotation movement 196 and 197 of the two cones 344. Consequently, when the eccentricity 193 between the ring 343 and the disc 342 is regulated, the direction of output rotation movement 179 is modificated; thus, the transmission ratio can be varied from forward to reverse including neutral in a continuous form.

The transmission has the roller disc 342 mounted on a stationary base, and the disc 342 conduces the direction of input rotation movement 137; the eight rollers 341 are supported on a structure with control of the eccentricity 193, and the rollers 341 have a rotation movement of continuously variable eccentricity; the rollers 341 drive the main variable movements 194 and 195, and the rollers 341 have a free rotation movement; the two traction cones 344 have a continuously variable output rotation movement.

The transmission is depicted in a transmission ratio. The transmission has the traction contact for transmitting the movements between the rollers 341 and the two traction cones 344. The rollers 341 drive the main variable movement, and a perpendicular movement in relation to the main variable movement.

The main variable movement of the rollers 341 is a tangential movement to a contact area, this contact area is formed between the external surfaces of the rollers 341 and the cones 344. The contact area is an interaction zone between movements, the main variable movement of the rollers 341 is converted in a main output variable movement of the cones 344. The main output variable movement of the cones 344 is a tangential movement to the contact area. The main output variable movement of the cones 344 is a component of the continuously variable output rotation movement of the cones 344.

The perpendicular movement in relation to the main variable movement of the rollers 341 is converted in the free rotation movement of the rollers 341. This conversion is made in the contact area by the traction contact. The free rotation movement of the rollers 341 is when each one of the rollers 341 rotates around of its own symmetry axis 148.

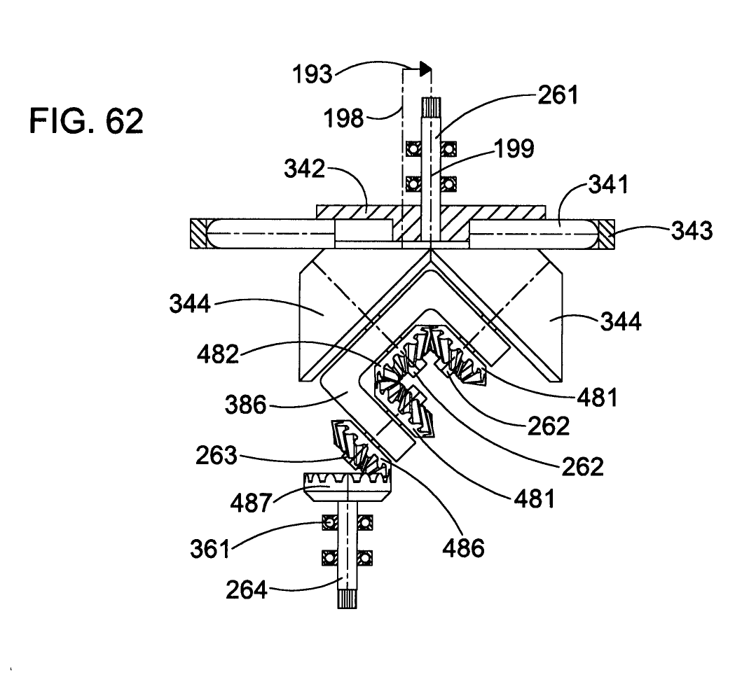

FIG. 62 shows a longitudinal section of the continuously variable transmission of FIG. 61. The transmission has an input shaft 261 which is connected at one side to the roller disc 342. The disc 342 drives the rollers 341. At one end of the rollers 341 is the ring 343. The ring 343 has the eccentricity 193 which is formed between the reference axes 199 and 199. The rollers 341 have the traction contact with the two traction cones 344.

The two cones 344 are mounted on a cone shafts 262. The spiral bevel gear 482 is engaged with the two spiral bevel gears 481. The cone shafts 262 with a shaft 263 are mounted on a cone support 386. The shaft 263 drives a spiral bevel gear 486 which is engaged with the face gear 487. The gear 487 is supported on an output shaft 264.

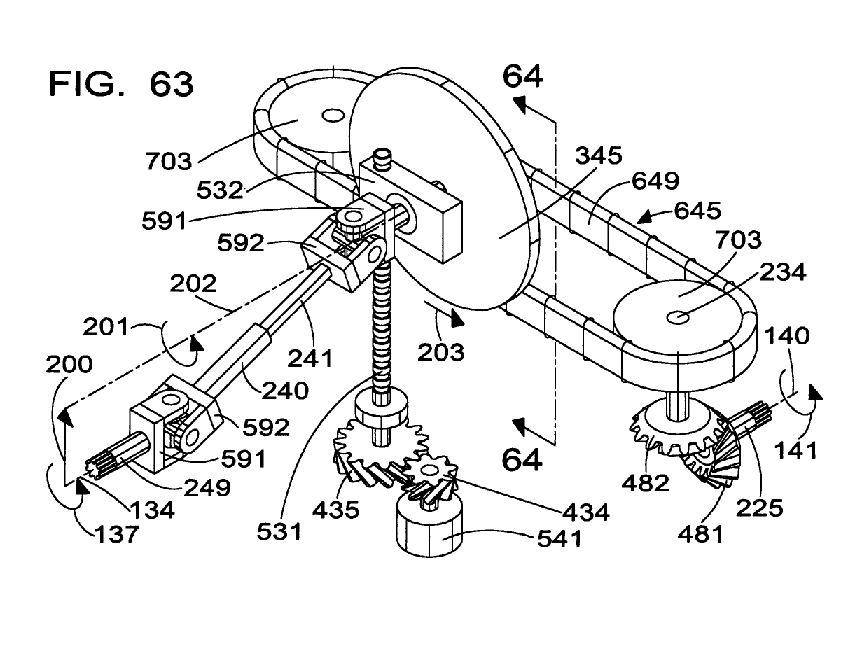

Referring to the FIG. 63, there is shown an embodiment of a continuously variable transmission in accordance with the present invention. The continuously variable transmission has the input shaft 249 which is connected to the universal joints 591 and 592. The joint 592 is connected to the external telescopic shaft 240 with the internal telescopic shaft 241. The shaft 241 is connected to the joints 592 and 591. The joint 591 is connected to a traction disc 345. The disc 345 has a eccentricity 200 between a reference axis 202 and the reference axis 134. The eccentricity 200 is regulated through a screw 531 and a nut support 532. The control motor 541 regulates the eccentricity 200 of the disc 345. The torque of the motor 541 is amplificated through the gear train formed by the helical gears 434 and 435 and the screw 531. The disc 345 has a traction contact with a compound belt 645. The belt 645 is formed of the annular belts 649. The disc 345 has a direction of rotation movement 201 with a direction of main variable movement 203. The belt 645 drives the two cylindrical pulleys 703. One of the pulleys 703 is supported on the output shaft 234 which transmits the movement to the spiral bevel gear 482. The gear 482 is engaged with the spiral bevel gear 481. The gear 481 is mounted on the rotatable output shaft 225. The shaft 225 is determined by the output axial axis 140 with a direction of output rotation movement 141.

The continuously variable transmission of FIG. 63 is operated through the input rotation movement 137 and rotates with the same angular velocity to the traction disc 345 using a universal joints with telescopic shafts. The universal joints with telescopic shafts permit to transmit the rotation movement 201 with the eccentricity 200 of the traction disc 345. Additionally, the eccentricity 200 of the disc 345 is continuously variable. The control system of the continuously variable transmission regulates the eccentricity 200 between the disc 345 and the input shaft 249. The control system can have several methods of control for selecting the transmission ratio. The control system can be configured to determine the transmission ratio in an automatic, or semi-automatic, or manual selection by a user. When the disc 345 rotates with the direction of input rotation movement 137, the disc 345 has the direction of main variable movement 203. This direction of main variable movement determines the direction of rotation movement of the compound belt 645. Consequently, when the eccentricity 200 between the disc 345 and the input shaft 249 is regulated, the direction of output rotation movement 141 is modificated; thus, the transmission ratio can be varied from forward to reverse including neutral in a continuous form.

The transmission has the input shaft 249 mounted on a stationary base, and the shaft 249 conduces the direction of input rotation movement 137; the traction disc 345 is supported on a structure with control of the eccentricity 200, and the disc 345 has a rotation movement of continuously variable eccentricity; the disc 345 drives the main variable movement 203; the annular belts 649 have a free rotation movement; the compound belt 645 and the two cylindrical pulleys 703 have a continuously variable output rotation movement.

The transmission is depicted in a transmission ratio. The transmission has a traction contact for transmitting the movements between the disc 345 and the compound belt 645. The disc 345 drives a main variable movement, and a perpendicular movement in relation to the main variable movement.

The main variable movement of the disc 345 is a tangential movement to a contact area, this contact area is formed between the external surfaces of the disc 345 and the compound belt 645. The contact area is an interaction zone between movements, the main variable movement of the disc 345 is converted in a main output variable movement of the belt 645. The main output variable movement of the belt 645 is a tangential movement to the contact area. The main output variable movement of the belt 645 is a component of the continuously variable output rotation movement of the belt 645.

The perpendicular movement in relation to the main variable movement of the disc 345 is converted in the free rotation movement of the annular belts 649. This conversion is made in the contact area by the traction contact.

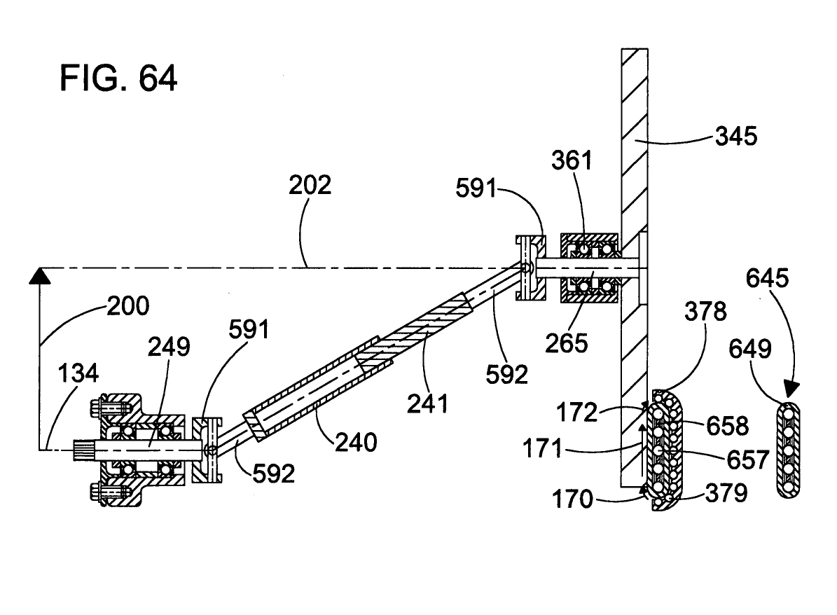

FIG. 64 shows a longitudinal section of the transmission of FIG. 63. The transmission has the input shaft 249 which is connected to a disc shaft 265 using the universal joints 591 and 592 and the telescopic shafts 240 and 241. The traction disc 345 has the eccentricity 200 between the reference axis 202 and the reference axis 134. The disc 345 is in traction contact with the compound belt 645. The belt 645 has the annular belts 649 with the balls 657 and the internal belt supports 658. The directions of free movement 170-172 are formed on the annular belts 649. The belt 645 is moved on the belt support 378. The support 378 has the balls 379 which are distributed uniformly for contacting the annular belts 649.

### Conclusion, Ramifications, and Scope

Accordingly, the reader will see that the processes for obtaining continuously variable transmissions, and the continuously variable transmissions of this invention can be used to shift a transmission ratio with few components and compactly, and can be utilized to change a speed from forward to reverse including stationary continuously and uniformly. In addition, the continuously variable transmissions can be configured in many forms and different types.

Although the description above contains many specificities, these should not be construed as limiting the scope of the invention but as merely providing illustrations of some of the presently preferred embodiments of this invention. For example:

The number of components of the continuously variable transmissions can be modificated, such as in FIG. 3 the number of half-toroidal discs 401 can be reduced to one, and the number of cylindrical rollers 331 can be reduced or increased.

The continuously variable transmissions can have different configurations for converting rotation movement of continuously variable oscillating angle, or of continuously variable eccentricity in a continuously variable output rotation movement, such as in FIG. 4 a traction sphere with supports and connections can be added to the transmission, and the traction sphere has its central point in the middle point of the axis 133, the cylindrical rollers 331 are located externally to the traction sphere, the external surface of the traction sphere has a contact areas with the rollers 331, the rollers 331 have a continuously variable oscillating rotation movement, and the traction sphere has a continuously variable output rotation movement.

The mechanism for obtaining a rotation movement of continuously variable oscillating angle, or of continuously variable eccentricity can have a different configurations, such as in FIG. 11 the transmission can have two swash plates 297 which are parallel plates with identical movement and the rollers with pneumatic-cylindrical tire 335 are located in the middle part between these two swash plates 297; in FIG. 31 the transmission can have the pneumatic-cylindrical tire 405 mounted on a stationary base, and the tire 405 driving the input rotation movement 137, and the compound belt 645 and the two pulleys 703 supported on a structure with control of the oscillating angle, and the belt 645 and the two pulleys 703 having rotation movement of continuously variable oscillating angle; in FIG. 39 the transmission can have the pneumatic-cylindrical tire 405 mounted on a stationary base, and the tire 405 conducing the input rotation movement 137, and the compound cylinder 411 supported on a structure with control of the oscillating angle, and the cylinder 411 having rotation movement of continuously variable oscillating angle; in FIG. 61 the transmission can have the ring 343 fixed and stationary, and the roller disc 342 supported on a structure with control of the eccentricity, and the disc 342 having rotation movement of continuously variable eccentricity; in FIG. 63 the transmission can have the traction disc 345 mounted on a stationary base, and the disc 345 driving the input rotation movement 137, and the compound belt 645 and the two pulleys 703 supported on a structure with control of the eccentricity, and the belt 645 and the two pulleys 703 having rotation movement of continuously variable eccentricity.

The control system can have different mechanisms of actuation, such as hydraulic, pneumatic, electro-mechanical, electromagnetic, etc.

The control system can have a plurality of sensors, transducers, input signal transmitters, decision components, output signal transmitters, actuators, etc.

The control system can have different methods for controlling the continuously variable transmission, such as methods for shifting the transmission ratio with automatic, semi-automatic, or manual selection by a user.

The converter mechanism from the main variable movement to the main output variable movement can have different components, such as magnetics, touch fasteners, system of collapsible teeth, system of traction oil, etc.

The continuously variable transmissions can have a dual-range, power split with a summation gear set, or several regimes.

The continuously variable transmissions can have a starting device, such as clutch, torque converter, etc.

The continuously variable transmissions can have different situations when the transmission ratio is approximately zero or singularity, such as geared neutral, stationary, parking, neutral, etc.

Thus the scope of the invention should be determined by the appended claims and their legal equivalents, rather than by the examples given.

1. A process for obtaining a continuously variable transmission, comprising the steps of
(a) providing a component with an input rotation movement in a structure,
(b) providing a component with a rotation movement of continuously variable oscillating angle in said structure,
(c) providing a converter mechanism in said structure and converting movements from said component with said input rotation movement to said component with said rotation movement of continuously variable oscillating angle,
(d) providing a control system and controlling said component with said rotation movement of continuously variable oscillating angle of said structure,
(e) providing a plurality of elements with a contact area, a main variable movement, and a perpendicular movement in relation to said main variable movement, in said component with said rotation movement of continuously variable oscillating angle,
(f) providing a plurality of elements with a contact area, and a main output variable movement in said structure,
(g) providing a plurality of elements with a free movement in said contact area,
(h) providing a converter mechanism in said contact area and converting movements from said plurality of elements with said main variable movement to said plurality of elements with said main output variable movement,
(i) providing a converter mechanism in said contact area and converting movements from said plurality of elements with said perpendicular movement in relation to said main variable movement to said plurality of elements with said free movement,
(j) providing a component with a continuously variable output rotation movement in said structure and integrating movements between said plurality of elements with said main output variable movement, and said plurality of elements with said free movement, in said component with said continuously variable output rotation movement,
(k) providing a reversible movement transmission in said structure from said component with said continuously variable output rotation movement to said component with said input rotation movement, comprising:
(1) separating movements from said component with said continuously variable output rotation movement, of said structure, said plurality of elements with said main output variable movement, and said plurality of elements with said free movement,
(2) converting movements in said contact area from said plurality of elements with said free movement to said plurality of elements with said perpendicular movement in relation to said main variable movement,
(3) converting movements in said contact area from said plurality of elements with said main output variable movement to said plurality of elements with said main variable movement,
(4) integrating movements between said plurality of elements with said main variable movement, and said plurality of elements with said perpendicular movement in relation to said main variable movement, in said component with said rotation movement of continuously variable oscillating angle, and
(5) converting movements from said component with said rotation movement of continuously variable oscillating angle to said component with said input rotation movement in said structure.

2. The process of claim 1 wherein said plurality of elements with said main variable movement is a plurality of elements with a normal movement to said contact area.

3. The process of claim 1 wherein said plurality of elements with said main variable movement is a plurality of elements with a tangential movement to said contact area.

4. The process of claim 1 wherein said plurality of elements with said free movement is a plurality of elements with a free rotation movement in said contact area.

5. The process of claim 1 wherein said plurality of elements with said free movement is a plurality of elements with a free displacement movement in said contact area.

6. A process for obtaining a continuously variable transmission, comprising the steps of:
(a) providing a component with an input rotation movement in a structure,
(b) providing a component with a rotation movement of continuously variable eccentricity in said structure,
(c) providing a converter mechanism in said structure and converting movements from said component with said input rotation movement to said component with said rotation movement of continuously variable eccentricity,
(d) providing a control system and controlling said component with said rotation movement of continuously variable eccentricity of said structure,
(e) providing a plurality of elements with a contact area, a main variable movement, and a perpendicular movement in relation to said main variable movement, in said component with said rotation movement of continuously variable eccentricity,
(f) providing a plurality of elements with a contact area, and a main output variable movement in said structure,
(g) providing a plurality of elements with a free movement in said contact area,
(h) providing a converter mechanism in said contact area and converting movements from said plurality of elements with said main variable movement to said plurality of elements with said main output variable movement,
(i) providing a converter mechanism in said contact area and converting movements from said plurality of elements with said perpendicular movement in relation to said main variable movement to said plurality of elements with said free movement,
(j) providing a component with a continuously variable output rotation movement in said structure and integrating movements between said plurality of elements with said main output variable movement, and said plurality of elements with said free movement, in said component with said continuously variable output rotation movement,
(k) providing a reversible movement transmission in said structure from said component with said continuously variable output rotation movement to said component with said input rotation movement, comprising:
(1) separating movements from said component with said continuously variable output rotation movement, of said structure, said plurality of elements with said main output variable movement, and said plurality of elements with said free movement,
(2) converting movements in said contact area from said plurality of elements with said free movement to said plurality of elements with said perpendicular movement in relation to said main variable movement,
(3) converting movements in said contact area from said plurality of elements with said main output variable movement to said plurality of elements with said main variable movement,
(4) integrating movements between said plurality of elements with said main variable movement, and said plurality of elements with said perpendicular movement in relation to said main variable movement, in said component with said rotation movement of continuously variable eccentricity, and
(5) converting movements from said component with said rotation movement of continuously variable eccentricity to said component with said input rotation movement in said structure.

7. The process of claim 6 wherein said plurality of elements with said main variable movement is a plurality of elements with a normal movement to said contact area.

8. The process of claim 6 wherein said plurality of elements with said main variable movement is a plurality of elements with a tangential movement to said contact area.

9. The process of claim 6 wherein said plurality of elements with said free movement is a plurality of elements with a free rotation movement in said contact area.

10. The process of claim 6 wherein said plurality of elements with said free movement is a plurality of elements with a free displacement movement in said contact area.

11. A process for obtaining a continuously variable transmission, comprising the steps of:
(a) providing a component with an input rotation movement in a structure,
(b) providing a component with a rotation movement of continuously variable oscillating angle in said structure,
(c) providing a converter mechanism in said structure and converting movements from said component with said input rotation movement to said component with said rotation movement of continuously variable oscillating angle,
(d) providing a control system and controlling said component with said rotation movement of continuously variable oscillating angle of said structure,
(e) providing a plurality of elements with a contact area, a main variable movement, and a perpendicular movement in relation to said main variable movement, in said component with said rotation movement of continuously variable oscillating angle,
(f) providing a plurality of elements with a contact area, and a main output variable movement in said structure,
(g) providing a plurality of elements with a free movement in said contact area,
(h) providing a converter mechanism in said contact area and converting movements from said plurality of elements with said main variable movement to said plurality of elements with said main output variable movement,
(i) providing a converter mechanism in said contact area and converting movements from said plurality of elements with said perpendicular movement in relation to said main variable movement to said plurality of elements with said free movement, and
(j) providing a component with a continuously variable output rotation movement in said structure and integrating movements between said plurality of elements with said main output variable movement, and said plurality of elements with said free movement, in said component with said continuously variable output rotation movement.

12. A process for obtaining a continuously variable transmission, comprising the steps of:
(a) providing a component with an input rotation movement in a structure,
(b) providing a component with a rotation movement of continuously variable eccentricity in said structure,
(c) providing a converter mechanism in said structure and converting movements from said component with said input rotation movement to said component with said rotation movement of continuously variable eccentricity,
(d) providing a control system and controlling said component with said rotation movement of continuously variable eccentricity of said structure,
(e) providing a plurality of elements with a contact area, a main variable movement, and a perpendicular movement in relation to said main variable movement, in said component with said rotation movement of continuously variable eccentricity,
(f) providing a plurality of elements with a contact area, and a main output variable movement in said structure,
(g) providing a plurality of elements with a free movement in said contact area,
(h) providing a converter mechanism in said contact area and converting movements from said plurality of elements with said main variable movement to said plurality of elements with said main output variable movement,
(i) providing a converter mechanism in said contact area and converting movements from said plurality of elements with said perpendicular movement in relation to said main variable movement to said plurality of elements with said free movement, and
(j) providing a component with a continuously variable output rotation movement in said structure and integrating movements between said plurality of elements with said main output variable movement, and said plurality of elements with said free movement, in said component with said continuously variable output rotation movement.

13. A continuously variable transmission, comprising:
(a) a structure having a component with an input rotation movement,
(b) a component with a rotation movement of continuously variable oscillating angle in said structure,
(c) a converter mechanism mounted in said structure for converting movements from said component with said input rotation movement to said component with said rotation movement of continuously variable oscillating angle,
(d) a control system for controlling said component with said rotation movement of continuously variable oscillating angle of said structure,
(e) a plurality of elements with a contact area, a main variable movement, and a perpendicular movement in relation to said main variable movement, for using said component with said rotation movement of continuously variable oscillating angle,
(f) a plurality of elements with a contact area, and a main output variable movement in said structure,
(g) a plurality of elements with a free movement in said contact area,
(h) a converter mechanism in said contact area for converting movements from said plurality of elements with said main variable movement to said plurality of elements with said main output variable movement,
(i) a converter mechanism in said contact area for converting movements from said plurality of elements with said perpendicular movement in relation to said main variable movement to said plurality of elements with said free movement, and
(j) a component with a continuously variable output rotation movement in said structure for integrating movements between said plurality of elements with said main output variable movement and said plurality of elements with said free movement.

14. The continuously variable transmission of claim 13 wherein said component with said input rotation movement is an electric motor with an electrical connectors and a mechanical supports.

15. The continuously variable transmission of claim 13 wherein said component with said rotation movement of continuously variable oscillating angle is a pneumatic-cylindrical tire with a mechanical supports.

16. A continuously variable transmission, comprising:
(a) a structure having a component with an input rotation movement,
(b) a component with a rotation movement of continuously variable eccentricity in said structure,
(c) a converter mechanism mounted in said structure for converting movements from said component with said input rotation movement to said component with said rotation movement of continuously variable eccentricity,
(d) a control system for controlling said component with said rotation movement of continuously variable eccentricity of said structure,
(e) a plurality of elements with a contact area, a main variable movement, and a perpendicular movement in relation to said main variable movement for using said component with said rotation movement of continuously variable eccentricity,
(f) a plurality of elements with a contact area, and a main output variable movement in said structure,
(g) a plurality of elements with a free movement in said contact area,
(h) a converter mechanism in said contact area for converting movements from said plurality of elements with said main variable movement to said plurality of elements with said main output variable movement,
(i) a converter mechanism in said contact area for converting movements from said plurality of elements with said perpendicular movement in relation to said main variable movement to said plurality of elements with said free movement, and
(j) a component with a continuously variable output rotation movement in said structure for integrating movements between said plurality of elements with said main output variable movement and said plurality of elements with said free movement.

17. The continuously variable transmission of claim 16 wherein said component with said rotation movement of continuously variable eccentricity is a traction disc with a mechanical supports.

18. The continuously variable transmission of claim 16 wherein said component with said input rotation movement is an electric motor with an electrical connectors and a mechanical supports.

19. A continuously variable transmission, comprising:
(a) a structure having a component with an input rotation movement,
(b) a component with a rotation movement of continuously variable oscillating angle in said structure,
(c) means for converting movements from said component with said input rotation movement to said component with said rotation movement of continuously variable oscillating angle,
(d) means for controlling said component with said rotation movement of continuously variable oscillating angle of said structure,
(e) a plurality of elements with a contact area, a main variable movement, and a perpendicular movement in relation to said main variable movement, for using said component with said rotation movement of continuously variable oscillating angle,
(f) a plurality of elements with a contact area, and a main output variable movement in said structure,
(g) a plurality of elements with a free movement in said contact area,
(h) means in said contact area for converting movements from said plurality of elements with said main variable movement to said plurality of elements with said main output variable movement,
(i) means in said contact area for converting movements from said plurality of elements with said perpendicular movement in relation to said main variable movement to said plurality of elements with said free movement, and
(j) a component with a continuously variable output rotation movement in said structure for integrating movements between said plurality of elements with said main output variable movement and said plurality of elements with said free movement.

20. A continuously variable transmission, comprising:
(a) a structure having a component with an input rotation movement,
(b) a component with a rotation movement of continuously variable eccentricity in said structure,
(c) means for converting movements from said component with said input rotation movement to said component with said rotation movement of continuously variable eccentricity,
(d) means for controlling said component with said rotation movement of continuously variable eccentricity of said structure,
(e) a plurality of elements with a contact area, a main variable movement, and a perpendicular movement in relation to said main variable movement, for using said component with said rotation movement of continuously variable eccentricity,
(f) a plurality of elements with a contact area, and a main output variable movement in said structure,
(g) a plurality of elements with a free movement in said contact area,
(h) means in said contact area for converting movements from said plurality of elements with said main variable movement to said plurality of elements with said main output variable movement,
(i) means in said contact area for converting movements from said plurality of elements with said perpendicular movement in relation to said main variable movement to said plurality of elements with said free movement, and
(j) a component with a continuously variable output rotation movement in said structure for integrating movements between said plurality of elements with said main output variable movement and said plurality of elements with said free movement.
